(19) United States
(12) Patent Application Publication
(10) Pub. No.: US 2017/0178193 A1
(43) Pub. Date: Jun. 22, 2017

(54) METHODS AND SYSTEMS OF A SPONSORED MOBILE DATA USAGE PLATFORM

(71) Applicant: Tube Incorporated, Chelmsford, MA (US)

(72) Inventors: Shantigram Venkatesh Jagannath, Bangalore (IN); Harjot Singh Saluja, Nashua, NH (US); Sharmistha Chatterjee, Bangalore (IN); Robin Balyan, Nashua, NH (US); Mahender Reddy Korandla, Westford, MA (US); Avi Chopra, Bangalore (IN); Minyan Shi, Bolton, MA (US); John Briar, Boise, ID (US); Apratim Ankur, Bangalore (IN); Abhishek Kumar, Bangalore (IN)

(21) Appl. No.: 15/382,317

(22) Filed: Dec. 16, 2016

Related U.S. Application Data
(60) Provisional application No. 62/269,074, filed on Dec. 17, 2015.
(60) Provisional application No. 62/280,771, filed on Jan. 20, 2016.

(30) Foreign Application Priority Data
Jul. 19, 2016 (IN) 201611024751

(51) Int. Cl. G06Q 30/02; G06F 9/44; H04L 12/26; G06Q 30/04

(52) U.S. Cl. CPC G06Q 30/0267; G06Q 30/0273; G06Q 30/0276; G06Q 30/04; G06F 8/33; H04L 43/0876

(57) ABSTRACT

A sponsored data system configured to operate with a wireless mobile device running an app that receives sponsored data from a content provider server is provided. The system includes an interface application configured to run on the wireless mobile device. The interface application is configured to determine availability of sponsored data. A cloud platform is configured to interface with the content provider server. The cloud platform is configured to generate a token with data usable to determine availability of sponsored data and transmit the token to the interface application. A portal is configured to create and store a package that identifies at least a portion of the data associated with the app as sponsored data.

### CROSS-REFERENCE TO RELATED APPLICATIONS

This application claims priority to the following applications: U.S. Provisional Patent Application No. 62/269,074, entitled “METHODS AND SYSTEMS OF A SPONSORED MOBILE DATA USAGE PLATFORM,” filed on Dec. 17, 2015; U.S. Provisional Patent Application No. 62/280,771, entitled “METHODS AND SYSTEMS FOR ENABLING MOBILE CONTENT SPONSORSHIP,” filed on Jan. 20, 2016; and India Provisional Patent Application No. 201611024751, entitled METHODS AND SYSTEMS OF A SPONSORED MOBILE DATA USAGE PLATFORM, filed on Jul. 19, 2016. The entire content of each of the aforementioned applications is hereby incorporated by reference herein, as are the documents that such applications incorporate by reference.

The application is also related to U.S. patent application Ser. No. 14/976,896, entitled “SYSTEM AND METHOD FOR COORDINATING CLIENT-SIDE INFERENCE OF MOBILE NETWORK LOADING AND CAPACITY,” filed Dec. 21, 2015, which claims priority to U.S. Provisional Patent Application No. 62/094,493, titled “A System and Method for Coordinating Client-Side Inference of Mobile Network Conditions,” filed on Dec. 19, 2014; U.S. patent application Ser. No. 14/755,983, entitled “SPONSORED DATA SYSTEM AND METHOD,” filed Jun. 30, 2015; U.S. patent application Ser. No. 14/477,464 (now U.S. Pat. No. 9,407,508), entitled “CLIENT-SIDE INFERENCE OF WIRELESS NETWORK STATES,” filed Sep. 4, 2014; and U.S. patent application Ser. No. 14/575,550, entitled “SYSTEM AND METHOD FOR SCHEDULING MOBILE DATA DURING A SPECTRUM VALLEY,” filed Dec. 18, 2014. The entire content of each of the aforementioned applications is hereby incorporated by reference herein, as are the documents that such applications incorporate by reference.

### FIELD

The present disclosure generally relates to a sponsored mobile data usage platform.

### BACKGROUND

An ecosystem has evolved for mobile advertising in which advertisers and content publishers participate in advertising exchanges, and advertisements are placed on mobile devices, such as in mobile browsers and in mobile applications (referred to in some cases herein as “apps”). Increasingly, advertisers wish to deliver rich-media mobile advertisements, which may incorporate video, animation, and other components that may require larger amounts of data bandwidth to deliver the advertisement. FIG. 1 shows various components of the mobile digital marketing ecosystem 200 (also referred to simply as mobile marketing ecosystem), buy-side platforms 202, and sell-side platforms 204. It should be appreciated that the components may evolve with overlapping functionalities, and one of ordinary skill in the art would understand that functional capabilities based on the various components of the ecosystem as shown in FIG. 1 may be provided in other configurations. In embodiments of FIG. 1, an advertiser 208 or an ad agency 210 may run ad campaigns on a buy-side ad server 212, an ad network 214 or a demand-side platform (DSP) 218. A publisher 220 can sell its inventory on a sell-side purchaser ad server 222, or an ad network 224 or a sell-side platform (SSP) 228.

However, there are a number of problems in the ecosystem, including low click-through rates for rich-media mobile ads due to high mobile data costs and poor display quality and experiences with the advertisements; low mobile application installation rates due to high mobile data costs; and blocking of advertisements by mobile users due to the high mobile data costs.

Market research shows that global mobile advertisers are expected to spend more than $100 billion worldwide in 2016, comprising more than half of overall digital marketing spending and representing a more than 400% increase from 2013. Between 2016 to 2019 mobile ad spending is expected nearly to double again, hitting almost $200 billion and accounting for as much as 70% of digital ad spending. A need exists to provide advertisers a better return on their investments (ROI). Mobile video ad spending is growing rapidly because video advertising is highly effective in engaging users and delivering stronger brand stories. The market is also experiencing increased costs per loyal user.

With increased mobile marketing spending, more mobile ads are served to mobile users. Sometimes more user data is spent on advertisement than on actual content. In some instances, this can be concerning or cost prohibitive for the user. FIG. 2 shows that for many leading news publishers, the time to download advertising content 102 exceeds the time to download editorial content 104 that users are seeking.

In order to avoid paying so much for advertising, mobile users are starting to use ad-blocking software, which in turn has affected advertiser's returns on investment.

High data cost and poor display quality of rich-media mobile ads contribute to low click-through rates, and in turn a higher cost-per-loyal user (CPLU). This is especially true in emerging markets where mobile data is more expensive, mobile network coverage and bandwidth are limited, and other types of broadband communication, such as cable, are not widely available. A need exists for methods and systems that consider the availability of ad-blocking software and provide advertisers with improved return on investment in mobile advertising technology.

High mobile data costs have also led operators to come up with mechanisms to reduce subscriber's data cost. With an objective to reduce subscriber's billing rate, mobile network operators worldwide have introduced limits on the amount of data that a subscriber can consume for a basic plan and differentially charge for incremental usage excess beyond the limits. In order to enable more consumption of data, methods and systems are disclosed herein and in the documents incorporated herein by reference, which can allow parties to categorize mobile data traffic based on a subscriber's usage needs and patterns to develop newer differential, split-billing service models where an enterprise (e.g., employers), content providers (e.g., publishers), advertisers, application developers or other sponsors pay fully for or a pay a certain percentage of the cost for data usage sponsored by them, while rest of the data may be billed to a subscriber's account. This category of service is referred to herein as split billing, where sponsored data may be multi-rated (i.e., provided at no charge, or different levels of discount, as compared to other data usage). The methods and systems that enable such capabilities are referred to herein in some cases as a “sponsored data platform” or a “sponsored data solution,” and those terms should be understood to be used interchangeably except where content indicates otherwise. Various parties, such as employers, enterprises, content providers, publisher, advertisers, developers and the like, are referred to herein as “sponsors,” and the use of any of those terms should be understood to be encompass any such sponsors, except where context indicates otherwise. Such sponsors, unless context specifically states otherwise, may be engaged in various kinds of sponsorship, such as toll free downloads (e.g., app developers and content providers), split billing sponsorship models with any sponsorship ratio shared between consumers and sponsors (e.g., enterprises), and zero rating solutions where protocol-specific application packets can be zero-rated by operators. The various embodiments described herein should be understood to be applicable to any of these types of sponsorship, except where context specifically indicates otherwise.

In such sponsorship solutions discussed above, operators have attached selection and filtering criteria to allow passage of sponsored, multi-rated traffic for selected IP ranges and subnets, for both sponsors and mobile subscribers in a cellular network. This can require IP addresses to be easily added, removed or modified one time at a minimum cost and effort in order to enable scalability to large numbers of sponsors and subscribers.

However, only allowing selection of IP addresses as a criterion for sponsorship (e.g. toll free downloads, split-billing) can impose heavy charges on sponsors (e.g. content providers) for sponsoring and zero-rating all types of content. In order to handle the situation, content providers may need a pricing model to multi-rate different types of content based on usage demand, socio-economic factors, government policies, and other factors. For example, content providers might wish to allow 100% sponsorship to health-care, news, and educational web traffic, 50% sponsorship to job search related sites, 25% sponsorship to videos during live sports matches, or 10-15% sponsorship to movie trailers before a movie release. Additionally, in news sponsorship, textual and image data might be afforded 100% sponsorship as per government norms, such as to increase public awareness, whereas news videos with audio-video content type might be afforded only 50% sponsorship. Hence, a need exists for solutions that allow varying levels of sponsorship for varying types of traffic from varying domains.

In a scenario where sponsors (e.g., content providers) provide multi-rated data though sponsorship campaigns to a set of subscribers, it can become important to measure the amount of sponsored data accessed by each subscriber. Further, there is also a need to account for the volume of traffic sponsored by each content provider when multiple subscribers use same content or access similar uniform resource locators (URLs) for the same campaign. As an example, a campaign may include a sponsored movie, which may contain multi-rated audio, video, and images. The network protocol for accessing each type of traffic may be different, as audio and video may be downloaded through https, while images can be downloaded through http, for example. Accordingly, a need exists for aggregating information about usage patterns across types of traffic and protocols.

There are technologies that can facilitate operators to set charging policies for IP address ranges and subnets served by different sponsors (e.g., content providers) under different application level protocols. As of now, operators have mostly been multi-rating each end point in the network. However, defining IP rules and charging multiple rates for each URL and protocol under each URL retrieved from a destination can involve repeated effort by the operator involving manual intervention, making it expensive to dynamically change the configuration and to accommodate changing needs from sponsors, as end-points keep changing. Further, this approach is not scalable, as it incurs a huge amount of processing resources in the GGSN/P-GW (Gateway GPRS Support Node/Packet Gateway) of the operator. In most mobile telecommunications systems (e.g., 2G/3G/LTE/4G), the GGSN/P-GW is primarily involved with a) user based packet inspection, filtering, policy-enforcement; b) IP address allocation; and c) setting Diffsery Code Points and operator charging rules. These operations, if undertaken manually, can be very time consuming, making it very difficult to dynamically change configurations as needs of a campaign, such as a sponsored data campaign, change over time. A content partner, for example, may have several URLs or IP addresses as a destination from which content is served, as well as over several different protocols with a different end point for each protocol. It also includes work and processes among operator personnel to do configurations, making it expensive to dynamically change the configurations and to accommodate changing needs from sponsors, as the end points keep changing.

Different technologies have evolved around sponsored data to measure traffic per subscriber for different sponsored campaigns; however, a need exists for methods and systems for filtering, accounting for, and billing for different kinds of traffic (e.g., different protocols), including in the presence of dynamic charging rules for a campaign.

Economic and business factors relating to offering sponsored data can vary significantly based on location, as may the types of apps that are used by customers, both in consumer and enterprise market, so sponsors may desire to offer a range of different apps at a range of sponsorship levels (i.e., “multi-rated”) for different categories of traffic in different locations. For example, a sponsor may wish to offer office workers more sponsorship on enterprise apps, while offering school and college students sponsorship on educational apps.

One such example is email in enterprises and consumer business. Enterprises have been largely trying to ease employees' data usage. However, another complicating factor in mobile ecosystems is that employees of enterprises increasingly use a “Bring Your Own Device” (BYOD) approach to their jobs, where they use the same smartphone, tablet, or other mobile device for work and personal activities. Also, enterprises are increasingly encouraging the use of cloud-based solutions, such as for electronic mail, which allows workers to remain connected to their activities even when not at the workplace. As a result, many workers end up using their personal cellular data plans in order to undertake work activities. Similarly, many workers end up using mobile devices that are provided by their employers for personal activities, which can result in the employer paying for cellular data usage for the worker's personal needs. A need exists to separate work and personal data usage, including for purposes of tracking which party should be responsible for paying for particular data usage. Elsewhere in this disclosure, implementations are provided for allowing sponsorship of applications and other content. In the case of electronic mail, particular complications arise because of the unique characteristics of the leading electronic mail client programs, including systems that are intended to provide a high degree of data security, which in turn make it difficult for outside parties to interact with the programs to provide new features.

Finally, with a rising cost of bandwidth, as content providers wish to provide various levels and types of sponsorship for users, there is a need for methods and systems that make various types of multi rated traffic (e.g., SIP, HTTP, HTTPS, RTSP, SMTP, FTP, Exchange ActiveSync, and the like) less expensive, such as by taking advantage of periods of unused network capacity, termed as “valleys,” for eligible customers. A need also exists to allow traffic to pass through the same network for non-eligible subscribers without being multi-rated.

In the above-described ecosystem, there is a need for content partners (which as noted above may include various types of content providers, such as publishers, enterprises, advertisers, application developers, and others) to sponsor or subsidize entire or selected content that is delivered over cellular networks to mobile devices. Over the last decade, mobile marketing has experienced significant growth, primarily targeting smartphone and tablet users, delivering video, audio, images, slides, and banners that are provided on an easy-to-use user-interface. Classified and categorized web-content rendered on dynamic web pages has served as one of the approaches in reaching out to target audiences. However, there are challenges that may inhibit selective content sponsorship for mobile websites. First, content partners' preferences in sponsoring selected content on web pages may vary significantly, but conventional platforms can require significant custom coding in order to implement each campaign and suitably display the sponsored content on the web interface to end-users. Also, there is a need to differentiate content sponsorship by allowing a desired portion of a subsidy to be applied to different types of sponsored content (such as differentiating sponsorship for images, video, text and the like, differentiating advertising versus other content, or the like).

Also, there is a need for the ability to make the content sponsorship in a campaign dynamic, such as based on shifting marketing needs, network capacity, and intended audience. In order to facilitate dynamic content sponsorship, there is may be a requirement to ensure that all sponsored document object model (DOM) elements can be rendered for a page (including one with sponsored links) at the correct time. This may be needed, for example, to ensure that all authorized elements as stated in the campaign are sponsored and that non-sponsored elements are in fact not sponsored.

### SUMMARY

This disclosure includes various embodiments of methods and systems that can be integrated with technology components of an existing ecosystem for mobile marketing to provide various improvements, including ones that improve click-through rates on mobile, rich-media advertisements, improve conversion rate and improve returns on investments made by advertisers in mobile marketing campaigns.

Embodiments include a number of solutions that may be employed independently or together to enable a party, such as an advertiser or a content provider, to sponsor or subsidize mobile data usage that occurs when a user of a mobile device (referred to herein in some cases as a “mobile user”) views an advertisement. Also provided herein are embodiments in which a party may sponsor or subsidize the mobile data usage occurring when a mobile device user downloads a mobile application from an application store, such as a public application store, in response to an advertisement promoting an application.

The disclosure also describes an implementation to take advantage of peaks and valleys in operator network capacity by pre-loading rich-media mobile advertisements in operator network capacity usage valleys, thereby improving the experience of a mobile user viewing an ad in real-time and improving ad click-through and conversion rates. The implementation works independently under any wireless technology (e.g., 2G, 3G, 4G, 5G, WiFi, small cell, femto, and HetNets) as supported by any type of sponsors (e.g., enterprises, advertisers and content providers).

The disclosure also describes how sponsored or subsidized mobile ad solutions can be integrated with existing ad blocking solutions to bring high quality rich-media ads to a mobile user free of data charges.

In embodiments, toll-free mobile advertisements (referred to in some cases herein as “TFMA”) may refer to scenarios in which parties in the mobile marketing eco-system 200 other than end users sponsor, i.e. pay for, mobile data usage occurring on a mobile device when the user views an ad on a cellular network. This disclosure introduces methods and systems, with various technology components, for enabling toll-free mobile ads and toll-free mobile application downloads sponsored by sponsors such as advertisers or content providers, which can be easily integrated into the technology infrastructure of the mobile marketing eco-system operated by telecommunications carriers, advertising exchanges, publisher platforms, and the like, to compensate for part or all of the mobile data cost occurring to a mobile user for viewing an advertisement or downloading one or more mobile applications over a cellular network. This disclosure also introduces embodiments to preload rich-media mobile ads in a valley of a varying cellular network capacity usage pattern to greatly improve ad display quality and user experiences. These methods and systems will encourage mobile users to view mobile ads and download mobile applications more freely over a cellular network, hence improving ad click-through rates and returns on investment for advertisers.

This disclosure also describes how implementations can work with ad blocking software to bring mobile users high quality mobile ads free of data charge, benefiting both the advertiser and the mobile user.

The methods and systems disclosed herein may provide toll-free mobile ads (TFMA) management as shown in FIG. 1 through a mobile marketing ecosystem.

The methods and systems disclosed herein may include solutions that may be integrated independently with buy-side platforms, sell-side platforms and publishers.

In embodiments, methods and systems are provided that allow varying levels of sponsorship for varying types of traffic from various domains. In embodiments of the present disclosure, dynamic rules may be configured any time based on both category or class of the traffic being sponsored and the content within the traffic category.

In embodiments, methods and systems provided herein allow aggregation of usage data across types of traffic and protocols in mobile networks. As usage patterns of different subscribers for different content and individual components within the content may vary, a multi-rated aggregator may be provided with the capability of accounting for each sub-component within a component per subscriber, as well as summarizing overall usage of sub-components and components for all subscribers in a sponsored campaign.

In order to enable aggregation of the multi-rated traffic per unit time for different subscribers, the methods and systems disclosed herein may provide a number of capabilities. A unified gateway service may be deployed one time with IP rules and charging policies for different types of sponsored content with a flexibility of allowing dynamic change of rules and charging rates. A unified service may comprise individual gateways depending on an application layer protocol as a session initiation protocol (SIP) gateway can account bytes for voice over IP (VoIP) traffic, a real time streaming protocol (RTSP) gateway may be used for audio and video streaming, and an HTTP/HTTPS gateway may be used for accounting for web traffic. An authenticating agent may be provided to authorize eligible/non-eligible subscribers having access to sponsored traffic for limited duration, in specific geographical areas under defined IP rules, with a provision of reconsidering users for sponsorship eligibility under dynamic changes of a rules set by an operator such as and when new sponsors are added or existing sponsors are removed from the system. A universal billing agent may be closely coupled with the gateway service to aggregate data transmitted under different rules in different geographical areas to diverse user-devices to bill sponsors.

In embodiments, different kinds of sponsored content may be available to subscribers at the same time during idle periods of 3G, LTE and 4G spectrum. To access the sponsored traffic at the same time, a unified software gateway framework can be provided that allows authorized clients to pull multi-rated traffic from different sponsors (e.g. content providers) through this gateway. However, the gateway can be flexible to allow sponsored and non-sponsored traffic when a subscriber's eligibility criteria toggle/switch while moving across geographical boundaries of a campaign or available data quota as set by the content provider changes due to a subscriber's daily usage.

The methods and systems disclosed herein may also include methods and systems for filtering defined IP addresses, accounting and billing for traffic of various protocols (optionally including charging differently for different protocol traffic). Embodiments provide a unified service with application-level gateways capable of accounting multi-rated traffic as well as allowing passage of non-multi rated traffic. Further embodiments disclosed herein describe a system and method employed to account multi-rated packets for individual clients during a campaign to bill sponsors for their sponsorship.

Other embodiments of this disclosure relate generally to systems and methods for providing sponsored email services, such as to enterprise and consumer mobile subscribers, for varying email services, using different email servers, for different mobile platforms. In case of an enterprise, the sponsorship can be afforded by the organization, while in consumer email applications, sponsorship can be afforded by the content provider or advertiser. The disclosure considers configuration of device email settings either through an administered central management system, where settings are pushed into the device by an existing Mobile Device Management (MDM) partner, or through manual configuration via a configuration file in cases where the MDM partner is absent. This implementation enables secured mobile email sponsorship for varying network operators across different countries when email servers are deployed on the premises of an enterprise or in the cloud. By this implementation, a variety of email applications for diverse mobile platforms can be sponsored, either in presence or absence of MDM partners, offering various sponsored enterprise email services (including mail exchange, synchronization of emails, management of contacts and management of calendars) to users in numerous organizations.

In embodiments, a method and system for multi-rating email data for mobile subscribers is disclosed. The components of the system, in an embodiment, may include: a web service to forward email client's requests to authenticating agent; an authentication agent to authorize eligible email users; a software gateway service to allow passage of sponsored traffic in different operator networks; a domain name system (termed as “DNS” in the present embodiment) to route traffic to a sponsored or a non-sponsored gateway based on location of a mobile subscriber in selected regions of cellular network; and a back-end email server responsible for serving email requests.

Embodiments allow mobile subscribers in an organization to access company sponsored email service from BYOD mobile devices such as ANDROID®, iPhone®, iPad® and Windows Mobile where any mail exchange from selected devices and email accounts are charged separately from a subscriber's personal data plans. The disclosure provides a single platform to multiple MDM partners, diverse enterprises with different back-end email servers to selectively provide sponsored email to mobile enterprise users where each subscriber can be under a single cellular operator network or switches between different cellular operators' network. Among other benefits, implementations can work independently of any need for a MDM solution. Also, implementations can work whether the email server resides on enterprise premises or in the cloud.

By using implementations, enterprise providers may enable employees to use BYOD devices and use employer-provided enterprise applications, where the company directly pays the corporate data usage, while the user remains responsible for other data usage. This mechanism of separately charging the mobile subscribers for using company-provided enterprise apps from their personal data plans is termed split-billing, which can work with or without requiring a MDM solution. For example, an enterprise can use apps integrated with a software development kit (SDK) that enables split-billing, as described elsewhere in this disclosure, without requiring an MDM solution. Further, split billing allows provision to split the bill in any proportion, e.g., 50-50, 80-20, or the like, between consumers and sponsors.

Among enterprise apps running on BYOD devices and paid by enterprises, email is typically one of primary applications sponsored by organizations. In embodiments of the present disclosure, a sponsored email service is provided as a part of split-billing plan that operates with or without the presence of an MDM solution, where configuration settings for any email client can be pushed either by an MDM partner or can be manually set into the device by a configuration file. Further, a MDM partner can choose to configure and customize BYOD enterprise applications based on user-groups or user-profiles. For example, users with certain rights and privileges can be allowed unified messaging (voice, video, fax, text) in the email account settings as part of a company sponsored data plan. Further personal email settings of a client, including notifications and syncing options for email, contacts, tasks, and calendar may be preserved by this sponsored service over HTTPS.

Methods and systems for delivering multi-rated, sponsored data to subscriber applications, while charging content providers, advertisers, or others for the amount of data allowed to each subscriber from each device, are disclosed elsewhere in this disclosure and in the documents incorporated herein by reference. The kind of sponsored email service discussed herein is independent of such solutions and allows easy integration to any operator network, with the operator providing enterprise subscription and billing.

A present solution may work over the top using HTTP/HTTPS on any mobile platform, with either native email clients or with standard email applications available, such as in an app store, without being dependent on the make and model of the device. Various examples of different email clients using different mobile OS platforms are enabled, such as, without limitation: CLOUDMAGIC®, Mailbox, and Inbox supported by ANDROID® and iOS®; Mail.app and Dispatch, supported by iOS® and iPhone® respectively; OUTLOOK®, supported by ANDROID®, iOS® and Windows Mobile; and iOS® OEM apps and MYMAIL®, supported by ANDROID®.

With diverse enterprise email apps in the market, sponsored data services offer flexibility in multi-rating enterprise apps, when diverse email servers are supported by different MDM partners and also when no MDM partner is available. Differently charging mobile app services is referred to herein as “multi-rating” and is described in more detail elsewhere herein and in the documents incorporated herein by reference. With a multi-rating solution in place, enterprise providers can be billed differently based on rights and privileges associated with individual profiles in email settings. For example, an engineer and a business executive can be provided with different data plans by the enterprise.

In embodiments, as a typical mobile operating system or platform comes with varying enterprise apps, sponsored data users can switch between those applications at any time and roam across different geographical areas on the same network or among different operator networks. For example, a mobile subscriber registered as an employee of two different companies can use two email clients with altogether different configuration settings for accessing company emails. Moreover, a subscriber can roam from India to Bangladesh and back on a company tour. During this duration he may be using a cellular network or Wi-Fi. Further, subscribers can change a SIM card and be in different operator networks completely and still be able to access company provided BYOD apps under the company provided data plan. In such situations, sponsored data service may take into consideration the current state of the mobile subscriber in terms of location, cellular or Wi-Fi network being accessed, operator network being used, and enterprise app being used.

Provided herein are methods and systems to enable authorized multi-rated email services for different enterprise providers on employees' BYOD devices in cellular operator networks. Embodiments enable various email types and mobile operating systems, with split-billing. In embodiments, the solution may be independent of any need for an MDM solution and independent of any need for an operator network sponsored data solution. In embodiments, no integration is required with an email client, as the solution works for native email clients. In embodiments, there is also no need for dependency on a particular device OS, make or model. Implementations work when the email server is on premises or in the cloud.

In embodiments, a unified platform is provided for all kinds of sponsors to customize sponsorship or subsidies for content according to their needs.

Embodiments of this disclosure present an enhanced mobile marketing solution to enable selective content sponsorship for various content-providers on websites as viewed by mobile users. A sponsor, using the platform described herein, may allocate different portions of subsidy to different content types and may dynamically manage levels of sponsorship based on shifting marketing needs, network conditions, intended audience, and the like. Among other things, the disclosure offers mechanisms to sponsor content differently based on viewing characteristics of various target audiences and marketing strategies of content partners.

To enable selective content sponsorship, a software development kit (SDK) is provided, which operates in a client-server solution to allow a sponsor or other party to develop, deploy and manage a sponsored campaign that delivers content to mobile web browsers on mobile devices of a targeted audience. In embodiments, the SDK comprises a JavaScript SDK (“JS-SDK”) having components that are dynamically loaded to one or more mobile web browsers on one or more mobile devices and components that are loaded on and served from one or more servers, such as residing in the cloud or in an environment hosted by a sponsor or by a host of the platform described throughout this disclosure.

In embodiments, an SDK, such as the JS-SDK, may be used to facilitate or enable a wide range of different types of campaigns, including, in various embodiments, the different types of campaign described throughout this disclosure and in the documents incorporated herein by reference.

In embodiments, a software development kit is provided for enabling at least partial sponsorship of at least a portion of the content of a mobile website by a content sponsor, where the software development kit includes a device-side component to be loaded on a user device; and at least one server-side component for storing content relating to the parameters for a sponsored content campaign and for serving content to the device, where upon receiving a content-specific key and an identifier from the device-side component, the server side component validates authorization of the device to receive the content associated with the content-specific key under the parameters of the campaign and authorizes the delivery of the content to the device via gateway for the sponsored content campaign.

In embodiments, a system may be configured to allow content providers and third party sponsors (generically called Sponsors in this document) to pay for transferring data to user devices. This allows Sponsors to associate their brand with a particular content that they would like to sponsor, or in case of content providers incentivize users to download their own content, as the cost of downloading the content is paid by the Sponsor instead of the user. The disclosed “sponsored data” system breaks up the delivery pipe into small chunks equal to the unit required to transfer a particular piece of content to the user, as opposed to the whole pipe. It should be understood that the term “sponsored data” as used herein also encompasses split billing, zero rating, toll free data, 1-800 mobile data, two-sided data pricing. The system allows Sponsors to come forth and pay for these small chunks in exchange for brand promotion, or content promotion or user incentives etc. This benefits users, by letting them consume content that they care for free, benefit Sponsors as they get brand recognition and advertising mileage through the content, and can benefit content providers by increasing user engagement with their content.

Deploying a sponsored data platform in ISP networks presents three significant challenges: 1) Traditionally the data unit is identified only by the user who is consuming it and paid for by a single entity (i.e. the subscriber or perhaps in some cases an employer paying for the subscriber's bill). A Sponsor is only interested to pay for a chunk of data pertaining to the sponsored content and that which fits in the Sponsor's budget for the activity, but there is no way today to identify each chunk of data and do so within the requirements of the Sponsor. 2) The ISP's or operator's systems are not designed to scale to identify and count individual chunks of data and bill them separately to Sponsors. Today the operator's systems count the data being exchanged in a connection with the user and are designed to bill a single entity for that pipe. 3) The subscriber needs to know before consuming the data, if someone else is paying for the data transfer. This enables the subscriber to make an informed decision whether to download data or not. Today there is no integrated way for subscriber to know when and if each and every chunk of data is being paid for by a third party, whether the third party is a content provider or a Sponsor.

ISPs must not only track the total volume of data consumed by each user, as is done currently, but also separate out the volume of sponsored data for each content provider/sponsor in order to bill them. Moreover, content providers or third party Sponsors may wish to sponsor data for only a subset of their users. For instance, Twitter might sponsor Twitter access for baseball game attendees at Fenway Park. To enforce such a sponsored data scenario, the ISP would need to identify the eligible users and then track the amount of data they used on Twitter during the baseball game. Their usage accounting should support time-, app-, location-, and user-based granularity.

In addition to detailed accounting support, a sponsored data platform should also inform users that their data is being sponsored. Thus, the platform integrates with both the ISP, in order to enforce accurate usage counting, and the content provider, in order to inform users that their data is being sponsored.

The disclosed sponsored data system enables a marketplace where content is available to be sponsored and anyone would have the ability to sponsor the broadband data required for transferring the data to the user devices for consumption of content.

The disclosed sponsored data system and method can be summarized as following: a dynamic platform for sponsored data that a) identifies each and every chunk of content that a Sponsor would like to pay for the data transfer (sponsored data), b) integrates with the ISP to enable the ISP to not charge the subscriber for the sponsored data, c) enables the reverse billing for each content so it can be charged separately to the Sponsor.

The disclosed system may be implemented using an interface application that interfaces between sponsored data management software and mobile applications on user devices or a web-based interface application to integrate with Content Sites, to package each chunk of sponsored data and to inform users of dynamically available data sponsorships. It should be understood that the interface application may be implemented as an SDK. The interface application or SDK integrates with a provisioning and accounting platform in the cloud that; a) integrates with the ISP network for detailed sponsored data accounting; b) provides an analytics portal for content providers and ISPs to view statistics of the types and users of sponsored data; and c) allows Sponsors to create promotion packages by specifying the users, content to sponsor, and monetary amount to sponsor in a way that is possibly location-, time-, content-, and user-specific. The SDK includes a dynamic approval engine that decides if a chunk of data corresponding to any content is sponsored by a third party or to be paid for by subscriber. It also includes a cache DB on the device to cache the rules associated with the sponsorship for efficiency and it includes a messaging infrastructure to appropriately message the user prior to the data flow so the user can decide to consume content or not.

The sponsored data platform generally includes three main components: an SDK on user devices, a cloud component interfacing with ISP networks and content provider servers, and a portal for creating promotion packages and viewing sponsored data analytics.

The SDK is integrated into the apps that content providers wish to sponsor or into the content web site. It handles control plane communication with the cloud component, verifying user eligibility for different promotion packages, and ensuring that such sponsored traffic is flagged appropriately to distinguish it from non-sponsored data. The SDK also provides information such as the user ID and location, enabling detailed accounting in the cloud component. Handling this communication through a pre-built SDK makes the system modular, simplifying the content provider's integration with the ISP.

The SDK can also be used to gather network quality information and send it to the cloud. For instance, data traffic during times of lower congestion generally costs ISPs less than traffic at congested times. Thus, if the ISP wishes to give discounts to data sponsored at less congested times, the SDK can be used to determine network congestion in real-time for each user.

The cloud component interfaces with the SDK, the ISP network, and the content providers' servers. The cloud component has several DNS server and proxy boxes located in datacenters throughout the world, easily allowing devices to access the nearest box when using sponsored data. Data traffic flagged by the SDK as sponsored passes through the ISP network and proxy box, where it is counted and associated with a timestamp, user ID, and app.

The data counts are stored in a database in the cloud, which connects to an analytics server and external portal. The portal can be accessed by ISPs, content providers and third party Sponsors with different access privileges. ISPs can view the sponsored data usage volumes for different apps on its network at different times and locations. The analytics server compares this usage to historical usage patterns and highlights found anomalies. Content providers can similarly view sponsored data usage for different users and locations, as well as, the amount of data used with different promotion packages.

A separate screen of the portal allows sponsors to create and purchase sponsored data promotion packages. Each content provider views a sponsored data marketplace listing the apps available to be sponsored (i.e., those integrated with the SDK). Content providers with integrated apps can also provide specific URL links to be sponsored; the SDK can then flag traffic as sponsored only for those URLs.

To create a promotion package, the content provider first specifies the content (apps and URL links) to be sponsored by the package. The provider then specifies the users eligible for this package. ISP network, specific phone numbers, user location or other demographic information imported from a database may be used to specify users. Finally, the content provider specifies the monetary amount it is willing to spend on this promotion package as well as package expiration dates. Further details such as location, time, content, and user type specificity can be prescribed too.

In more detail, a sponsored data system is disclosed. The system is configured to operate with a wireless mobile device running an app that receives sponsored data from a content provider server. The system includes an interface application configured to run on the wireless mobile device, the interface application being configured to determine availability of sponsored data. The system also includes a cloud platform configured to interface with the content provider server, the cloud platform being configured to generate a token with data usable to determine availability of sponsored data and transmit the token to the interface application. The system also includes a portal configured to create and store a promotion package that identifies at least a portion of the data associated with the app as sponsored data.

The cloud platform may be configured to transmit caching rules to the interface application, the caching rules including at least one of an amount of data that is sponsored, a duration, a type of content associated with the token, the interface application being configured to determine availability of sponsored data based on the token and the caching rules. The system may also include a proxy box configured to receive sponsored data from the content provider server and send the sponsored data to the wireless mobile device, the proxy box being configured to record a number of bytes of sponsored data sent to the wireless mobile device. The system may also include an analytics server configured to receive the number of bytes of sponsored data from the proxy box and aggregate usage information for each sponsored data session.

The portal may be configured to allow a content provider to select content associated to be sponsored in a promotion package. The portal may be configured to store a plurality of parameters associated with the promotion package, the parameters including at least one of an amount of money left in the promotion package, an identification of the content sponsored by the promotion, users eligible for the promotion, a mobile data operator and a location of user device. The portal may be configured to store a list wireless mobile device phone numbers that are eligible to receive sponsored data. The portal may be configured to store a list of ISP networks associated with sponsored data. The portal may be configured to store at least one of an amount of money allocated towards providing sponsored data in a given promotion package, a maximum spending per user and per app included in the promotion package, and an expiration date and time.

A sponsored data distribution method is also disclosed. The method is also configured to operate with a wireless mobile device running an app that receives sponsored data from a content provider server. The method includes providing an interface application configured to run on the wireless mobile device, the interface application being configured to determine availability of sponsored data. A cloud platform is also provided and is configured to interface with the content provider server, the cloud platform being configured to generate a token with data usable to determine availability of sponsored data and transmit the token to the interface application. A portal is also provided and is configured to create and store a promotion package that identifies at least a portion of the data associated with the app as sponsored data.

The cloud platform may be configured to transmit caching rules to the interface application, the caching rules including at least one of an amount of data that is sponsored, a duration, a type of content associated with the token, the interface application being configured to determine availability of sponsored data based on the token and the caching rules. The system may also include a proxy box configured to receive sponsored data from the content provider server and send the sponsored data to the wireless mobile device, the proxy box being configured to record a number of bytes of sponsored data sent to the wireless mobile device. The system may also include an analytics server configured to receive the number of bytes of sponsored data from the proxy box and aggregate usage information for each sponsored data session.

The portal may be configured to allow a content provider to select content associated to be sponsored in the promotion package. The portal may be configured to store a plurality of parameters associated with the promotion package, the parameters including at least one of an amount of money left in the promotion package, an identification of the content sponsored by the promotion package, users eligible for the promotion, a mobile data operator and a location of user device. The portal may be configured to store a list wireless mobile device phone numbers that are eligible to receive sponsored data. The portal may be configured to store a list of ISP networks associated with sponsored data. The portal may be configured to store at least one of an amount of money allocated towards providing sponsored data in the promotion package, a maximum spending per user and per app included in the promotion package, and an expiration date and time.

In embodiments, a sponsored data system configured to operate with a wireless mobile device running an app that receives sponsored data from a content provider server is provided in accordance with the present disclosure. The system includes an interface application configured to run on the wireless mobile device. The interface application is configured to determine availability of sponsored data. A cloud platform is configured to interface with the content provider server. The cloud platform is configured to generate a token with data usable to determine availability of sponsored data and transmit the token to the interface application. A portal is configured to create and store a package that identifies at least a portion of the data associated with the app as sponsored data.

In embodiments, the portal allows configuration of settings for a campaign for distributing a toll-free app. In embodiments, the configuration of settings in the portal allows the toll-free app campaign to be distributed by short message service (SMS). In embodiments, the portal allows configuration of settings for a campaign for distributing different elements of sponsored data at different pricing rates. In embodiments, the multiple pricing rates include at least two of fully sponsored, partially sponsored, and unsponsored pricing rates.

In embodiments, the portal allows configuration of a campaign for at least one of a plurality of jurisdictions, a plurality of content categories, and a plurality of carrier networks. The portal further allows configuration of a campaign that includes mobile credit rewards for a plurality of carrier networks. The portal also allows configuration of a campaign for a plurality of content categories selected from the group consisting of toll-free advertising, partially sponsored advertising, toll-free video, partially sponsored video, toll-free use of a specified application, partially sponsored use of a specified application, toll-free data, partially sponsored data, toll-free email, and partially sponsored email.

In embodiments, the portal allows configuration of settings for a campaign that includes delivery of toll free video advertising to the mobile device. In embodiments, the interface application includes a software development kit on the mobile device that separates traffic that is sponsored from traffic that is not sponsored based at least in part on the token generated by the cloud platform. In embodiments, the software development kit is a JavaScript software development kit. In embodiments, the portal allows the sponsor of a campaign to configure parameters for the campaign selected from the group consisting of at least one carrier network on which the campaign will be provided, a timing for the campaign, an aggregate sponsorship amount for the campaign, a per user sponsorship amount for the campaign, at least one type of content to be sponsored, and at least one jurisdiction for the campaign.

In embodiments, the cloud platform further includes a gateway for tracking sponsored data usage by the mobile device. In embodiments, a facility for arranging for billing of appropriate sponsored elements of a campaign to a sponsor based on the tracking of sponsored data by the gateway. The cloud platform is configured to transmit caching rules to the interface application, the caching rules including at least one of an amount of data that is sponsored, a duration, a type of content associated with the token, the interface application being configured to determine availability of sponsored data based on the token and the caching rules.

In embodiments, a system including a software development kit for enabling at least partial sponsorship of at least a portion of the content of at least one of a mobile website and a mobile application by a content sponsor. The system includes a device-side component of the software development kit to be loaded on a user device. The system also includes at least one server-side component of the software development kit for storing content relating to the parameters for a sponsored content campaign and for serving content to the device. Upon receiving a content-specific key and an identifier from the device-side component, the server-side component validates authorization of the device to receive the content associated with the content-specific key under the parameters of the campaign and authorizes the delivery of the content to the device via a gateway for the sponsored content campaign.

In embodiments, the software development kit is provided within an encapsulated template structure. In embodiments, the gateway is configured at least in part via a sponsor portal that allows configuration of settings for a campaign. In embodiments, the portal allows configuration of settings for a campaign for distributing different elements of sponsored data at two or more pricing rates among fully sponsored, partially sponsored, and unsponsored pricing rates. The portal also allows the sponsor of a campaign to configure parameters for the campaign selected from the group consisting of at least one carrier network on which the campaign will be provided, a timing for the campaign, an aggregate sponsorship amount for the campaign, a per user sponsorship amount for the campaign, at least one type of content to be sponsored, and at least one jurisdiction for the campaign. The portal further allows configuration of parameters for the gateway that include tracking components for an aggregate campaign that includes distribution of sponsored data for at least one of a plurality of jurisdictions, a plurality of content categories, and a plurality of carrier networks.

In embodiments, the configuration is for different content types, wherein the content types are selected from the group consisting of toll-free advertising, partially sponsored advertising, toll-free video, partially sponsored video, toll-free application usage, partially sponsored application usage, toll-free data, partially sponsored data, toll-free email, and partially sponsored email. In embodiments, the software development kit separates traffic that is sponsored from traffic that is not sponsored based at least in part on a token for a campaign handled at least in part by the server-side component.

In embodiments, the system includes a facility for arranging for billing of appropriate sponsored elements of a campaign to a sponsor based on the tracking of sponsored data by the gateway. In embodiments, the software development kit is configured to handle caching rules that are set based on the configuration of the campaign, the caching rules including at least one of an amount of data that is sponsored, a duration, a type of content associated with the token, the software development kit configured to determine availability of sponsored data based on the token and the caching rules.

### BRIEF DESCRIPTION OF THE DRAWINGS

The foregoing and other objects, features and advantages of the devices, systems, and methods described herein will be apparent from the following description of particular embodiments thereof, as illustrated in the accompanying drawings. The drawings are not necessarily to scale, emphasis instead being placed upon illustrating the principles of the devices, systems, and methods described herein.

FIG. 1 shows various components of the mobile digital marketing ecosystem.

FIG. 2 shows data usage for advertisements on a number of popular sites visited by mobile device users.

FIG. 3 shows a typical workflow for mobile advertising in accordance with the present disclosure.

FIG. 4 illustrates an exemplary workflow with an operation management suite (OMS) widget integrated with the buy-side ad server in accordance with the present disclosure.

FIG. 5 illustrates an embodiment of the workflow with the OMS widget integrated with the sell-side ad server in accordance with the present disclosure.

FIG. 6 illustrates the workflow with an OMS widget integrated with the publisher SDK in accordance with the present disclosure.

FIG. 7 shows signaling and data flows for toll-free ads for buy-side and/or sell-side solutions in accordance with the present disclosure.

FIG. 8 shows signaling and data flows for toll-free ads when using a publisher widget in accordance with the present disclosure.

FIG. 9 demonstrates that mobile ads content may be pre-downloaded when the cell capacity usage is low in accordance with the present disclosure.

FIG. 10 shows a workflow for ad content pre-loading in accordance with the present disclosure.

FIG. 11 shows an adaptive scheduler algorithm in accordance with the present disclosure.

FIG. 12 shows a flow wherein the mobile user installs the mobile app, such as upon encountering a promotion of the app in accordance with the present disclosure.

FIG. 13A shows a workflow of the toll-free app download for an app that is integrated with a tracking software development kit in accordance with the present disclosure.

FIG. 13B shows a workflow where a toll-free app is promoted via an SMS campaign in accordance with the present disclosure.

FIG. 14 demonstrates the functionality of ad blocking in accordance with the present disclosure.

FIG. 15 shows that a menu may be provided for the user to allow toll-free advertisements in accordance with the present disclosure.

FIG. 16 shows exemplary embodiments of a flow in which toll free ads are delivered to a computer in the presence of ad blocking software in accordance with the present disclosure.

FIG. 17 shows a whitelist OMS gateway domain in accordance with the present disclosure.

FIG. 18 illustrates an example of a current real time bidding (RTB) ad serving flow without the presence of an ad blocker in accordance with the present disclosure.

FIG. 19 shows a sequence of an RTB ad serving workflow when ad blocking is active in accordance with the present disclosure.

FIG. 20 shows different gateways deployed and clients redirected to these gateways to access sponsored content from sponsors in accordance with the present disclosure.

FIG. 21 shows a particular example of sponsored and non-sponsored traffic after being authenticated from an authenticator in accordance with the present disclosure.

FIG. 22 shows how bytes accounted by individual gateways can be billed to a sponsor in accordance with the present disclosure.

FIG. 23 shows different system components involved in billing the sponsor (e.g., content provider) in accordance with the present disclosure.

FIG. 24 shows different email servers deployed in various scenarios with or without a MDM partner's presence for different email clients in accordance with the present disclosure in accordance with the present disclosure.

FIG. 25 shows a flow diagram of sponsored and non-sponsored email being served after being authenticated from the authenticator, after requests are served from a landing web server in accordance with the present disclosure.

FIGS. 26A and 26B show a control chart of serving email from a back-end email server in a cellular network in accordance with the present disclosure.

FIG. 27 shows an embodiment of email clients on diverse mobile platforms being served sponsored data, where each email client's configuration settings are managed by an MDM virtual private network (VPN) server/enterprise mobility management (EMM) in accordance with the present disclosure.

FIG. 28 shows email clients on diverse mobile platforms being served sponsored data, where each email client's configuration settings have been setup manually without EMM in accordance with the present disclosure.

FIG. 29 shows a portal interface for on-boarding a content partner and setting up integration and download of JS to support a sponsored content campaign in accordance with the present disclosure.

FIG. 30 shows cross carrier cross device support for a sponsored content campaign in accordance with the present disclosure.

FIG. 31A illustrates a flow for one-time content provider on-boarding for sponsored content campaigns in accordance with the present disclosure.

FIG. 31B illustrates a flow by which a content provider is allowed to create a dynamic sponsored campaign in accordance with the present disclosure.

FIG. 31C illustrates a flow for a sponsored content campaign having one or more gateways handling transmission and metering of sponsored traffic in accordance with the present disclosure.

FIGS. 32A through 32D illustrate interaction of various components for creation, hosting and operation of a sponsored campaign for one or more mobile platforms on one or more operator networks in accordance with the present disclosure.

FIG. 33 illustrates components of an embodiment of a JS-SDK system of the present disclosure.

FIG. 34 illustrates an exemplary process flow for learning the association between the mobile network header information and the ad-network attributes in accordance with the present disclosure.

FIG. 35 illustrates an exemplary process including an option where the mobile network operator can provide user information to the Publisher or the SSP directly in accordance with present disclosure.

FIGS. 36 and 37 illustrate exemplary data management platforms in accordance with the present disclosure.

FIG. 38 is a block diagram showing a sponsored data container on a user device in accordance with present disclosure.

FIG. 39 is a diagrammatic view of an overall system architecture of a sponsored data system in accordance with the present disclosure.

FIG. 40 is a diagrammatic view of a content provider's portal home screen in accordance with the present disclosure.

FIG. 41 is a diagrammatic view of a portal screen configured to allow a content provider to select content associated to be sponsored in a promotion package in accordance with the present disclosure.

FIG. 42 is a diagrammatic view of a portal screen configured to allow a content provider to select users eligible for a promotion package in accordance with the present disclosure.

FIG. 43 is a diagrammatic view of a portal screen configured to allow a content provider to specify the amount of money it is willing to spend on the advertising package in accordance with the present disclosure

FIG. 44 is a diagrammatic view of an operation of the interface application or software development kit in determining and marking a sponsored data content in accordance with the present teachings.

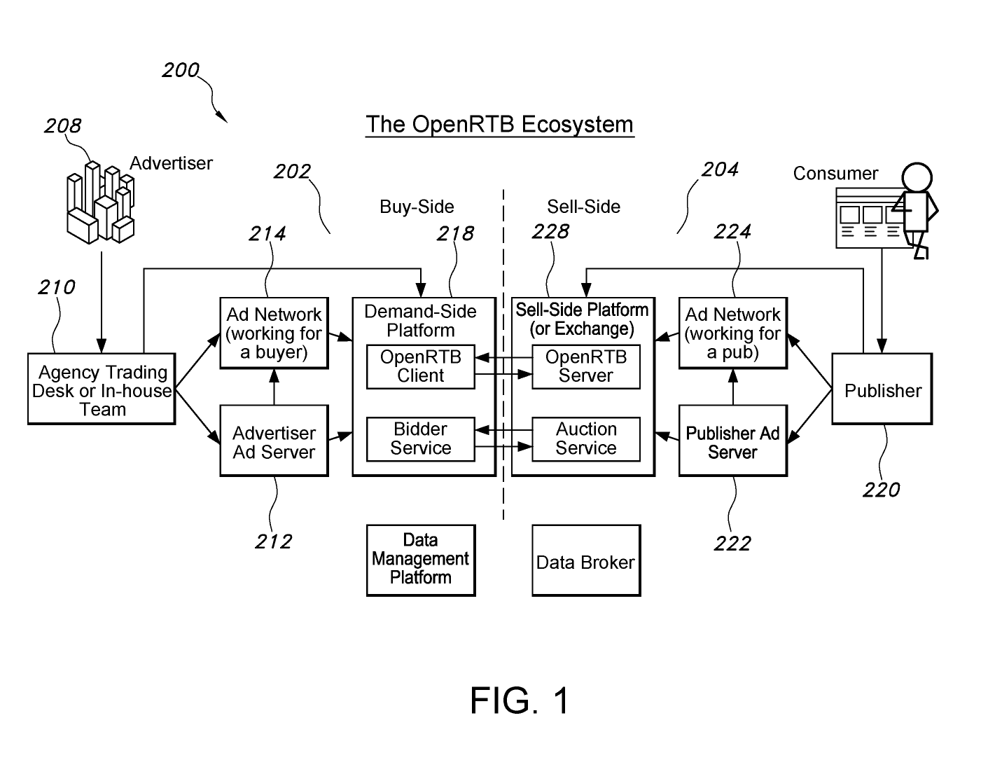

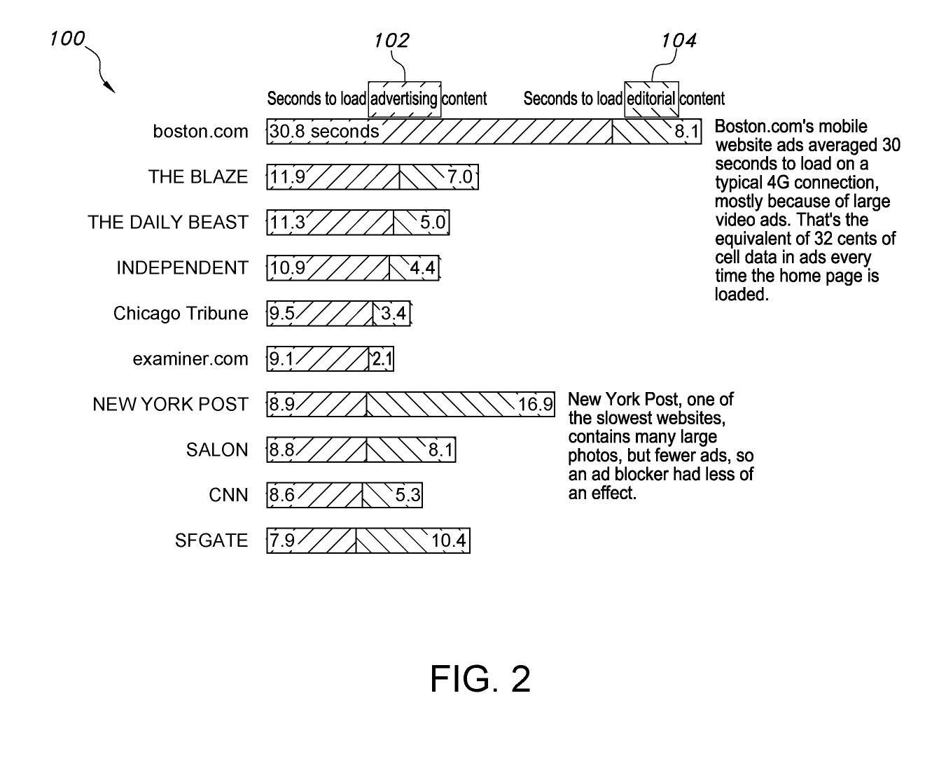

### DETAILED DESCRIPTION

The embodiments will now be described more fully hereinafter with reference to the accompanying figures, in which multiple embodiments are shown. The foregoing may, however, be embodied in many different forms and should not be construed as limited to the illustrated embodiments set forth herein. Rather, these illustrated embodiments are provided so that this disclosure will convey the scope to those skilled in the art.

All documents mentioned herein are hereby incorporated by reference in their entirety. References to items in the singular should be understood to include items in the plural, and vice versa, unless explicitly stated otherwise or clear from the context. Grammatical conjunctions are intended to express any and all disjunctive and conjunctive combinations of conjoined clauses, sentences, words, and the like, unless otherwise stated or clear from the context. Thus, the term “or” should generally be understood to mean “and/or” and so forth.

Recitation of ranges of values herein are not intended to be limiting, referring instead individually to any and all values falling within the range, unless otherwise indicated herein, and each separate value within such a range is incorporated into the specification as if it were individually recited herein. The words “about,” “approximately,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the described embodiments. The use of any and all examples, or exemplary language (“e.g.,” “such as,” or the like) provided herein, is intended merely to better illuminate the embodiments and does not pose a limitation on the scope of the embodiments or the claims. No language in the specification should be construed as indicating any unclaimed element as essential to the practice of the embodiments.

In the following description, it is understood that terms such as “first,” “second,” “top,” “bottom,” “up,” “down,” and the like, are words of convenience and are not to be construed as limiting terms unless specifically stated to the contrary.

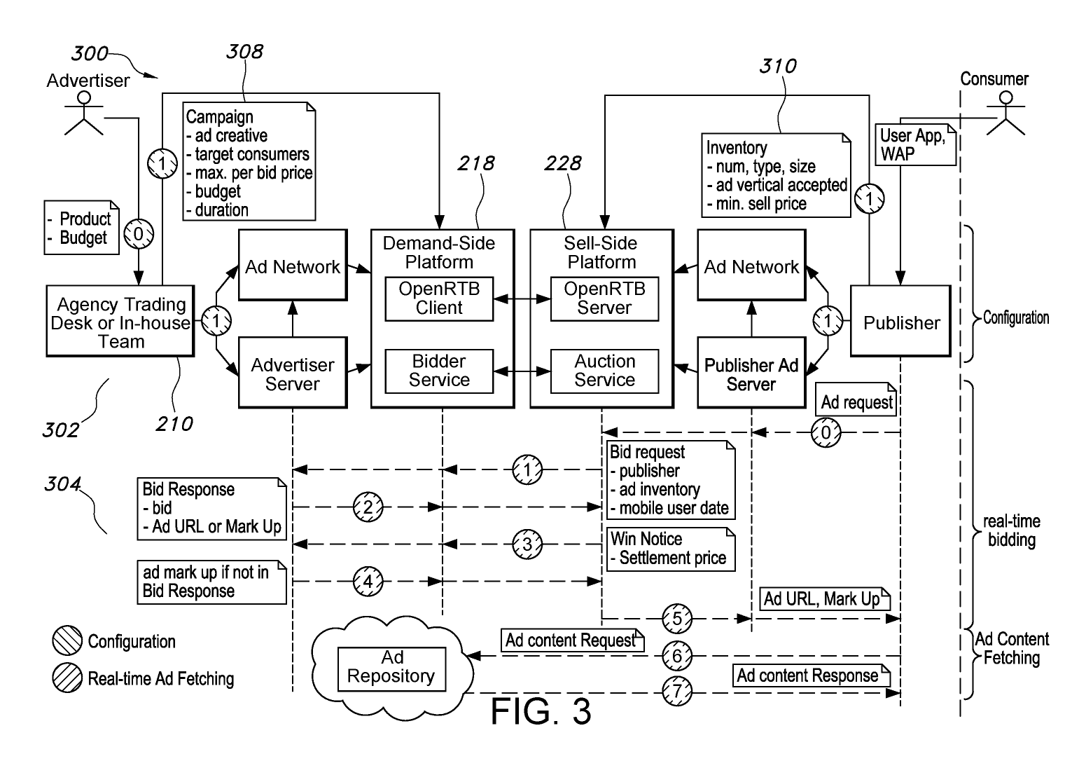

FIG. 3 shows a typical existing workflow 300 for mobile advertising. The workflow can be broken into two phases. The workflow 300 may include a configuration phase 302, where the advertiser 208 or the agency 210 may create an ad campaign 308 on one or more of the demand-side platforms (DSP) 218, and the publisher 220 may create inventory descriptions 310 on one or more of the sell-side platforms 228. In an example, the configuration phase 302 may be dynamic, but in other examples it may not change often. The workflow 300 may include an ad delivery phase 304, which may be triggered when the mobile user uses a mobile application or accesses a mobile website. The ad delivery 304 phase may include real-time ad bidding and ad video content fetching after a successful bid. In an example, the whole transaction may complete in real time, such as within fraction of a second.

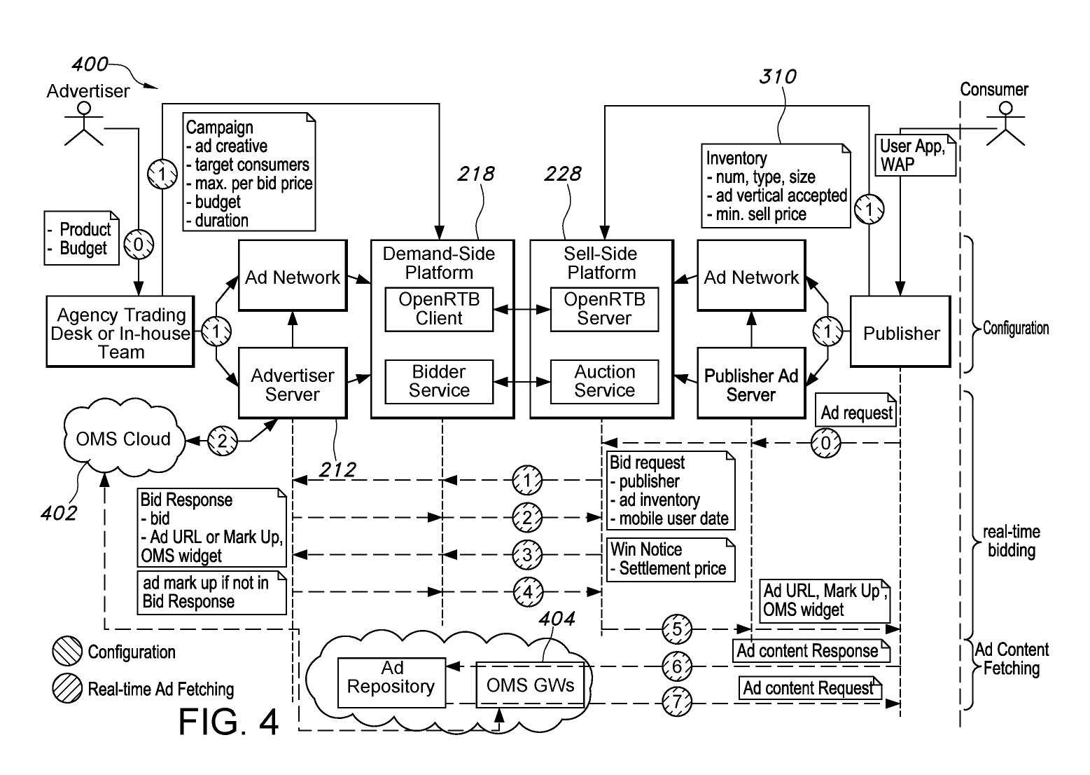

Embodiments of the present disclosure may employ an operations management suite (OMS) widget for buy-side integration. FIG. 4 illustrates an exemplary workflow 400 with an OMS widget integrated with the DSP 218. An ad server portal may offer a sponsored ad option to its advertiser and agency partners. The ad server 212 may call an OMS Cloud application program interface (API) 402 when the advertiser/agency creates a sponsored video ad campaign. The OMS Cloud API 402 may return a JavaScript Widget for the campaign. After winning a bid, the ad server 212 may send (via DSP Bidder Service) an ad video URL (or markup) and the widget to the requested publisher. The widget may direct ad video content request to an OMS gateway 404 so that the OMS gateway 404 may mark the ad video request and response as toll-free and may notify the mobile user. The ad server 212 can call the OMS Cloud API 402 to query toll-free ads analytics. This may be a one-time integration. The same solution may also work with the buy-side ad network 214 and the DSP 218 if they offer a portal for the advertiser or the agency to run the ad campaign.

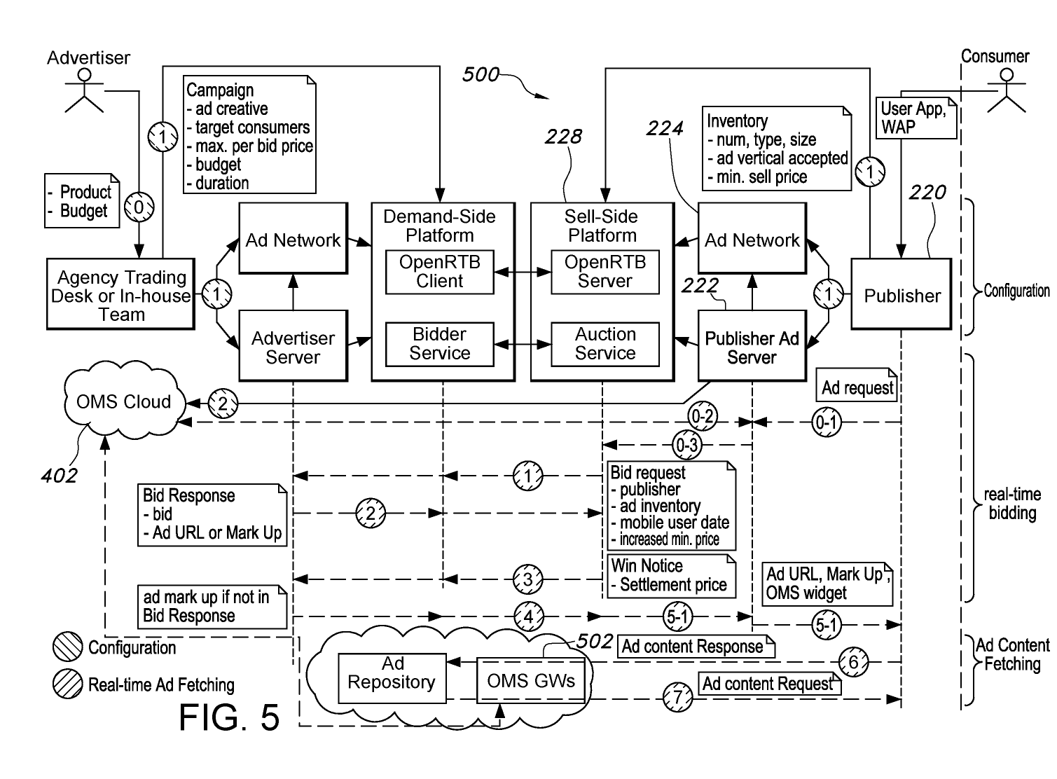

The OMS widget may also be provided for sell-side integration. FIG. 5 illustrates an embodiment of the workflow 500 with the OMS widget integrated with the sell-side ad server 222. The ad server 222 may call the OMS Cloud API 402 to set a budget and/or toll-free advertising restrictions. The ad server 222 may pay for toll-free data. In return, the ad server 222 may present itself as a premium “publisher,” requesting higher minimum prices for its inventories. The ad server 222 may call the OMS Cloud API 402 before submitting an ad request to SSP auction service 228. The OMS Cloud API 402 may consider the mobile user's network condition and return the widget if the mobile user should be given toll-free ads. The ad server 222 may request a higher minimum price for this ad inventory upon receiving a positive response from the OMS Cloud API 402. Upon receiving an ad URL/Mark Up, the ad server 222 may add the widget and send it to the publisher 220. The widget may direct an ad video content request to an OMS gateway 502, and the OMS gateway 502 may mark the ad video content request and response as toll-free and notify the mobile user. The ad server 222 can call the OMS Cloud API 402 to query toll-free ads analytics. This may involve a one-time integration. The same solution may also work with the sell-side ad network 224 and/or the SSP 228 if they offer a portal for the publisher 220 to create inventory descriptions.

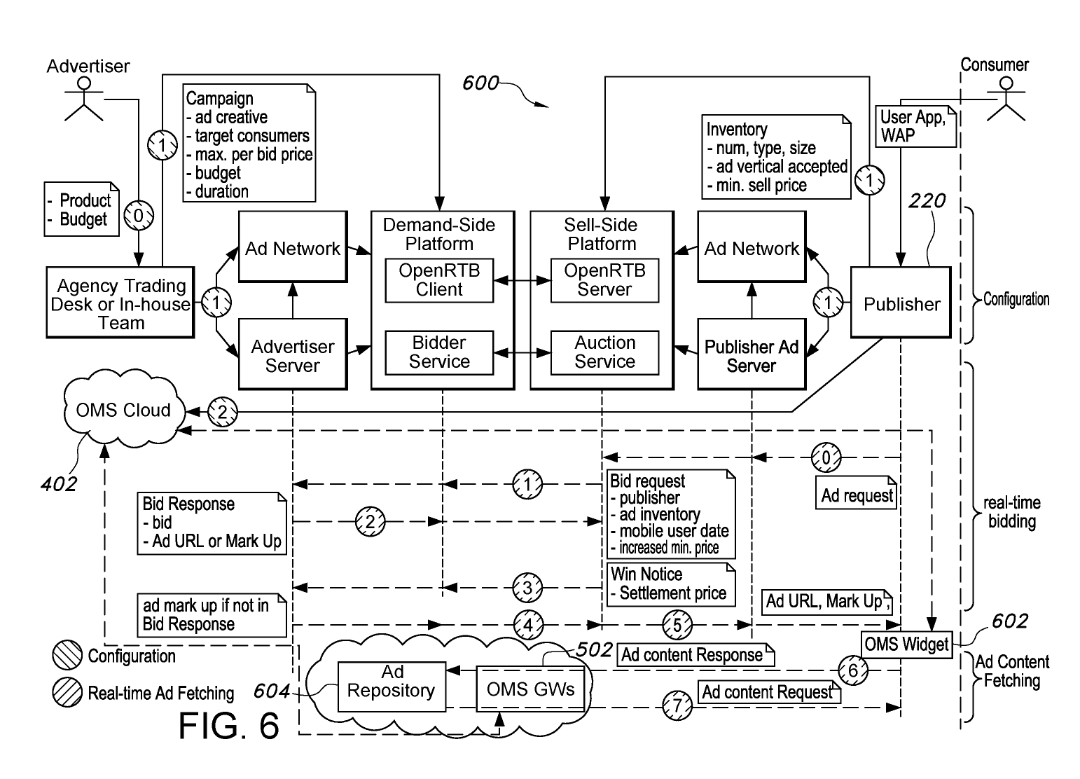

In some embodiments, the workflow may also involve the OMS widget 602 for the publisher. FIG. 6 illustrates a workflow 600 with an OMS widget 602 integrated with the publisher SDK. The publisher 220 may go to an OMS portal to set toll-free data budget and restrictions. The publisher 220 may pay for toll-free data. In return, the publisher 220 may present its inventories as ‘premium’ inventory, and may request higher minimum prices for its inventories. Upon receiving an ad URL/Mark Up, the OMS widget 602 may talk to the OMS Cloud API 402 to authorize for toll-free data. Upon successfully obtaining authorization, the OMS widget 602 may direct an ad video content request to the OMS gateway 502. Otherwise, it may direct the requests to the ad repository 604. The publisher 220 may go to the OMS portal to view toll-free analytics.

The above embodiments may provide a number of benefits to the mobile advertising ecosystem 200, including providing independent solutions for mobile marketing eco-system players. The embodiments may be easy to integrate and quick to deploy, without requiring significant modifications to existing infrastructure. No change in existing mobile marketing eco-system interfaces and workflows may be required. The methods and systems can be deployed without any adverse performance impact to ad real-time-bidding systems. The methods and systems may not require the advertiser 208 or the agency 210 to switch ad platforms. The methods and systems can provide support for advertising across advertising platforms, across operator networks, across mobile operating systems, and across different makes and models of a mobile device. The methods and systems can provide flexible toll-free budget management, network aware user targeting, and rich analytics. The methods and systems can dramatically increase video click-through rates for video advertisements, increase return of advertiser's investment, and increase the value of a publisher's inventory.

Unlike other systems, the embodiments described herein can be integrated independently with different players of the mobile marketing eco-system 200, with no changes required for the existing eco-system interfaces. There may be no adverse performance impact to the existing real-time-bidding systems. Among other things, the methods and systems may allow one to bring network awareness to mobile user targeting and provide insights of user behavior when ads are free of data charges. Among other benefits, the methods and systems described herein may not require a separate mobile app to provide toll-free ads.

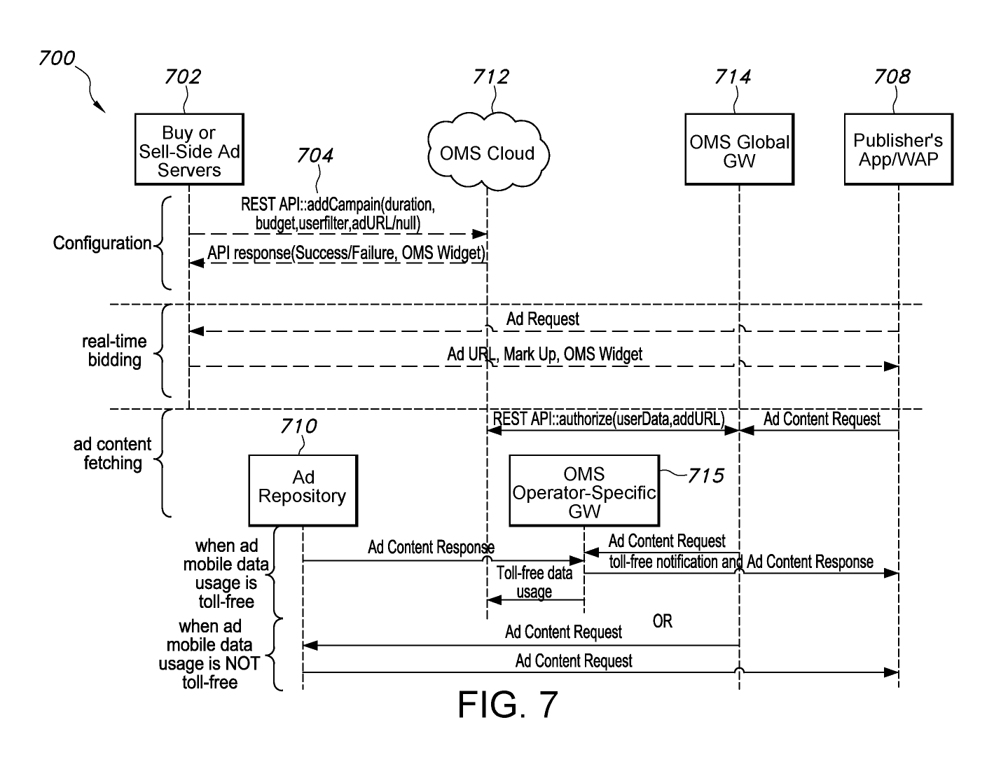

FIG. 7 shows an embodiment of a signaling and data flow 700 for toll free ad serving for buy-side and/or sell-side ad servers 702. In this example, the same flows and APIs may work for both the buy-side and the sell-side solutions.

The methods and systems may provide integration with the buy-side or sell-side ad servers 702. The integration may be a one-time task. The solution may work when the buy-side ad server 702 hosts the ad content (e.g., video ad content) or a third party hosts the content. The methods and systems disclosed herein may facilitate workflow for creation of an ad campaign. The advertiser may create an ad campaign on the buy-side ad platform 702. The buy-side ad platform 702 (which in embodiments may comprise an ad server, ad network, DSP or combination thereof, or corresponding sell-side components, such as the sell-side platform (SSP) 228, publisher ad network 224 or publisher ad server 222, or combinations thereof, as applicable) may call an OMS campaign-creation representational state transfer API 704 when the video ad campaign is created on the ad platform. In embodiments, the buy-side ad server 702 may pass an ad video URL as an argument for the API 704. The OMS cloud 712 may return an OMS widget. The buy-side ad servers 702 may store the OMS widget with the ad video URL.

Once the campaign is created and the OMS widget is stored on the buy-side platform 702, the ads for the campaign may be fetched and displayed in real-time. For example, the mobile user may use a publisher's app/WAP 708 to access the ads. The publisher's app/WAP 708 may request a video ad. The sell-side platform 228 may put an auction call to an ad exchange. The ad exchange may broadcast a bid request to the DSP 218. The buy-side ad platform 702 may bid (via the DSP 218) on an impression, send a bid response with the ad video URL, ad markup, and the OMS widget to the ad exchange. The ad exchange may send a win notification to the buy-side ad platform 702. The buy-side ad server of the buy-side platform 702 may then send the ad markup if not included in the bid response. The ad exchange may send the ad URL, markup, or the OMS widget to the publisher's app/WAP 708 via the SSP 228 and/or the sell-side platform 702. The requesting publisher's app/WAP 708 may receive the ad URL, markup, or the OMS widget and may start requesting ad content.

The OMS widget may be enabled and may direct the ad content request to an OMS global gateway. The OMS widget may modify the ad URL and the ad content request may be sent to the OMS global gateway 714. The OMS global gateway 714 may check if the request is from a device that is on a carrier network which has deployed an OMS toll-free data solution. If so, the OMS global gateway 714 may redirect the request to an OMS carrier-specific OMS gateway 715; otherwise, the OMS global gateway 714 may redirect the request to an ad repository 710. When the carrier-specific OMS gateway 715 receives the ad content request, it may forward the request to the ad repository 710. On receiving a response, it may insert a toll-free notification and send the notification and the video content to the requesting publisher app/WAP 708. The data usage of the video ad may be counted by the carrier-specific OMS gateway 715 and zero-rated by operator network.

The methods and systems disclosed herein may provide integration with the sell-side ad platform 702. The sell-side ad platform 702 may benefit from a sponsored video ad in many ways. The sell-side ad platform 702 may pay for the sponsored ad video initially with the confidence that the sponsored ad will lead to higher viewing and higher conversion. The sell-side ad platform 702 may gradually establish itself as a “premium” sell-side ad platform 702 and attract high-end video ads and more ads traffic. The high end video ads and high ads volume may help the sell-side pay for sponsored data expense later on. This may be a one-time integration. The sell-side ad platform 702 (which again may comprise an ad server, publisher ad network, SSP or combination thereof) may call the OMS cloud API 712 to create a toll-free ad campaign by specifying campaign duration, target users, total budget and per-user budget.

The methods and systems described herein may facilitate the workflow. When receiving the ad request from the publisher app/WAP 708, the sell-side may call an OMS cloud API 712 to check if this mobile user can be sponsored for an ad. The OMS cloud application 712 may validate the mobile user against the toll-free ad campaigns created. If the user can be sponsored, the OMS cloud application 712 may return the OMS widget if the mobile user is authorized to get toll free ads. The sell-side may increase the minimum price for this “impression” when the mobile user can be sponsored. On winning the ad auction, the SSP 228 may receive the original video ad URL, or markup and send the ad URL, the markup, or the OMS widget to the requesting purchaser's app/WAP 708. When the requesting purchaser's app/WAP 708 receives the ad URL, the markup, or the OMS widget, it may start requesting the ad content. The rest of the workflow remains same as discussed above.

The OMS widget may modify the ad URL and the ad content request may be sent to the OMS global gateway 714. The OMS global gateway 714 may check if the request is from a device that is on the carrier network which has deployed the OMS toll-free data solution. If so, the OMS global gateway 714 may redirect the request, such as to the carrier-specific OMS gateway 715. Otherwise, the OMS global gateway 714 may redirect the request to the ad repository 710. When the carrier-specific OMS gateway 715 receives the ad content request, it may forward the request to the ad repository 710. On receiving the response, it may insert the toll-free notification and send the notification and the video content to the requesting purchaser's app/WAP 708. The data usage of the video ad may be counted by the carrier-specific OMS gateway 715 and zero-rated by operator network.

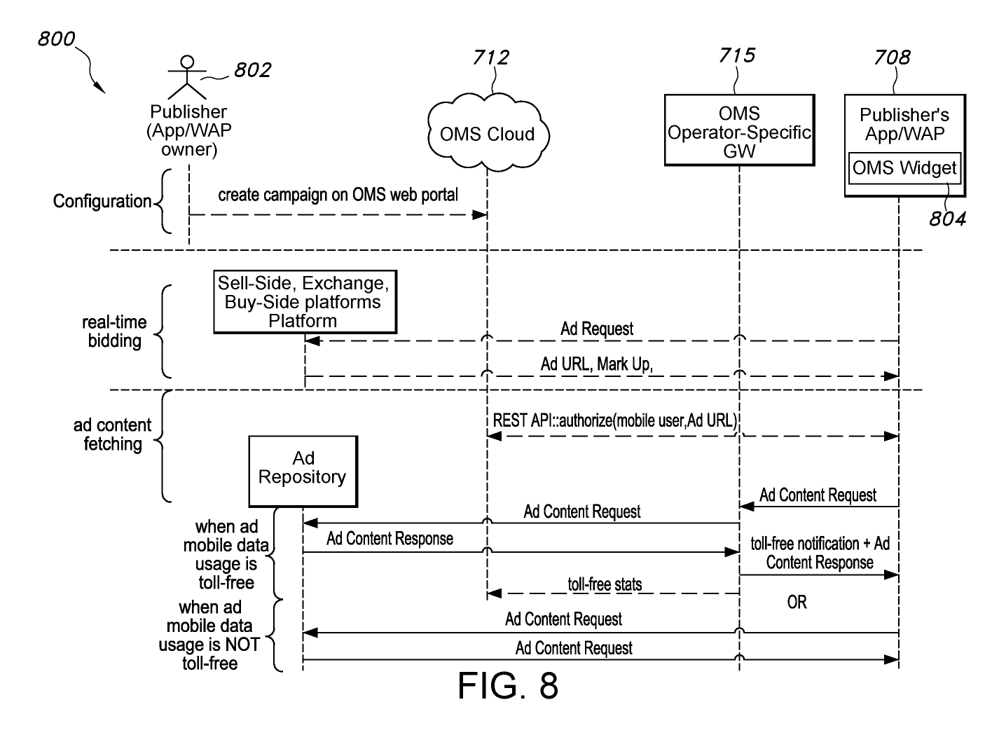

In an example, the methods and systems disclosed herein may facilitate toll-free signaling and data flow as a publisher solution. FIG. 8 shows toll-free ads signaling and data flows 800 when using a publisher widget.

The publisher 802 may integrate the OMS widget (SDK) 804 with the publisher's app and/or the WAP 708. The publisher 802 may create a toll-free campaign with duration, budget and user filters on the OMS portal. The mobile user may use the publisher's app/WAP 708. The ad request may be sent from the publisher's app/WAP 708. After real-time bidding, and the response is sent to the publisher's app/WAP 708 with the ad URL or markup, the OMS widget 804 may call the OMS cloud API 712 to check if the mobile user is authorized to use the toll-free data. The OMS widget 804 may direct the ad content request to the carrier-specific OMS gateway 715 if the mobile user is authorized. The carrier-specific OMS gateway 715 may pass the request to the ad repository 710 server. Upon receiving the response, the OMS gateway 714 may insert the toll-free notification and send the notification and the video content to the requesting publisher's app 708.

In accordance with various alternative embodiments, several examples of usages of the embodiments disclosed herein may be possible. For example, the advertiser 208 may pay for a new movie promotion at include many cinemas in the promotion. One of the cinemas in the campaign may promote new movies via an ad campaign over SMS messages. The ad campaign may deliver an ad via SMS to mobile users who are in a one-kilometer radius of the cinema. The cinema may be located in a shopping plaza or other venues where there is no public Wi-Fi access. Though there may be high foot traffic around the cinema and many mobile users may accept the SMS message, the number of mobile users who watch a movie trailer to which a link directs them to an ad may be small. Among the mobile users who did watch the movie trailer, many of them may quit before the video ends because of the slow video download, low video resolution, network traffic, or the like. This may be caused by the high foot traffic in the shopping plaza where many mobile users may have to share same cell sites. The mobile users may download the publisher's app/WAP 708 or the like to deploy selected sponsored content on the devices of the mobile users.

The cinema may employ a different ad campaign strategy and decide to sponsor the data usage of a mobile user who watches the movie trailer in accordance with the methods and systems disclosed herein. The new ad campaign may still target users within a one-kilometer radius of the cinema, but the SMS message may state that the mobile user can watch the video content, such as a movie trailer, free of charge or the usage can zero rated by the operator network. In operation, the cinema may see an increased number of mobile users watching the movie trailer and buying tickets for the cinema. Even though the same percentage of mobile users may quit watching video due to poor quality, the increased amount of mobile users viewing at least a portion of the video content may increase.

The methods and systems disclosed herein facilitate handling of pre-loading of mobile advertisements (PLMA) during valleys in cell capacity usage in an operator network.

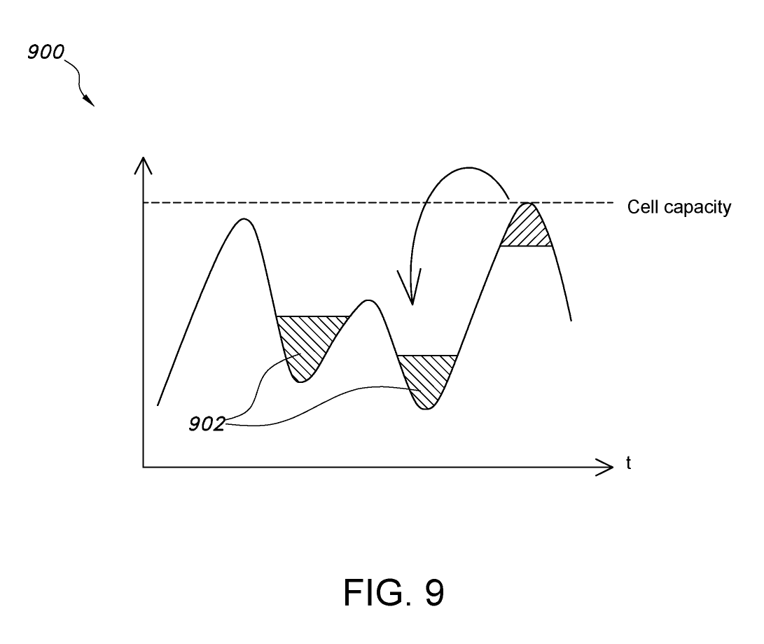

The methods and systems may utilize the solutions described above to pre-load a rich-media ad content at a capacity usage valley of the operator network. The methods and systems may bring many benefits including without limitation, smoother-playing media, higher video and audio resolution, and higher video and audio quality. The methods and systems may work with the toll-free ads solutions described above to bring high quality mobile ads to users free of data charge while retaining superb user experiences. The methods and systems may be built upon the network capacity inference and scheduling algorithms in accordance with present disclosure that may detect the capacity usage valley in real-time at seconds granularity, also known as “micro-night.” This solution may include an adaptive scheduler included in the app/WAP 708 residing on the mobile device to schedule a content request at a “micro-night.” The methods and systems may expose a client-side API through which a mobile application may fetch the mobile ad content. As a result, the content server may provide content with higher resolution to the mobile device because the content server may detect lower network delay, higher network bandwidth, and the like. When a user views an ad, such as playing a video ad, video may play immediately from the buffer. As demonstrated in FIG. 9, the mobile ads content may be pre-downloaded when the cell capacity usage is low.

A wide variety of ad campaigns can be enabled by the methods and systems disclosed herein, managed through the gateways as described. In embodiments, the methods and systems disclosed herein can provide applications on mobile devices that enable sessions of free data for a limited duration of time so that other users may use the mobile internet to access sponsored ad campaigns. By way of this example, applications on the mobile devices can use APIs to access free data campaigns hosted by the solution. By way of the APIs on the mobile devices of others, these mobile devices can request free data sessions through the API on their mobile devices. For these requested sessions, the application hosting the Free Data Session (FDS) sessions can pay for the network activity that is usually paid for by the user. In other instances, the brand that is funding the FDS session campaign can also fund the network time required to provide the campaign data. In paying for the network activity that is usually paid for by the mobile user, the campaign, the application, or the brand, can incur a portion of the cost) or a multiple of the cost) of the network activity.

In embodiments, subscribers can discover FDS session campaigns in native application environments such as while shopping in Amazon Prime™ or other ecommerce platforms. In further embodiments, the FDS sessions can be paid in part or in whole by advertisers and users who can discover FDS sessions geographically, such as a block party; or a venue, such as a sport stadium. In addition, the FDS session can be integrated into an advertising network already in place such as kiosk in malls, large displays in venues and any other display of media. In all of these examples, a mobile user can watch video content as part of an advertisement; and as a benefit of watching the video, the mobile user can receive a pre-paid session, such as thirty-minutes of FDS. In further embodiments, the FDS sessions can be pre-configured, such as to a set of holidays or other events, so that specific holiday-related or event-related FDS campaigns can be used. In additional embodiments, a customer can host an ad campaign and as an enterprise sponsored event when attendees may bring their own device to engage with enterprise sponsorship.

In embodiments, the methods and systems disclosed herein can include a FDS dashboard that can be a part of or in addition to the OMS that can provide a commercial user with return-on-investment information for sponsored FDS campaigns relative to previous campaigns or other ad campaigns. By way of this example, the FDS dashboard can detail availability of users' mobile devices and ad campaigns currently being offered. The FDS dashboard can also include pin-point regions depicted graphically whether on a city or municipal basis or on an event or venue basis, where FDS is not leveraged enough to target regional campaigns The FDS dashboard can also allow for the viewing of user experiences and heat maps network wide detailing activity in the pin-point regimes on which the FDS dashboard can focus. In doing so, the FDS dashboard can interact with each of the app/WAPs 708 of the mobile user. In these embodiments, the FDS campaigns can be configured in different regions and time zones to maximize their usage.

In further embodiments, the FDS dashboard can provide download management for the control of what is being downloaded during the FDS sessions in its link the app/WAP 708. Moreover, videos and high data content downloads can be saved for FDS sessions and not used unless a session is active and available so as to prioritize transmission of the sponsored content when network traffic is low. After the end of the FDS session, user level usage can be tracked and reported. The report can detail how much the user has saved by using the FDS sessions.

The embodiments may provide several advantages such as allowing use of network unused capacity to download ad content, improving the user experience for viewing ads, improving ad click-through rate and completion rate, reducing advertisement cost, improving user experiences for all users sharing the cell capacity, reducing operator network capital expenditure and operating expenditure, and the like.

Among other advantages, the methods and systems described herein may pre-fetch the ad content and may specifically pre-fetch content when there are fewer users to compete for bandwidth, and when the mobile device is experiencing better radio frequency conditions. The mobile user may have a better user experience when displaying the ad, and the ad may be shown in higher resolution, with higher quality.

In accordance with further embodiments, the methods and systems described herein allow for cellular load prediction that can determine network traffic load or cellular level load, or both. By determining, predicting, modeling, and estimating cellular levels, unused or underutilized cellular capacity can be used to reduce the cost of providing ad campaigns and/or improve the quality of service or experience for a mobile user on a cellular network, such as using the underutilized capacity to download ad content, improve user experience for viewing ads, improve ad click-through rate and completion rate, reduce advertisement cost, improve user experiences for all users sharing the cell capacity, reduce operator network capital expenditure and operating expenditure, and the like. By way of the above examples, content can be pre-fetched or be scheduled to be fetched when the prediction of cellular levels indicates there may be fewer users to compete for bandwidth, and when the mobile device should be experiencing better radio frequency conditions. As before, the mobile user not only can have a better user experience when displaying the ad, but the ad can also be shown in higher resolution, with higher quality.

By way of the above example, the prediction of the level of network load can take into account types infrastructure used by the mobile devices, the times of usage of the mobile devices, and days of the week during which the mobile devices may be used. The infrastructure used by the mobile devices and the towers, and other fixed infrastructure to which the mobile devices connect can dictate the ability for mobile devices to receive larger amounts of data or the mobile device itself can be the restriction, or both. Moreover, the prediction of the level of cellular load or network load can be used to determine usage varying over each day or usage varying over the week, or both, and use such information in the delivery and timing of or pre-fetching of advertising content at times that facilitate a better user experience when displaying the content.

In further embodiments, the methods and systems described herein allow changes to configuration and dynamic adjustment for known events that may affect the network traffic. In one such example, a scheduled football game against the New England Patriots in Foxboro Stadium will by itself create network demands and cause network traffic, but also provide many candidates for sponsored campaigns. In this example, the possible content of sponsored content or non-sponsored content, or both, and can be pre-fetched prior to the game. In other examples, pauses in game activity can serve as moments to direct the user of the mobile device to campaign material or in determinations such pause in the game can be a candidate to load and pre-fetch material with the anticipation of less network load at the time. In embodiments, constant and real time monitoring of network traffic can be provided by the methods and systems provided herein. The constant and real-time monitoring of traffic can provide real time feedback for adjustment of cellular and network level predictions. In doing so, it can be shown that ad campaigns can be more efficiently delivered to the monitored networks when the activity and network conditions facilitate larger transfers without apparent issues detected by the user.

In embodiments, the methods and systems provided herein can be configured so accounts for each user can be permissively associated with the ad campaigns. The accounts of each user can track the usage of each user and the regional variability in usage for each user. For example, high usage patterns in a region can lead to different customizations for each user or groups of users. By way of this example, users in the vicinity of a university campus can rely on a network that can see a lot of traffic from students watching videos. As such, network usage on a college campus can be much different than, for example, in a rural environment and the configurations and profiles for each user based on the information from their account can be used with permission in the prediction determinations of cellular and network levels. Previous activity of the user in certain locations can also be included in the prediction determinations.

In additional embodiments, the methods and systems disclosed herein can include a complete end-to-end system that can include data inputs, algorithms and feedback loops to deploy an ad campaign into a predetermined location. By way of this example, the determination of network load and parsing of campaign content can be determined without reference to any third party tools. Moreover, operations, administration and management features and other software development tools can be deployed to assist each of the users or those directing the ad campaign. As such, the methods and systems disclosed herein can be shown to provide a robust system for sponsored content and can be shown to provide high availability of functionality in this space, especially in locations with relatively high network congestion.

The methods and systems disclosed herein can include an analytics server configured to receive the number of bytes of sponsored data from proxy server or the like and may aggregate usage information for each sponsored data session. In further embodiments, the analytics server may determine cellular network levels, heat maps of the cellular activity showing usage intensity, and usage statistics. In additional embodiments, the methods and systems disclosed herein can include multiple methodologies for prediction of availability for FDS sessions and campaigns including the parsing of multiple duration FDS sessions. Such methodologies may also include prioritization of users based on existing FDS sessions or other criteria that may be provided by the user, determined from previous sessions, or determined from analytics of previous sessions and network and cellular activity. The methodologies for prediction of availability for FDS sessions and campaigns can also include managed network protection by using intelligent scheduling of FDS sessions based on the current and the predicted users.

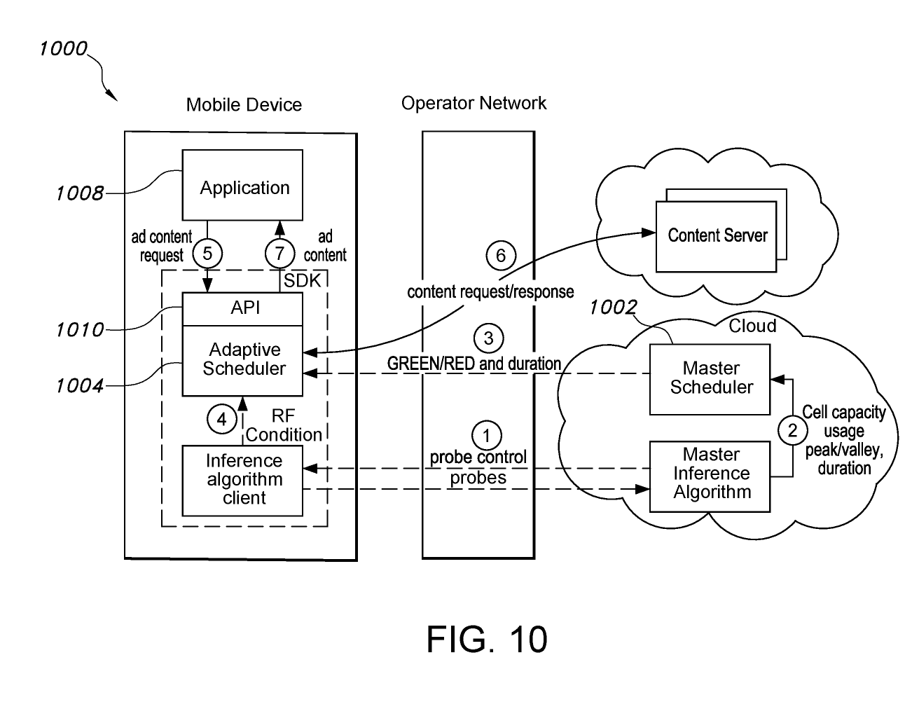

FIG. 10 shows the ad content pre-load workflow 1000. Step 1 describes a flow of crowd-sourcing cell capacity inference algorithm. A master in a cloud may control which device to send device local measurements and how often to minimize battery and data usage impact to individual devices. The master may use measurements collected from multiple devices to infer the cell capacity usage in the near future. Step 2 indicates that a cloud inference algorithm output is used by a master scheduler 1002 in the cloud to control which device and at what time duration should send content request (green/red flag, start time and duration). The purpose of the master scheduler 1002 is to ensure a fair bandwidth to each device and same time to space out requests from various devices of the same cell to avoid congestion.

Step 4 shows that an adaptive scheduler 1004 may also use local real-time radio frequency (RF) measurements for decision-making. Step 5 shows that a mobile application 1008 may call a scheduler API 1010 when requesting the ad content by passing the ad URL. Step 6 shows that the adaptive scheduler 1004 may make the request based on indication received from the master scheduler 1002, local radio frequency (RF) configuration and the amount of ad content that has been buffered or pre-fetched based on circumstances or predetermined rules discussed herein. Step 7 shows that the content is passed to the application 1008 to display. In further embodiments, the methods and systems described herein can obtain real time feedback from RF measurements for unknown events that might happen and can base decision making on those measurements.

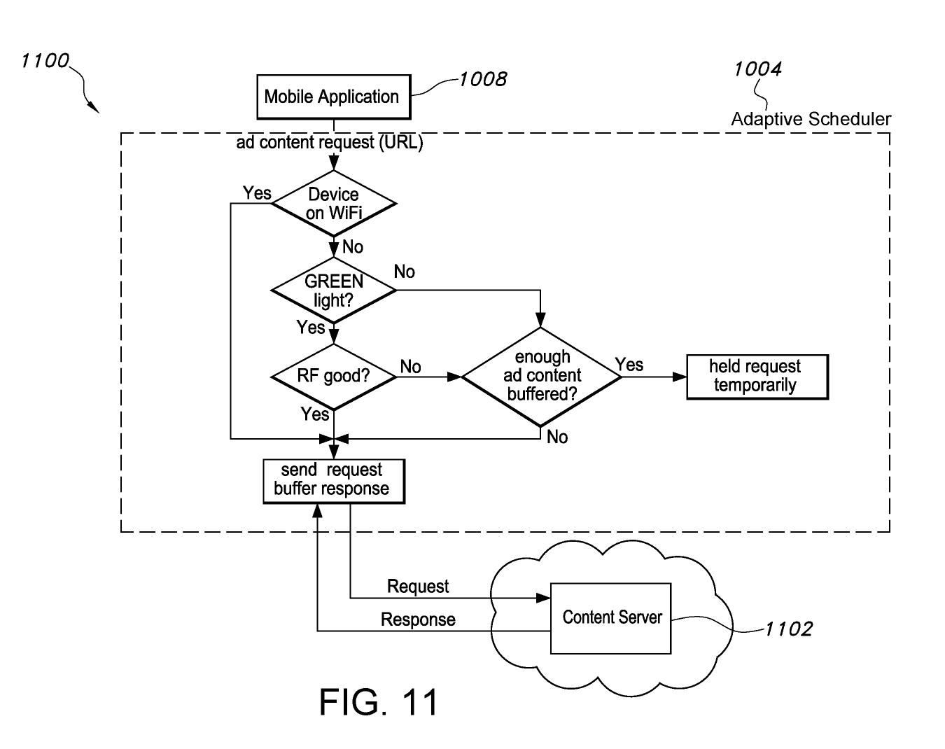

FIG. 11 shows an adaptive scheduler 1004 algorithm.

In alternative embodiments, an ad-content pre-load may work with any toll-free ad solution to provide a pre-load for a toll-free ad. In this case, the mobile application 1008 may pass a modified ad content request URL to the adaptive scheduler 1004. The adaptive scheduler 1004 may request the ad content via the OMS gateway.

In an example, the mobile application 1008 may request a video ad through the ad platform. The application 1008 may receive a URL that prompts for the video ad. The application 1008 may call the adaptive scheduler API 1010 to request ad video content before the mobile user clicks a play button. The adaptive scheduler 1004 may send the request immediately or hold the request temporarily based on algorithm logic that can network traffic as discussed herein. When a user starts playing the video, the video may play immediately from the buffer. The adaptive scheduler 1004 may ensure there is sufficient content buffered so that the user should never wait for the ad video to download. In other instances, the content server 1102 may judge that bandwidth is not sufficient in the earlier instance but still may determine that there is sufficient bandwidth to support a reduced performance (or success) ad campaign where there is congested traffic that will not dissipate until the ad campaign opportunity is over such as a sporting event. In these examples, the threshold of bandwidth sufficient to support an ad campaign can be customized based on local activity.

Because the adaptive scheduler 1004 sends the request as much as possible at cell capacity usage valley, a content server 1102 may see the request with short network delay and recognizes that there is sufficient bandwidth in the network. The content server 1102 may send video content segments in higher resolution. The user may enjoy higher resolution video with smooth video display experience.

The methods and systems may provide toll-free mobile app downloads (TMAD). This disclosure describes at least two solutions that may allow an owner of a brand to promote its mobile application via sponsoring mobile data cost occurring to a mobile user when the user downloads the application over the network.

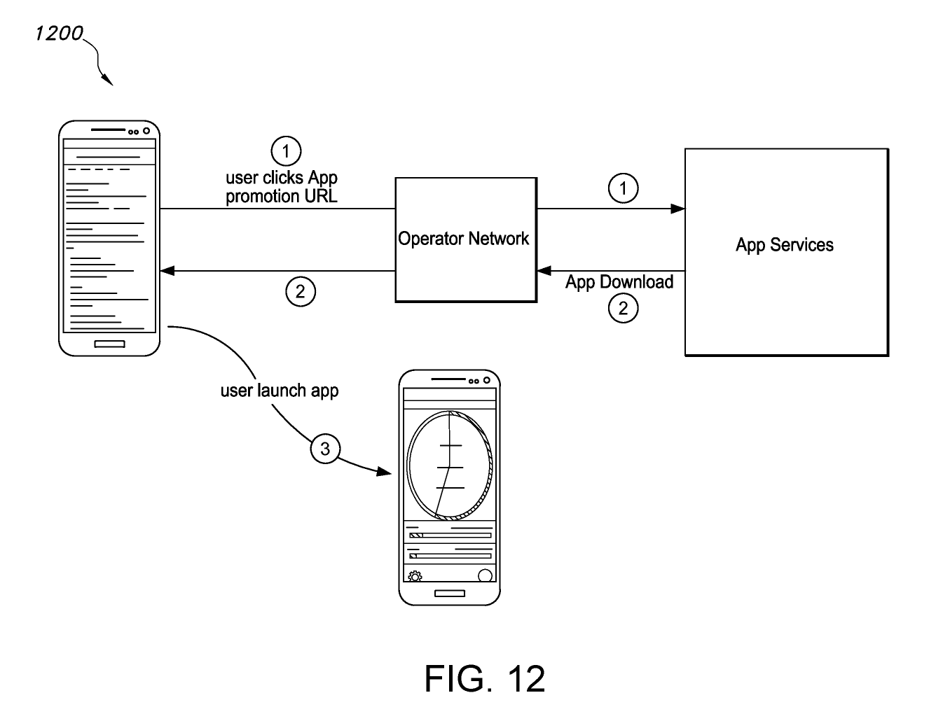

FIG. 12 shows a flow 1200 wherein the mobile user installs the mobile app, such as upon encountering a promotion of the app.

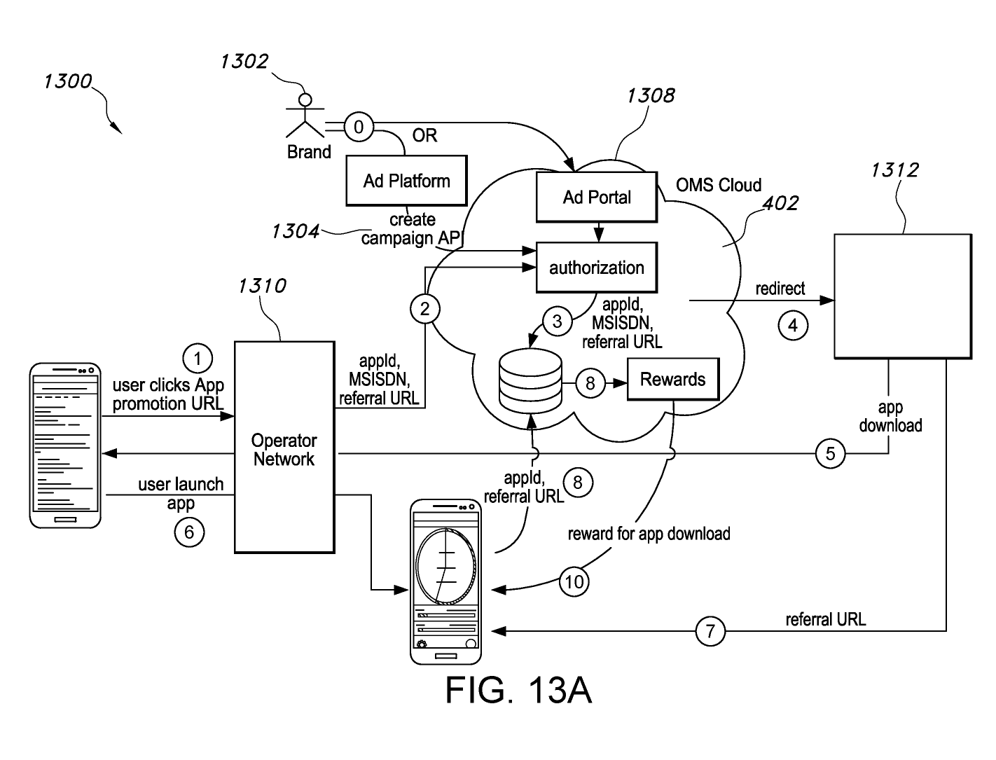

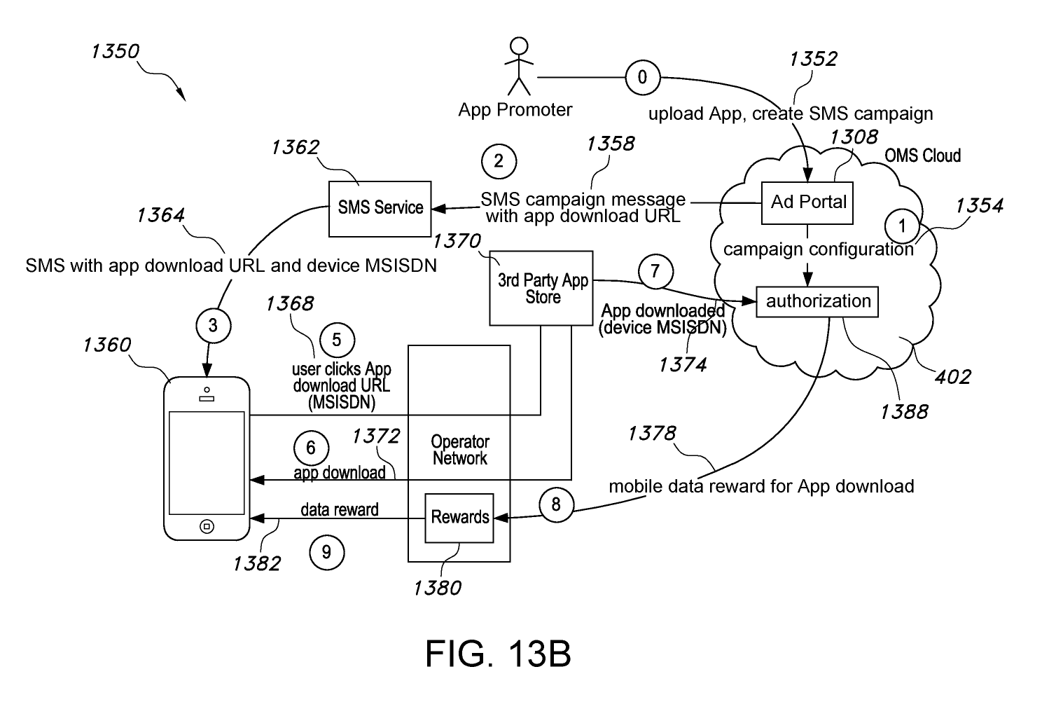

FIG. 13 shows a workflow 1300 of the toll-free app download for an app that is integrated with a sponsored data platform that has a tracking function for activities relating to use of sponsored data.

In embodiments, a brand (or an app owner) 1302 may create an app download campaign 1304 on the ad server or on an ad portal 1308. For former case, the ad server may need to integrate a campaign creation API of the OMS cloud 402 to facilitate installation of the app. An operator network 1310 may insert a number uniquely identifying a subscriber's mobile device in a mobile network (e.g., using the telephone number to the SIM card in the mobile phone or using the mobile station international subscriber directory number (MSISDN) for the device) as a header enrichment to an app download request destined to the OMS cloud 402, such as via an API to the OMS cloud 402. The MSISDN may be present only when the mobile user is on the cellular network.

The methods and systems disclosed herein may provide several advantages and benefits including removed or reduced user hesitation to download the app and associated advertising content when relying on a cellular connection and in turn increase the number of app downloads and sufficiently successful viewing of advertising content. The methods and systems disclosed herein may enable the user to download the user's favorite app toll free and without network charges by viewing content also delivered toll free. The methods and systems disclosed herein may allow easy campaign management for app developers by providing a software developer kit and dashboard to manage the sponsored content.

The methods and systems disclosed herein may involve several steps to provide the user with the toll free app downloads. For example, the methods and systems disclosed herein may allow using a permissive tracking capability so as to relay locations and history of user to the sponsored data platform, such as using a tracking SDK. The tracking SDK can also track success of the campaign or many campaigns including the individual activity of the users or group of users. App developers may come onboard an app promotion portal and configure TMAD, the budget, and start/end date of the campaign and the like. The onboarding of the app developer may generate a click through URL for app promotion. App developers may now be invited to create an ad campaign and publish on the ad network. App developers may give a click through URL as the one generated by the disclosure when they onboard. When the user clicks on an ad impression, a click through URL may be shown. A web server may be able to detect user information using its integration with an operator. For example, the server may redirect the call to a Google play store 1312 with the correct Google play attribution URL. The user may download the app from the Google play store 1312 or any ad server. The tracking solution may know when the app is downloaded and inform the web server about size of the app and the user information. The server may recharge the user with correct amount of data (MB) or zero out the charge. As such, the user may get a toll free app download. The workflow 1300 may remain the same if the tracking solution is integrated with a partner tracking SDK and an attribution framework.

FIG. 13B shows a workflow 1350 for enabling toll-free app downloads for an app that is promoted by an SMS campaign 1352. In this embodiment, the app developed for the SMS campaign is not required to integrate with an SDK or other similar facility of sponsored data platform described herein. This embodiment enables the downloading by users of toll-free apps from third party application store(s) 1370, such as the Amazon™ app store, or an enterprise app store.

In the workflow 1350, at a campaign configuration step 1354, the app promoter creates the SMS campaign 1352, such as working on the ad portal 1308 of the host of the sponsored data solution, which may be hosted in the OMS cloud 402 as described herein, where the campaign is directed at least in part to promoting toll-free downloading of the app. Using an interface of the portal 1308, the promoter may specify the app to which the campaign applies (including indicating the URL from which the app can be downloaded), the campaign duration, the budget (i.e., the aggregate amount of sponsored data charges that the sponsor will pay for users to download the app), the size of the app, a reward (such as offering the user free data usage as a reward for downloading the app), and a reward policy, such as allowing one toll-free download of the app per unique mobile device, until the budget for the app is exhausted.

Next, at a step 1358, the ad portal 1308 may send an SMS campaign message, including the URL for downloading the app, addressed to a target mobile user device 1360, such as by using an SMS server 1362. At a step 1364, the SMS server 1362 sends the SMS message to a mobile user device 1360. The SMS message contains the app download URL and a device identifier, such as the MSISDN of the mobile device 1360. When the user of the mobile device 1360 clicks the App download URL within the SMS message, the app download request is sent at a step 1368 to the third party application store 1370 along with the MSISDN of the mobile device. At a step 1374 the third party application store 1370 notifies the authentication and authorization services 1388 (such as authentication and authorization services of the OMS cloud 402 as described in connection with certain embodiments throughout this disclosure) of the initiation of the app download, as well as the MSISDN associated with the device 1360 that initiated the download. The authentication and authorization services 1388 of the OMS cloud 402 may authenticate and authorize the mobile user based on the stored campaign configuration from the step 1352. The third party app store 1370 may download the app to the device 1360 at a step 1372, through the operator network to which the device is connected. Upon being notified of the download and confirming authorization and authentication, the OMS cloud 402 may send a request at a step 1378 for the operator network to which the mobile device 1360 is connected to provide the user of the device with the reward 1380 that is associated with the downloading of the app, as was specified in the configuration of the campaign at the step 1352. At a step 1382, the operator network may reward the user in the appropriate amount of free (or reduced charge) mobile data, such as by deducting charges from the subscriber's bill or by not fully charging the subscriber for mobile data usage that would otherwise require payment.

In embodiments, the methods and systems disclosed herein can enhance advertisement targeting and conversions in real-time. In certain embodiments, this can be accomplished with user segment information derived from the mobile network operator. Such user segment information is protected within the mobile network operator using an anonymous mapping between the user identity and publicly available advertising identifiers. In doing so, the methods and system disclosed herein can include the building of a dynamically refreshed database of user segment information received from the mobile network operator and information gleaned from the advertising infrastructure. The user segment information can be keyed with typically used identifiers such as ANDROID® ID/IFA and the like. In certain embodiments, the user identifiable information is not shared with any third parties. In further embodiments, users can be allowed to opt-in if the process through which the campaign is delivered requires it, or can also allow users to opt-out if needed. The various embodiments can be integrated with an advertisement ecosystem for scale of intelligent advertisement offerings. By way of this example, the methods and systems can include click through and install tracking systems to track these usage and activity in the campaigns.

In embodiments, the database of user segment information can be built through online learning by extracting and ingesting information from the devices and mobile network infrastructure in the campaign. In certain embodiments, data can be obtained from the advertising call, the mobile network operator header information, and the attribution data. The advertising call can include an advertisement identification, publisher/SSP/DSP cookies, mobile device finger print, and inventory information. The mobile network header data can include an MSISDN, segment information, location, network balance information, device IP address, and generation of temporary UID. Attribution data include a third party attribution ID, a campaign ID, and third party tracking data.

In further embodiments, indexing to the database of user segment information can be accomplished with advertisement identification (i.e., 1:1 matching), third party cookie detection (i.e., 1:1 matching), or obtaining a fingerprint of the mobile device (i.e., an incomplete match). Moreover, user segment information can be retrieved in real time to enhance bid request and a successful bid (i.e., a winning bid) can enhance the learning associated with the database. In one example, the campaign can run an un-enriched campaigns on the demand side platform for learning. To that end, the advertising call information can be received through the campaign, the ID call can be included in the winning URL, and the database can learn the association between the advertising call information and header information. This in turn can require that specific learning campaigns be run on the demand side platform. In another example, there can be enriched campaigns and there can be learning on the job. In this example, there can a SSP/Publisher that can integrate the ID Call prior to sending the bid-request. The ID call can include device ID parameters (e.g., ANDROID® ID). The SSP request can include the temporary UID that can be generated and can be interpreted by demand side platform. The demand side platform can be allowed to bid based on enriched header information and every campaign (not limited to local demand side platforms) can be a learning campaign with SSP/Publisher integration. The methods and systems disclosed herein may also include methods and systems for ad blocking. Embodiments disclosed herein describe how the toll-free ads solution can be integrated with an ad blocker to provide high quality, toll-free ads to the mobile users to benefit both the advertisers and the mobile users.

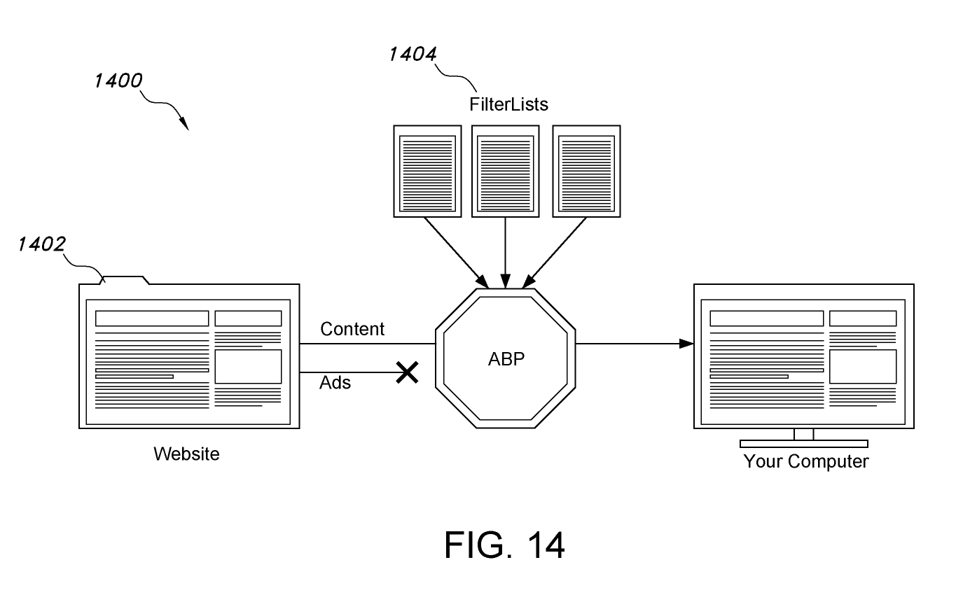

FIG. 14 demonstrates functionality of ad blocking 1400.

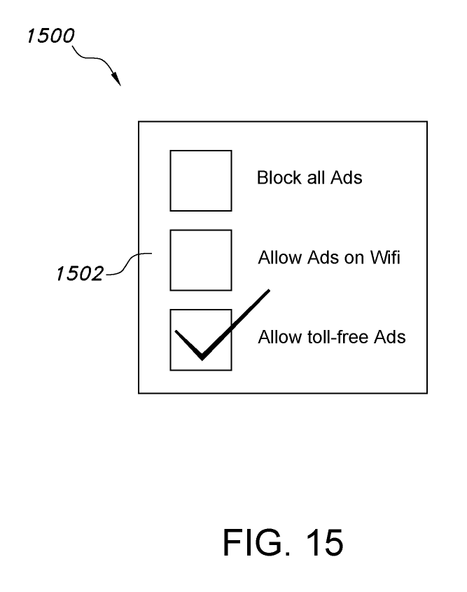

The ad blocker 1402 may add a toll-free option in an ad block configuration page via partnerships with various ad blockers on pre-decided terms 1404. As shown in FIG. 15, a menu 1500 may be provided for the user to allow toll-free advertisements 1502.

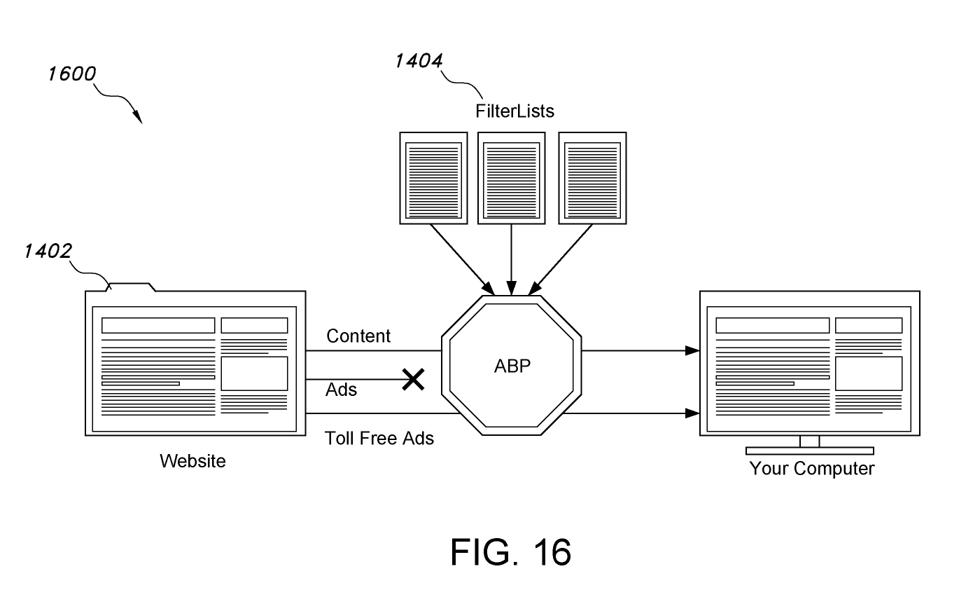

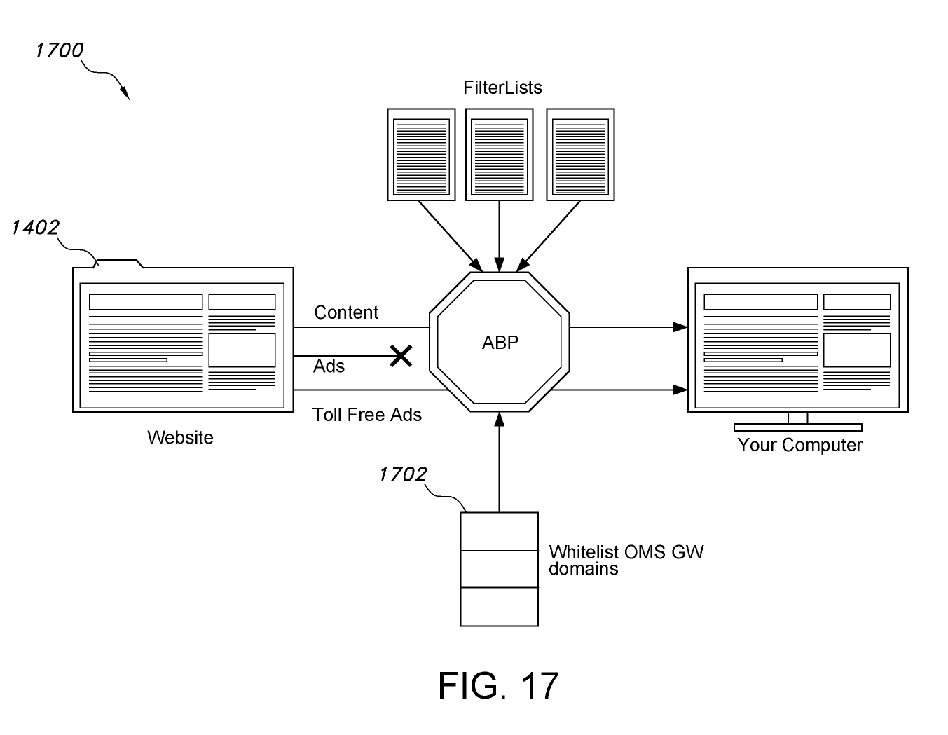

When the user allows the ad blocker 1402 to deliver toll free ads, the ad blocker 1402 may allow the ad content from a gateway domain. Exemplary embodiments of a flow may be seen in FIG. 16.

The methods and systems disclosed herein provide several advantages. The methods and systems disclosed herein may allow toll free ad delivery that may help the advertiser in reaching customers even when ad blocking is active. The methods and systems disclosed herein may improve ad clicking through-rate and makes it easy to integrate with the platform.

The steps involved in an end-to-end flow for the methods and systems disclosed herein may include creating a toll-free mobile ad campaign on existing ad platforms by the advertiser 208. The flow may include integration with a sponsored advertising solution described throughout this disclosure to enable a toll free option by the ad blocker 1402. The user may select the toll free option 1502. The ad blocker 1402, before blocking the ad, may call a sponsored advertising platform to check if the ad is toll free, and allow the ad to pass if it is loaded from a sponsored advertising solution provider's server.

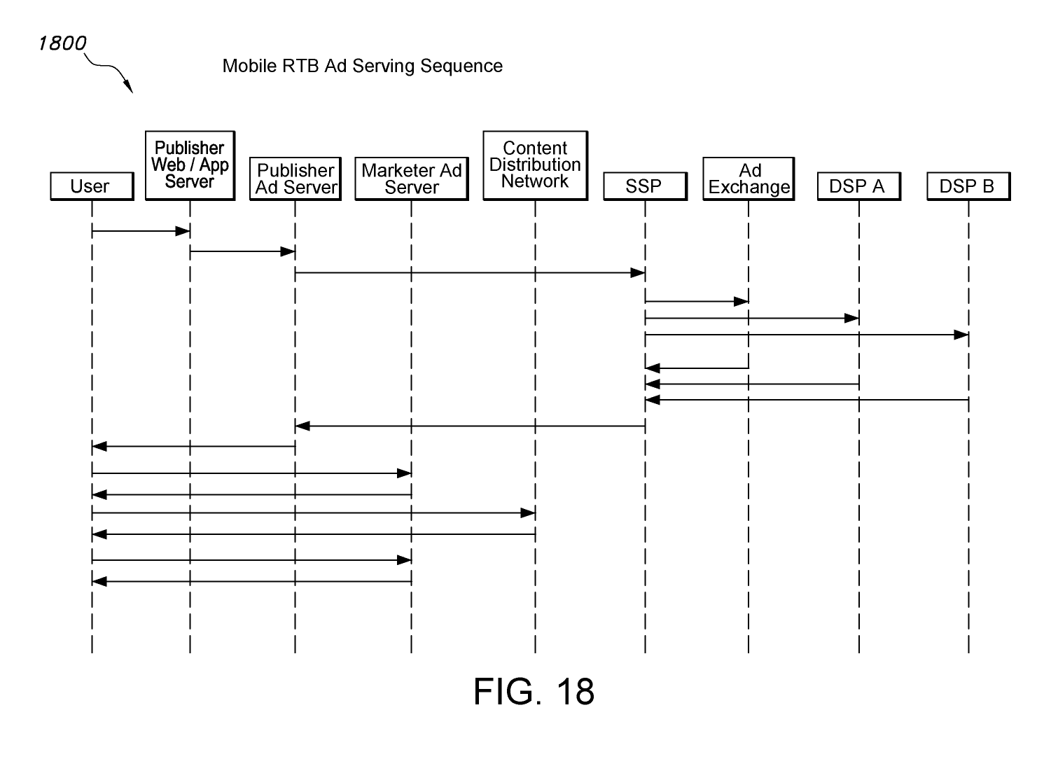

With the integration of the sponsored advertising solution with the ad blocker 1402, the ad blocker 1402 may add a whitelisted OMS gateway domain 1702 into its configuration, which may get allowed to the user. In an example, current ad serving without the ad blocker may work as shown in FIG. 18.

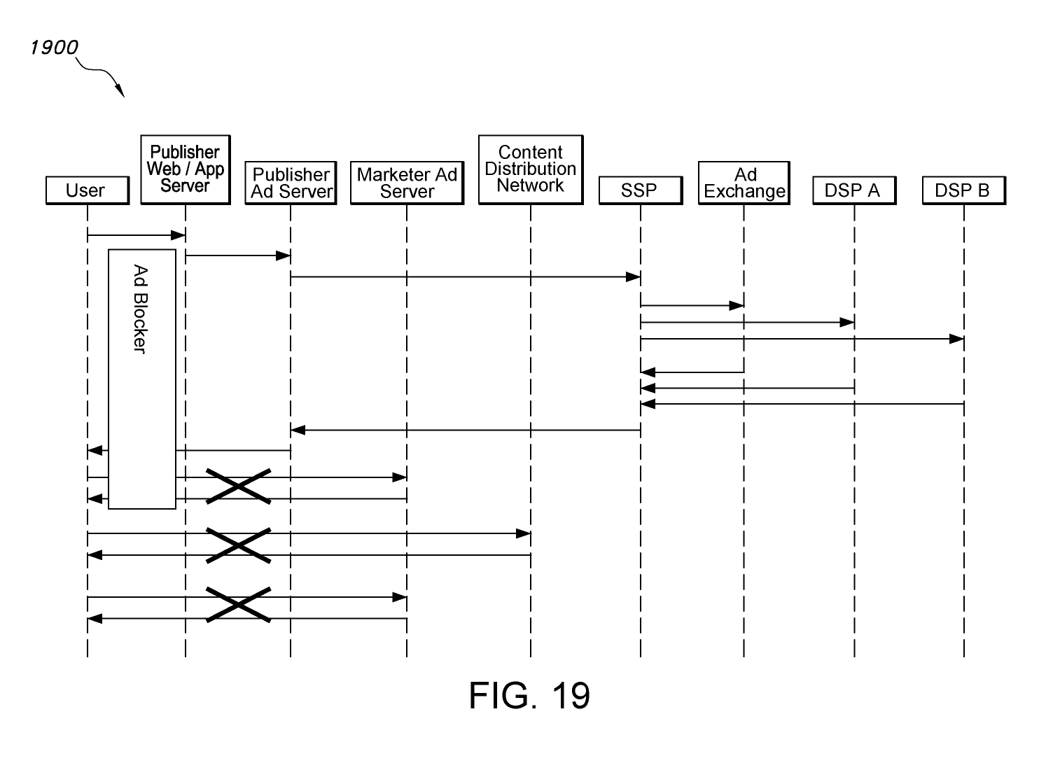

In an embodiment, a sequence is shown in FIG. 19 when the ad blocking is active.

In various embodiments, when the ad blocking integrates with the sponsored advertising solution to serve the toll free ads to the consumer, the sponsored advertising solution may check if the ad can be served toll free. The ad blocker 1402 may be able to allow the toll free ad to reach the user with white listing or other user pre-approvals of the domain of a sponsored advertising solution provider.

The methods and systems disclosed herein may facilitate aggregating differently rated mobile data. These methods and systems may relate generally to providing varying types of providing various sponsored data services to mobile data subscribers at varying rates (e.g., free, or at varying discount rates relative to regular pricing), while aggregating total consumption of different types of sponsored traffic, such as on a per subscriber basis. The methods and systems disclosed herein may consider access to sponsored data provided by content providers through sponsorship mechanisms known as campaigns. This may be considered as a type of protocol, accounting and data-driven method in communication systems and networks.

Systems and methods for differently rating various content types to a mobile device are disclosed herein. The system components may include an IP system aggregator to aggregate whitelisted IP addresses that may be eligible for multi-rated content reception. The aggregator may be configured with a defined set of rules to allow multi-rated content to a set of IP addresses of selected content providers and mobile users in the cellular network based on operator decisions. The system components may further include application level servers for allowing pass through of traffic from remote servers. These servers may be termed as “gateways” in the present embodiment, which may be deployed inside or outside of the operator network capable of delivering diverse traffic patterns from the content provider to the users. The system components may include an authenticating agent in the embodiment to authorize clients eligible for the multi-rated content during sponsorship events termed as “campaigns.” The system components may include an analytic and accounting agent to account for bytes transmitted to authentic users to charge the content providers based on a charging policy of content type as set by the operator.

In embodiments, methods and systems are provided that may aggregate varying, multi-rated application-level network traffic from different client applications from filtered IP addresses, in order to bill different content providers based on type and category of content in sponsored campaigns.

In a system, content that is meant to be multi-rated may be served by server gateways situated in between a client and a content provider deployed per region having region specific operator defined IP and charging rules. Each charging rule imposed by an operator may be a combination of rate towards subscriber and content partner as well as operator subsidy. Multi-rated diverse application protocol traffic as aggregated by individual gateways may be used by a billing agent to bill the individual content providers.

A protocol-specific type of traffic originating from a client may be redirected to an application specific gateway. A client redirect is successful to an application gateway if a requesting client's session traffic is authenticated by an authenticator.

In a system, all the traffic flowing through the gateway may not be charged to a subscriber's data plan and all the packets that are marked may be charged to the content provider or zero rated as applicable. Such packets can be differentiated and charged differently by embedding definitive markers in a protocol header (HTTP/SIP/RTSP/SMTP). For example, a single header byte that has been authenticated with both the content provider (sponsor of the data) and the operator can distinguish the charging class of the packet. The system may allow flexibility of selective-marking or non-marking content depending on type of sponsored or non-sponsored campaign.

In a system, the gateway service may be deployed in two-fold manner. It may be directly deployed inside an operator network where the operator needs to manage IP and charging rules or it may be deployed outside the operator network with administrative rights to the operator or gateway management team to manage rules. The following factors may be taken into account. One may separately account for the multi-rated data per subscriber and per device at application level. This preferably works for various subscriber identity modules (SIMs), such as single/dual/quadruple multi-operator SIMs, including for pre-paid and post-paid customers. Also, the system is preferably capable of allowing sponsored and non-sponsored multi-protocol traffic to any subscriber at any instant. Also, the system may scale with the number of sponsors, such as allowing multi-rated content under defined IP address ranges at different points in time. Also, the system may scale with new users joining from different regions.

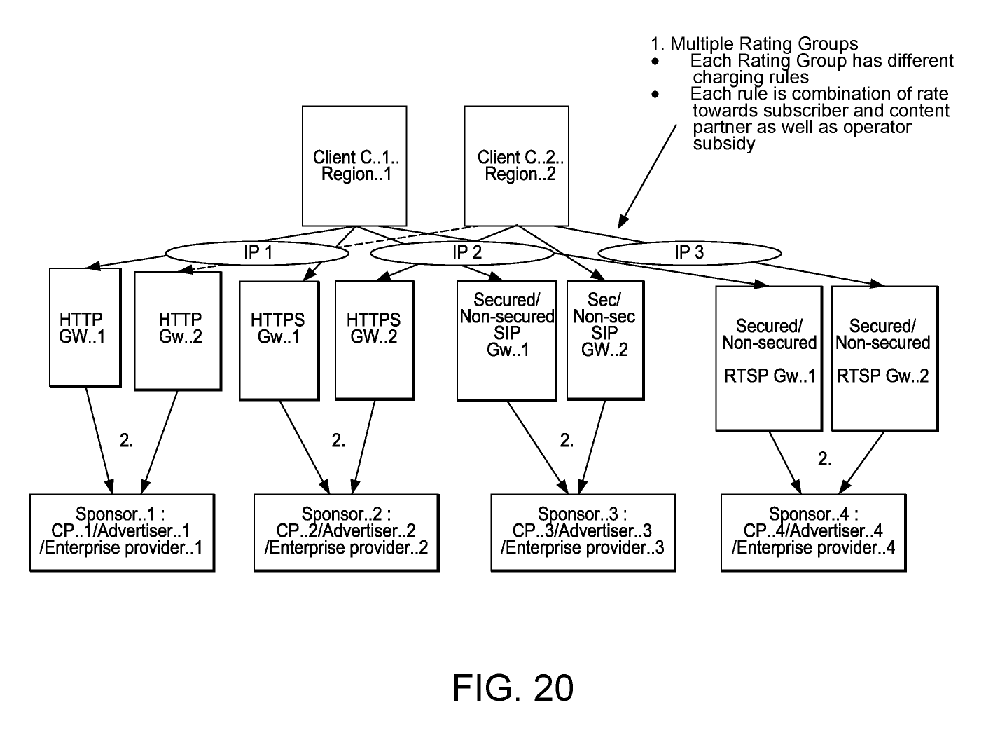

FIG. 20 shows different gateways deployed and clients redirected to these gateways to access sponsored content from sponsors. In FIG. 20, various system components may include an IP system aggregator where an operator may configure IP address ranges and subnets based on addition or removal of sponsors. The system subcomponents may include IP range filters settings based on destination servers of different sponsors, type of content being served from the destination servers, location of the destination servers, charging rules or sponsorship level of the content being served from the destination servers.

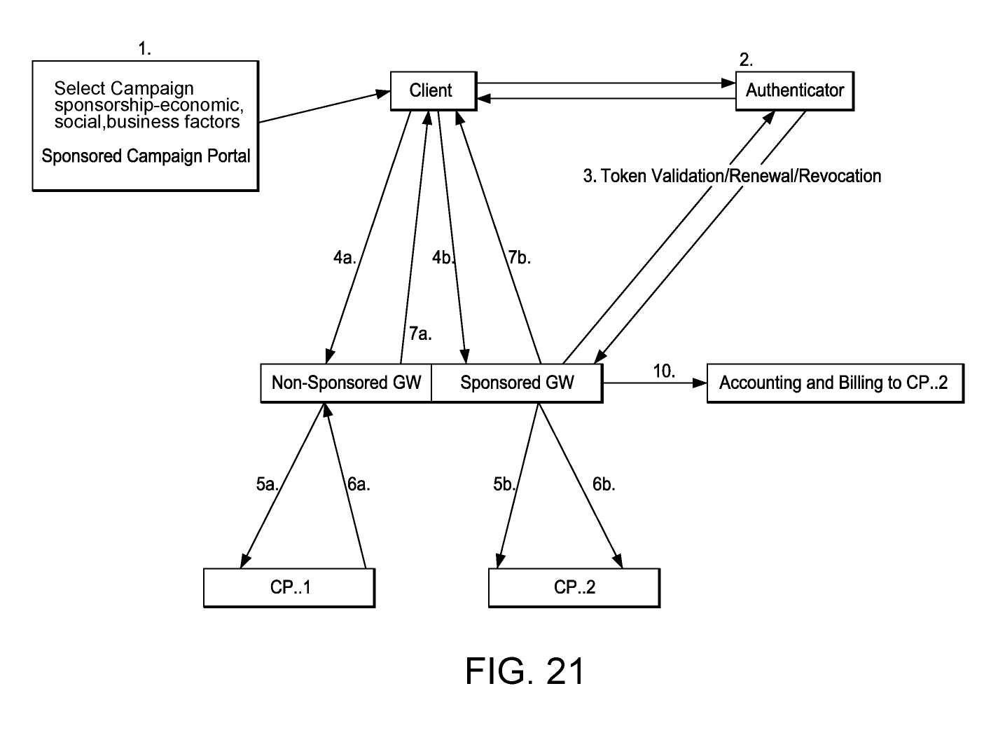

In FIG. 20, the system components may include a unified gateway service that may be capable of allowing dynamic deployment of protocol specific application level gateways (SIP/RTSP/HTTP/HTTPS/SMTP/IMAP/POP3) where each gateway is a server situated in between a mobile device of a user and the destination server, such as having content that will be served to the device, where the gateway server has the functionality of allowing traffic to pass through it. Each connection between the mobile device and the gateway may be over secured (using SSL/TLS) or non-secured (using sockets HTTP/HTTPS, RTP/SRTP, RTSP/Secure RTSP). The gateway may be responsible for accounting data transmitted from the destination server per application and per user-device based on generated authentication tokens. Individual gateways may be deployed on carrier-specific basis and may be responsible for separately accounting for bytes per operator for devices accessing sponsored data from multiple operator SIMs. The gateways may be configured to run on sponsored paths and non-sponsored paths, by white-listing the sponsored IPs. The rest of traffic passing through non-white-listed IPs of gateways may be classified as non-sponsored traffic (as shown in FIG. 21). This makes dynamic accounting of sponsored data, so that any change in sponsorship eligibility of an end-user, byte accounting may be accordingly updated, and no extra bytes are billed to the sponsor, which may include the content provider, advertiser or the enterprise provider as the case may be.

A single gateway for an application protocol may communicate with the authenticating agent at definite intervals to check validation of tokens issued by the agent so that in midst of long sponsored sessions, it can terminate sponsored sessions instantaneously when tokens expire. The rest of the session data may pass through the same gateway through non-sponsored path. In FIG. 21, the system components include the authenticating agent endowed with various functionalities. FIG. 21 shows a particular example of a sponsored and non-sponsored traffic after being authenticated from an authenticator. As per FIG. 21, the authenticating agent may allow authenticating users based on MSISDN, device-id, user-id, application-id and their presence in the cellular network where sponsorship is enabled, revalidating user's tokens in midst of sponsored sessions on a gateway server's request to allow pass-through of traffic through a sponsored/non-sponsored gateway, revoking user's authentication rights or tokens, based on sponsorship usage limit set by the sponsor (e.g. content provider) at any instant of an ongoing campaign, renewing sponsorship rights and re-granting tokens to old unauthenticated users on changing sponsorship criteria by the sponsor, and the like.

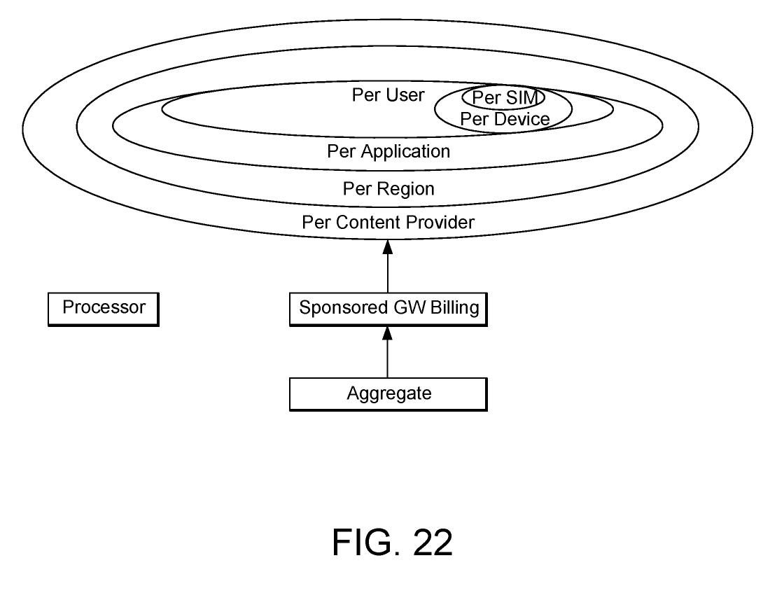

FIG. 22 shows how bytes accounted by individual gateways can be billed to a sponsor. Further bytes accounted to the sponsor per location, per application, per user, per device and per SIM can be used for statistical analysis to understand the growth and promotion of sponsored campaigns.

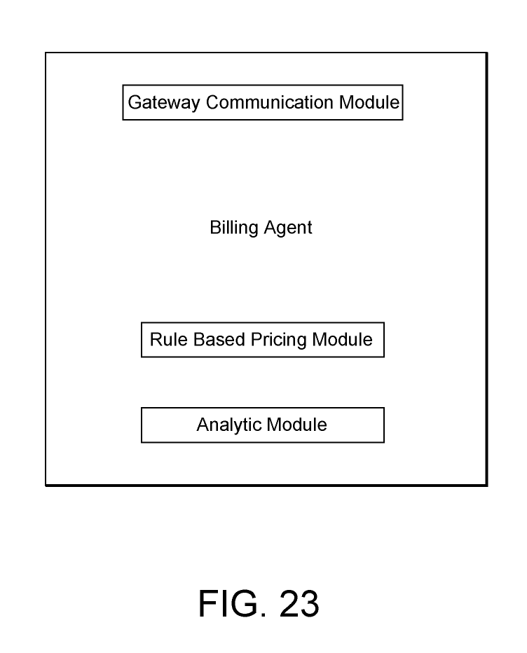

FIG. 23 shows different system components involved in billing the sponsor (e.g. content provider). As shown in FIG. 20, the system components may include a billing agent to bill the sponsor. The billing agent may include various components as shown in FIG. 23. The billing agent may include a communicator module with a gateway agent to receive total number of bytes accounted per token for any user from a gateway service. The billing agent may include a pricing module that may incorporate different charging rules for different types of content set by the operator to aggregate and generate a summarized billing report to the sponsor. The billing agent may include an analytic module to perform statistical analysis of different types of sponsored data usage by different users in different locations.

In embodiments, a selective set of URLs of a mobile application for a given sponsor (e.g. content provider) may be made available for categorical sponsorship (varying from 100% to 10%) by the operator based on a utility function in that location which may depend on factors such as similar application usage demand in a given location, social, economic, cultural background of people, social and economic feasibility, government rules or other influencing factors such as business impacts and marketing pros and cons.

When a client request for sponsored data is initiated, the sponsored data authenticator may authorize the client against its current IP address, device ID, current location, application ID, period of validity of campaign and remaining amount of sponsored data quota as set by the content and may grant a sponsorship token for limited duration for accessing sponsored traffic. A selective optimization may be carried out by the authenticator in issuing sponsored tokens based on user's usage pattern, type of content being accessed, whether the multi-rated sponsored campaign possesses restrictions on number of users in a given region, amount of content-type allowed for sponsorship, and the like. Authorized clients based on type of protocol traffic may be directed to an appropriate gateway by a client's device/application proxy. The gateway may pull multi-rated traffic from a back-end content provider. The number of objects, (N_k), or total number of bytes (S_k), transmitted to any client in a single session from the back-end may be accounted by the gateway against the sponsorship token issued by the authenticator. Unauthorized clients may retrieve traffic through the gateway as non-sponsored data where the gateway does not track bytes transferred to the client. Each client may establish a secured/non-secured protocol specific connection with the gateway as the case may be depending on a requesting destination host URL and the application protocol. The gateway may be equipped to terminate sponsored sessions and switch back to non-sponsored client sessions depending on several factors such as operator rule change (IP range inclusion/deletion), token expiry, client movement to non-cellular network or regions where sponsorship is disallowed, allowable data limit is used up or not, or whether sponsored campaign has expired. The gateway may be modeled to resume aggregating bytes if expired campaigns become active or non-eligible users become eligible due to changes in sponsored campaign as set by the content provider. The above procedure may be repeated by the concerned gateway for accounting bytes for all sponsored active campaigns set by the content providers by revalidating the sponsorship token for all requesting clients. Bytes accounted by the individual gateways may be transferred to the gateway billing aggregator to charge the content providers as per charging rules set by the operator.

In embodiments of the present disclosure, a system authorizes whitelisted BYOD devices using company-sponsored enterprise email clients using over the top HTTPS requests to account email exchanges in the core of the cellular network and bills enterprise providers for the company-sponsored email usage.

In embodiments of the system, there are three principal entities for allowing passage of sponsored/non-sponsored traffic for a given cellular network operator: a) email servers (e.g., HTTP, HTTPS, POP3, IMAP, SMTP, MAPI, Microsoft Exchange, and Microsoft ActiveSync), which are based on the protocol used by email client to send and receive mails from back-end email servers; b) one or more landing domain servers to serve different client requests for varying email servers for different enterprises; and c) sponsored/non-sponsored gateway servers residing in between the client and email server to account for only sponsored emails exchanged.

An email client is configured to issue HTTPS requests to an enterprise webserver residing between the client and the email server at the back-end. The intermediate webserver may perform the following functions. The intermediate webserver extracts the user id and device ID from an HTTPS request and forwards an authentication request to an authenticating agent. The authentication agent authorizes the request based on campaign rules and either generates a valid token to signify authentication success or responds with authentication failure, such as in case of a usage limit being exceeded or in a case where sponsored email usage is not granted for some region or part of a network. The intermediate webserver also issues “HTTP REDIRECT” messages to email clients based on success or failure of the authentication, routing clients to either a sponsored gateway (if authenticated) or a non-sponsored gateway (if not authenticated). The intermediate webserver also sets up a connection with the email server at the back-end.

In a system, enterprise traffic may be routed to the appropriate gateway depending on the location (e.g., country) and the network operator for the BYOD device. This can be achieved by a number of steps, as follows. A webserver is enabled to handle customized enterprise app requests on a specific “landing domain,” where the “landing domain” configuration is based on the country, operator, MDM solution partner name (if one is present) and the type of enterprise app being used. Customized traffic is routed via the applicable sponsored or non-sponsored gateway to the email server from the landing web server through a “REDIRECT” message. In the case of enterprises with EMM VPN server, a matching certificate, the same as the sponsored/non-sponsored gateway domain name, is served by it, to allow passage of sponsored and non-sponsored traffic. In the absence of an EMM VPN server, the matching certificate is offered by the back-end email server.

In embodiments, the system is equipped to allow passage of sponsored/non-sponsored traffic based on a mobile subscriber's presence in a cellular/Wi-Fi network with the help of a resolution server termed as domain name system (DNS). The gateway and landing domain translates any client's IP to the operator-run cellular network or non-cellular network and sends notification to the DNS at a specified interval (e.g., 30 seconds in one embodiment) when the client is in cellular network. The DNS is responsible for resolving requests to a non-sponsored gateway, for example, five seconds after the previous cellular notification has expired, to allow the client to fully switch to non-cellular network.

The following factors may be taken into account in the methods and systems disclosed herein. One may provide enterprise providers with the flexibility to support various types of email traffic to an organization's white-listed BYOD devices, including to various user groups and roles where different groups and roles can be accounted for using different charging rules. This allows the enterprise provider to decide the amount of data the enterprise will pay for respective roles and types of user groups. The system may separately account for the multi-rated data and the subscriber-paid data for different enterprise email apps in different operator networks. The system may allow authorized passage of sponsored/non-sponsored traffic to required gateways based on campaign configuration and the subscriber's presence in the cellular network. The system may extend easy portability of the solution and allow extensions to any kind of email-servers over secured and non-secured channels (HTTP/HTTPS). The system may also offer easy deployment of services for various cloud components (authentication systems, sponsored/non-sponsored gateways, and billing services) across various carrier networks, along with operator-provided subsidy plans and billing infrastructures. Moreover, automatic adjustments can be made due to network changes, such as changes in the reference signal received, power adjustments in a cell of a cellular network, carrier aggregation, or multi-layer configurations.

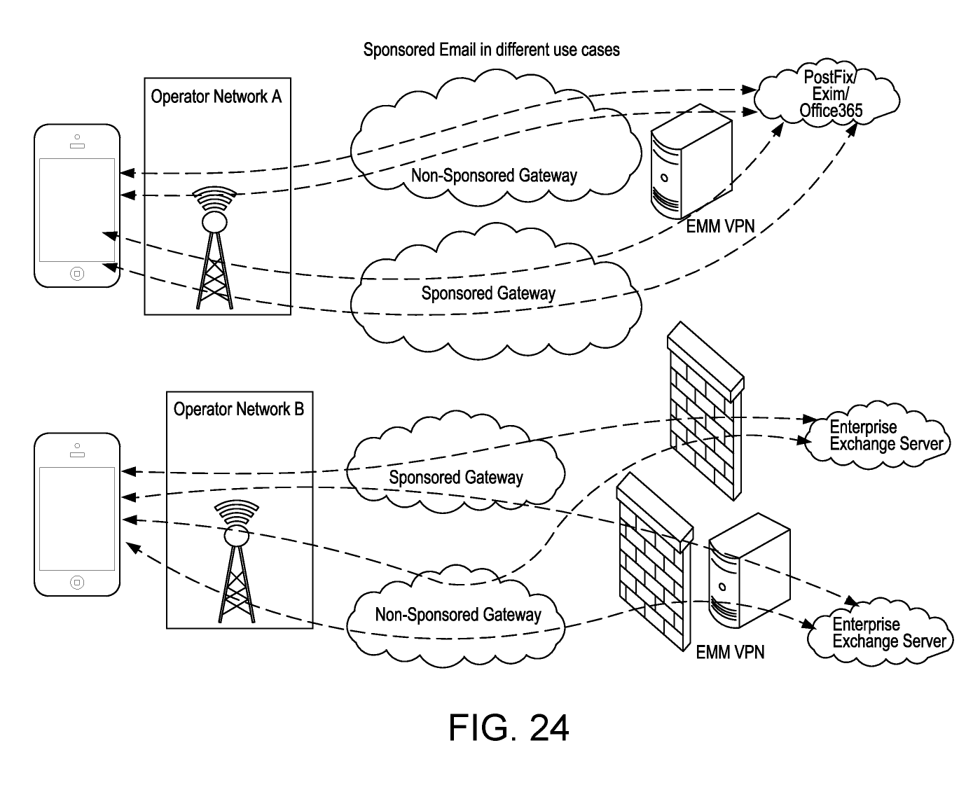

Referring to FIG. 24, the system components may include different email clients (e.g., IMAP/POP3/MAPI/SMTP/Microsoft Exchange/Exchange ActiveSync), which may be configured on diverse mobile platforms (e.g., ANDROID®/iPhone®), by which mobile subscribers access sponsored email service. Components may also include different back-end email servers configured either without an MDM partner's presence or supported by multiple MDM partners. Where present, an MDM partner's email configuration settings may be pushed into devices, where respective email clients update the received configuration. This may be achieved by a device provisioning system, which may push the provisioning profile to a device with a landing domain, via a URL path containing the unique device ID and email ID. The system components may also include back end email servers, which can reside, directly facing the Internet, facing the Internet behind a firewall, behind an EMM VPN server of an MDM partner, or behind a firewall and EMM VPN server of an MDM partner.

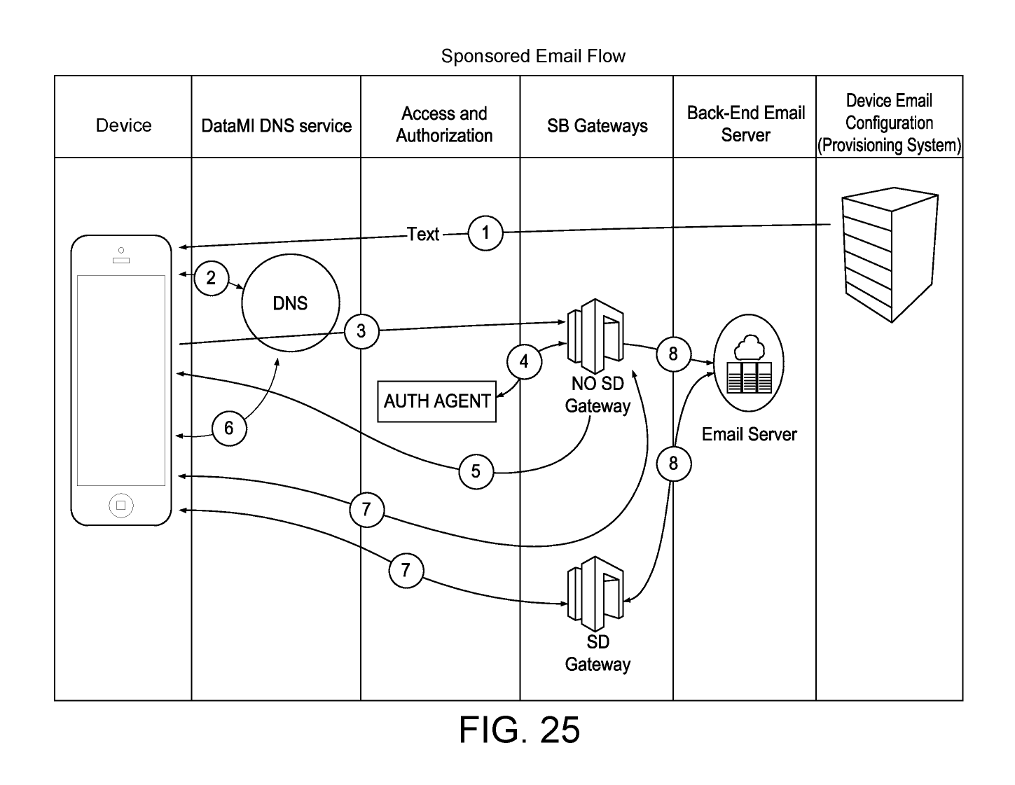

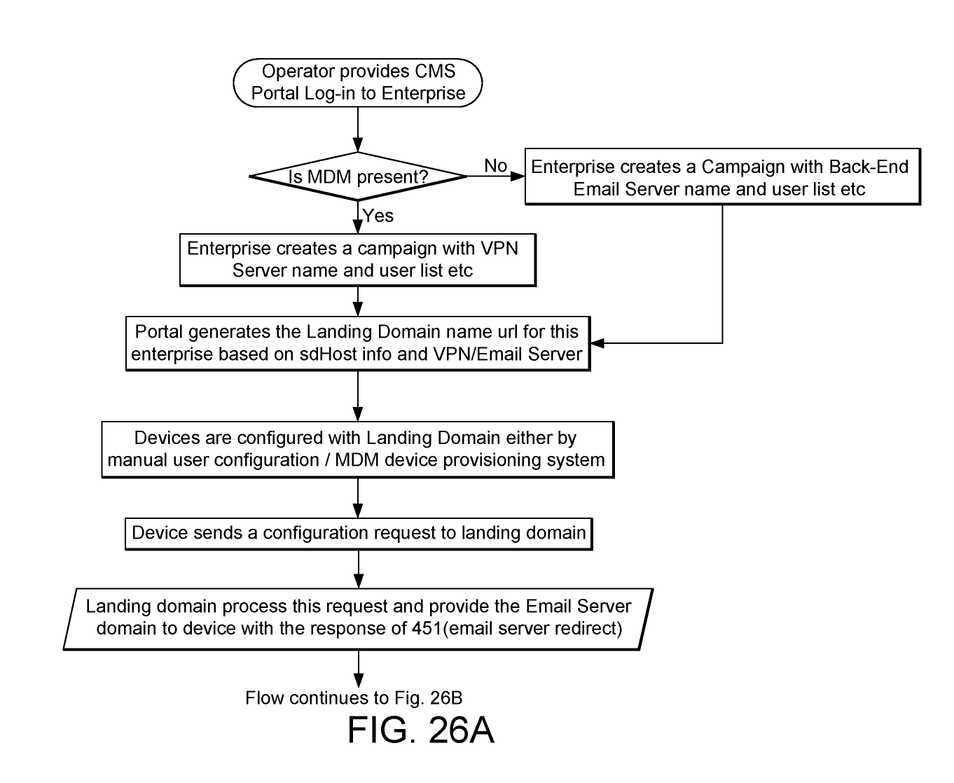

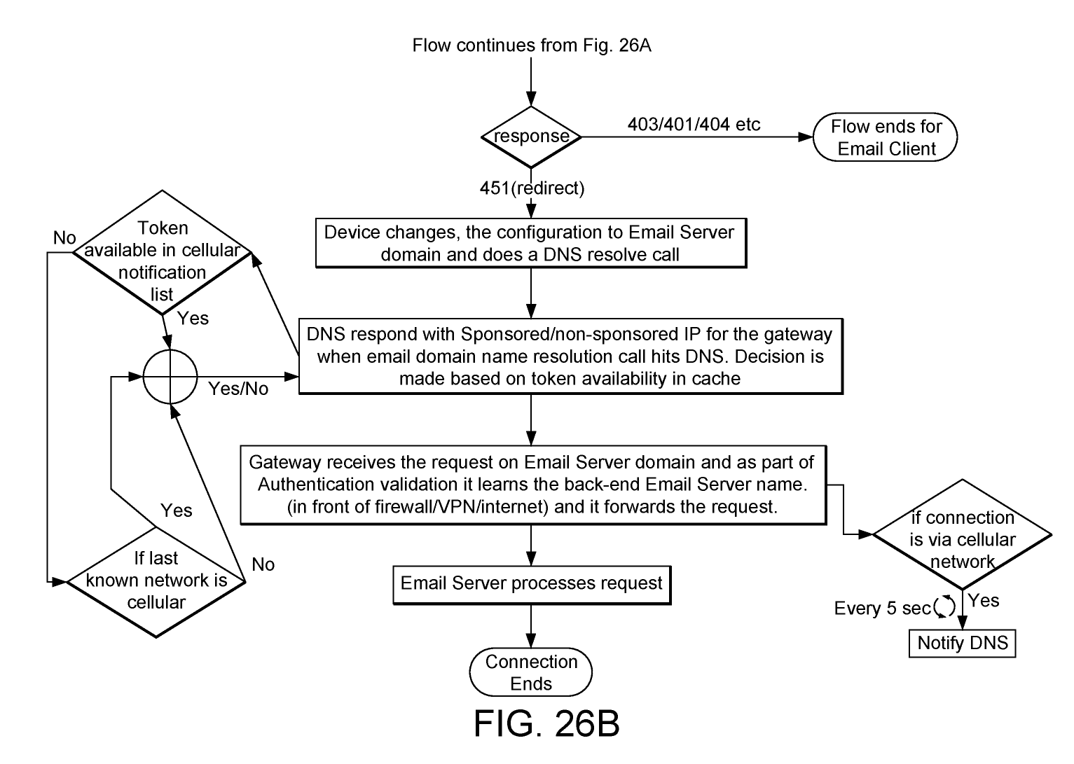

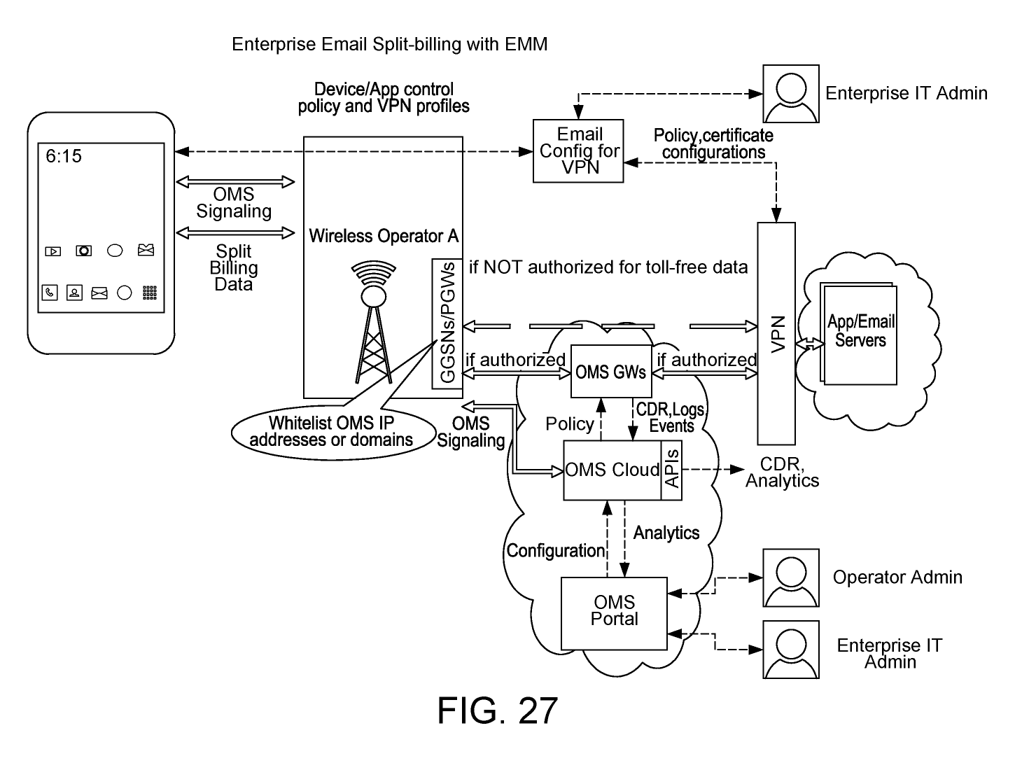

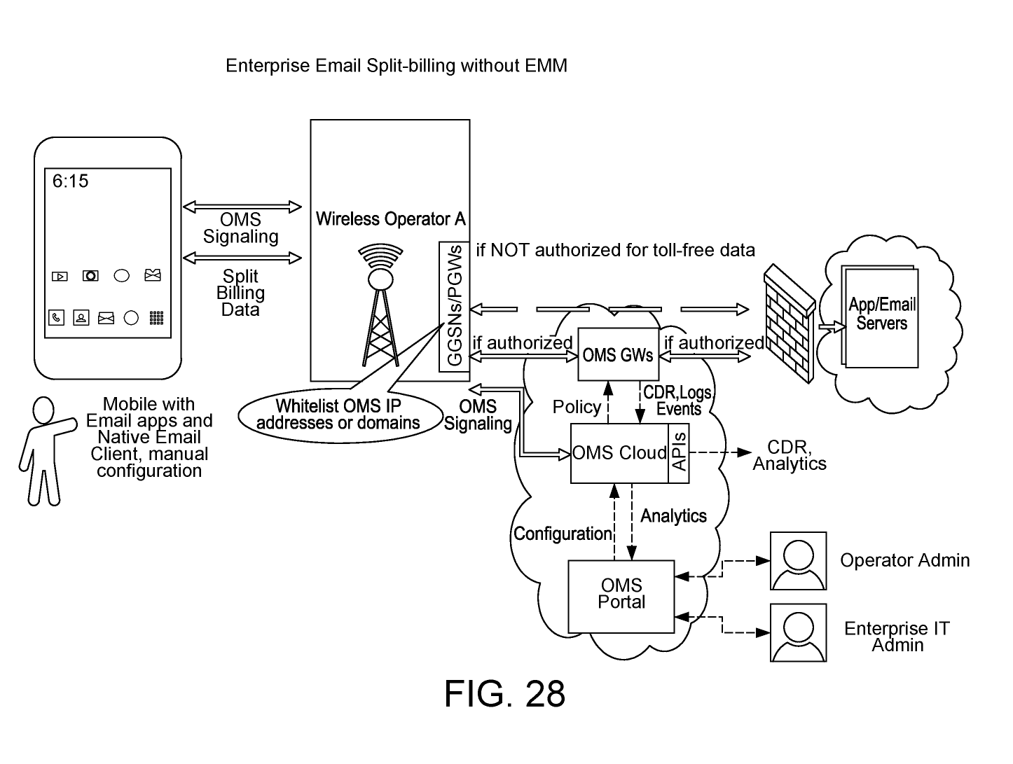

Referring to FIG. 25, the system components may include a landing non-sponsored web-server listening on a specified landing domain agreed between the enterprise provider and MDM partner (in cases where an MDM partner is present). Otherwise, the landing web-server may listen to client requests that have been setup manually with a configuration file. The system may also include a non-sponsored gateway responsible for providing email service to mobile subscribers without accounting bytes being exchanged. The non-sponsored gateway may be responsible for validating the client's presence in the cellular network by validating IP addresses and issuing notifications to DNS (see the control flow set forth in FIGS. 26A and 26B). The non-sponsored gateway may also be responsible for forwarding each user's request (with user-id and app-id) to an authenticating server. The non-sponsored gateway, on receiving authentication tokens, may be responsible for forming a tokenized email server name and sending this information to the device.

In FIG. 25, the system components also include the DNS resolving landing domain to non-sponsored gateways. Devices may send requests to this landing domain with email and device IDs to retrieve email server names. The DNS may store each token with flags (e.g., two flags), which help it to resolve to sponsored and non-sponsored domains. A last known state flag may be used, which may be a permanent flag that stores a value of ‘cellular’ or ‘non-cellular’, depending upon what conditions were present when the last resolve call was received. A sponsored data flag may be used, which may be updated on receiving notifications, such as having a default lifetime, such as thirty seconds. The DNS may be responsible for receiving notifications from sponsored gateways about each client's presence in cellular network and updating the last known connection for each token in its cache. The DNS may also be responsible for resolving to sponsored or non-sponsored gateways depending on client's presence in cellular network, such as with a time to live (TTL) of, for example, ten seconds. In a case where a sponsored flag is present, the DNS resolves to sponsored gateways, followed by updating the last known state flag to “cellular.” The DNS may also be responsible for resolving to non-sponsored domains upon not receiving notifications, such as after a grace time period (e.g., five seconds) when the sponsored flag has expired and the last known flag points to “cellular.” Here the DNS resolves with a TTL of, for example, one second, followed by changing last known state to “non-cellular.” A grace period (e.g., five seconds) may be allowed to allow the client to switch to a non-cellular network from a cellular network.

In FIG. 24, the system components may also include a sponsored gateway that is responsible for providing sponsored email service to mobile subscribers. Sponsored email traffic over HTTPS between the email client and the email server at the back-end may pass through this gateway. The sponsored gateway may be responsible for accounting bytes for emails exchanged through it. As noted in FIGS. 26A and 26B, the sponsored gateway is responsible for validating the email client device's presence in the cellular network by validating IP addresses and issuing notifications to the DNS. Returning to FIG. 25, the sponsored gateway is responsible for maintaining connections to back-end VPN servers in cases where an MDM partner solution is present, in such cases, VPN servers manage connections with different email servers. Otherwise, in the absence of a VPN server, the sponsored/non-sponsored gateway may directly maintain connections with back-end email servers.

In FIG. 25, the system components also include the back-end server, which is responsible for connecting to different email servers for various MDM partners, where applicable. The back-end server may be responsible for issuing matching certificates for sponsored/non-sponsored gateways to allow passage of sponsored/non-sponsored traffic at any time.

In FIG. 25, the system components also include the authenticating agent, which issues a sponsored token on receiving a new user ID and email ID from the webserver. The authenticating agent may ensure validity of all issued tokens on receiving any request from the DNS or the gateway by extending the lifetime of tokens to the campaign duration in case the token is close to expiration. The authenticating agent may be configured to respond successfully to expired tokens to allow mobile subscribers to use sponsored email services in cases where the subscriber has not accessed email for long durations and the token has expired.

In embodiments, single and/or multiple email clients for enterprise mobile subscribers are granted email sponsorship (such as varying from 100% to lower sponsorship levels, e.g., 10%) by the enterprise based on a utility function in that location, such as based on a) a type of user profile (e.g., involving user rights and privileges), b) the type of email servers available by the enterprise or the cloud, and/or c) the presence or absence of an MDM partner.

Each email originating from a mobile email client may land in a webserver situated in between the client device and email back end server. The request could encompass transmission request of a given email of a given number of bytes from the client or a reception request for email from email server to the client.

The configuration of the webserver may be dependent on the country, the operator name, the name of an MDM partner (if present), and the name of an enterprise service provider.

The number of objects (N) or the total number of bytes (S) exchanged between the client and email server may be tracked and updated by the sponsored gateway.

The intermediate non-sponsored webserver, upon receiving the token and authentication details from the authentication agent, may prepare the email server redirect name, which resolves to either a sponsored gateway or a non-sponsored gateway, depending on the response received from the authentication agent.

The email server redirect name may be pushed to the client device as an email server name, and a corresponding notification is issued to the DNS if the client IP is translated to the cellular network for the configured operator. The email client may save this configuration and initiates communication with the gateway. The gateway may be equipped to terminate sponsored sessions and switch back to non-sponsored client sessions depending on several factors, including, without limitation, the following: a change in the email configuration, movement of the client device to a to non-cellular network or a cellular network region where sponsorship is not provided, usage of an allowable limit of data, and/or expiration of the sponsored enterprise campaign.

In embodiments, the gateway is modeled to resume aggregating bytes if expired campaigns become active or if non-eligible users become eligible, such as due to changes in a sponsored campaign as set by the content provider.

The above approach may be repeated by individual gateways for accounting bytes per operator (including by country), per MDM partner and per enterprise-provider. Counts of bytes accounted by the individual gateways may be transferred to a gateway billing aggregator to allow for charging content providers according to the charging rules set by the operator.

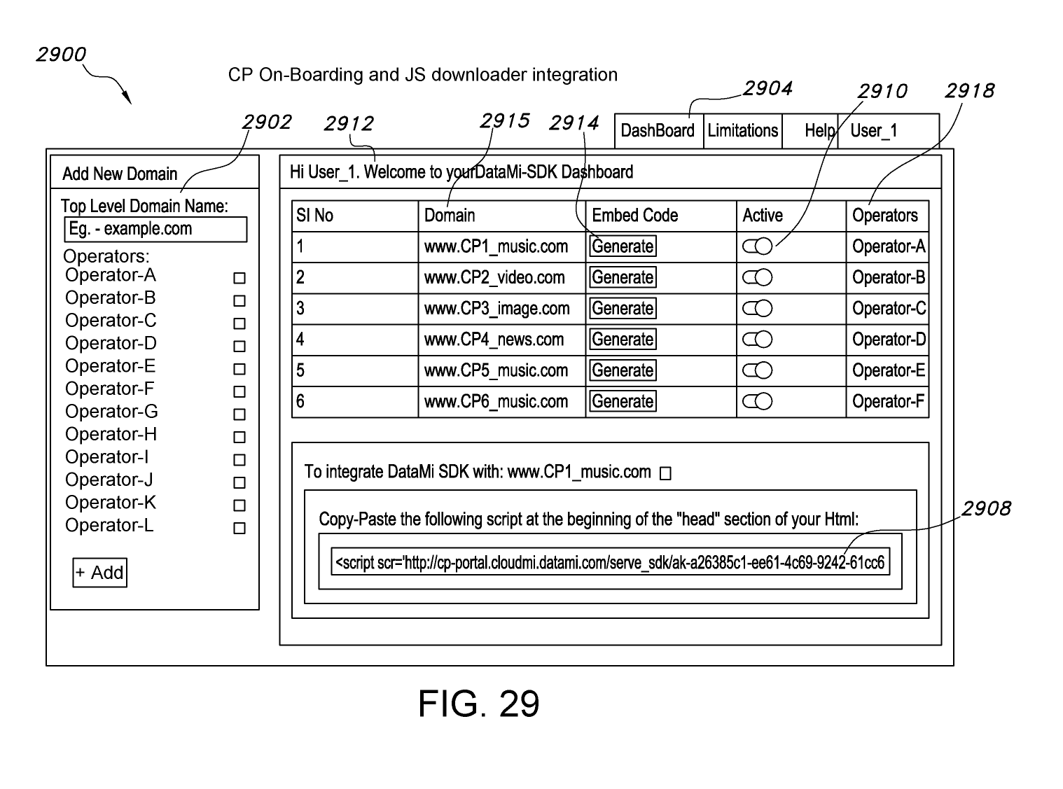

Referring to FIG. 29 and subsequent figures, methods and systems are provided herein for a client-server solution, including an SDK, which in embodiments may comprise the JS-SDK as described in this disclosure. In embodiments, the components of the JS-SDK may be dynamically loaded to one or more mobile web browsers on one or more mobile devices, and components may be deployed on and served from one or more servers.

In embodiments, a content provider's website may embed the JS-SDK, such as in an index page for the web site, to sponsor or subsidize the delivery of content for either the whole site, or for individual sections of web sites. A content partner may be provided, via a component of the JS-SDK, with a template section in the webpage to encapsulate content that the content provider would like to sponsor. This may enable the JS-SDK to gain a degree of control of the encapsulated page content during its loading. A content provider may configure the specific sections of the website (such as by specifying the path to each section) or the specific URLs that are to be sponsored. When the index page loads, the JS-SDK may talk to a server of a host of the platform described herein (referred to herein as the “host server,” which may be located in a cloud, such as managed by the host of the methods and systems described throughout this disclosure), which upon receiving a signal may insert JavaScript (JS) code for the campaign to the specified web site sections or URLs.

In embodiments, when a user mobile device latches to the cellular network and visits the website, the JS-SDK embedded in the website index page will communicate with the host server, and the host server will insert additional authorized JavaScripts to specific website sections, or other resources in a template section as text, which may be pre-configured resources or may be dynamically updated resources, including, without limitations, resources like img, video, form, audio, iframe, script, link, src, href, action, content, data-src, and/or data-href.

In embodiments, the JS-SDK may unlock the above-mentioned resources encapsulated within the template. Each of the DOM resources inside the template section may be parsed by JS-SDK and authorized to be routed through a sponsored gateway. The template section may then be passed to the browser, which renders it as HTML during loading of a page on the mobile device.

In embodiments, content sponsorship rules may be configured at the back-end when a content partner or mobile marketer creates a sponsored data campaign. In embodiments, the JS-SDK connects with the host server to authenticate and authorize a mobile user prior to serving web content to the user. In embodiments, services of the host server, such as enabled in the cloud, may authenticate and authorize a user for requests based on sponsored data campaign availability, campaign content sponsorship rules, campaign user targeting rules, user information, and the like. When authenticated and authorized, the JS-SDK may route the eligible content requests via a split billing gateway, such as described elsewhere in this disclosure and the documents incorporated herein by reference. In embodiments, only authorized content passes through the split billing gateway, and in embodiments the split billing gateway handles data path security and metering of data usage for the campaign.

The disclosure may provide several benefits, including, without limitation: easy one-time integration with content partners; configurable, dynamic sponsorship to an entire web site, a selected section, or selected content types within a website; use of convenient templates to enable easy sponsored web-site design that is aligned with campaign configuration parameters; flexible targeted advertising by allowing dynamic configuration of links, sub-links, custom tags, markers, and content-types for sponsorship; and easy updating, as web pages can be modified by updating DOM elements (e.g., the DOM elements may be sponsored after the page is rendered).

Further, the disclosure may provide a mechanism to ensure the SDK is downloaded from the original site through a redirect in cases, such as a script or network error, where SDK has previously failed to download.

Implementations may improve a user's experience by dynamically turning on and off different sponsorship configuration settings based on network capacity. An implementation enables a sponsor to selectively choose content, media-types, and media-resolution to be sponsored (including through link modification) based on varying network capacity at different times of the day. For example, during times when network capacity is highly available a content provider can sponsor better quality images or video, while avoiding the waste of sponsorship dollars on high quality content at times when the network does not have the capacity to render it well. These features can make the SDK highly usable on all network types (e.g., 2G, 3G, 4G, 5G, WiFi, small cell, femto, HetNets, etc.), and sponsored content selection lies at the discretion of the sponsor based on the available network type and capacity at any given time.

Further, an implementation does not depend on the carrier network, the mobile device platform, or the make and/or model of a particular mobile device. An implementation enables sponsorship to be tightly coupled to on-boarded content partners and authorized websites that are registered as domains. Thus, an implementation prevents malicious use by any other sponsor of the JS-SDK authorized to one sponsor for his registered website domain. An implementation also provides detailed analytics based on selective content sponsored.

An implementation enables an easy integration mechanism to sponsor entire or partial websites for different content partners. An implementation improves mobile marketing strategies by enabling configuration of content type, content category, content links, content pages for web sites, and the like, and allowing for sponsorship based on the region, business needs, target audience, network capacity, and the like. Further, an implementation allows dynamic changes to address sponsorship rules and dynamic changes to sponsorship of websites, maximizing benefits for content partners in dealing with dynamics in user behavior, business, marketing, and other dynamics.

In embodiments, a content partner registers websites on an over-the-top or OTT monetization service (“OMS”) portal, and the OMS portal fetches an application program interface (“API”) key from a global discovery service. In embodiments, different sponsorship campaigns are turned on and off from the OMS portal to target different user segments. In embodiments, upon integration of a sponsored data campaign, the API key is received to generate a downloadable link of the JS-SDK to be used by websites on mobile devices. In embodiments, mobile websites may report the API key (which may be unique for each content provider), a universally unique identifier (“UUID”) for the device, the URL of the JS-SDK, and/or other mobile device information to an authentication service, which upon successful authentication allows the mobile device to download the JS-SDK.

In embodiments, the website page integration with the JS-SDK is done manually by the developer or automatically by a parsing engine in the OMS gateway as the website page is downloaded through the OMS gateway as a result of existing action on the device browser. The integration using the parsing engine in the OMS gateway may allow the complete website to get integrated by manually inserting the SDK in the first parent page only.

In embodiments, the integration is done by inserting the JS-SDK link in the page and by replacing the existing HTML elements such as “head” and “body” into proprietary element templates. This can prevent the browser from processing such elements without first initializing the JS-SDK.

In embodiments, in case of a failure, such as a network failure or a script failure, the system redirects to a backup or fail-safe site from which the JS-SDK can be downloaded.

In embodiments, the JS-SDK checks cellular network status by contacting the Internet service provider (“ISP”) and calls global discovery only when the ISP confirms its presence in the cellular network. The JS-SDK may further check the ISP asynchronously (such as every two minutes) to confirm cellular presence if device is initially in a non-cellular network.

In embodiments, the JS-SDK successively calls user registration and authentication functions to authorize a user request based on sponsored data availability in the campaign and user eligibility information, such as available from the operator as defined by sponsorship rules applicable in a given region.

In embodiments, upon successful authorization of a user request, the JS-SDK parses web pages and loads the header part of a web page followed by its body. This may give the SDK parser more control to have a consistent body in sync with the header during page load.

In embodiments, upon failure of authorization, the JS-SDK loads web pages where embedded links, images, videos, audios, and the like (including based on HTML attributes like src attributes for loading images and href attributes for specifying URLs) are directly loaded without being passed through the gateway of the host of the methods and systems disclosed herein (and thus the data used to obtain such pages, etc. are not sponsored or subsidized by the content provider or other party).

In embodiments, attributes of webpages parsed by the SDK are matched to the attributes defined in a sponsored data campaign. In an aspect, upon successful matching, the content links, tags and content-types in that section are assumed to be sponsored and are passed through the sponsored gateway.

FIG. 29 illustrates an embodiment of the present disclosure, which includes a portal 2900, which provide an interface for on-boarding a content partner and setting up integration and download of JS to support a sponsored content campaign. The portal interface 2900 may allow content provider on-boarding for sponsoring web content on different operator networks 2902 and to configure a sponsored data campaign in a dashboard 2904. In the dashboard 2904, a script 2908 may be provided to a campaign sponsor, which is intended to be included in the HTML for a web site, such as in the header section of the HTML, such as by copying the script 2908 from the dashboard 2904 to the HTML header. A series of URLs or domains 2915 from which content is to be provided by a sponsor can be indicated in a menu 2912, where a content provider can indicate the code to be embedded 2914, can toggle to activate or de-activate a campaign 2910, and can indicate the operators of the cellular networks in which the campaign is intended to take place 2918. In an aspect, once the menu elements are selected in the menu 2912, the script 2908 can be automatically generated to allow for simple integration by pasting the script in the header of the website that is to be sponsored. The system may dynamically generate a JS-SDK downloader based on the selections in the dashboard 2904. In an aspect, once on-boarding the portal 2900, a content provider can sponsor web content on any operator network 2902 that has deployed sponsored data services on any mobile device platforms.

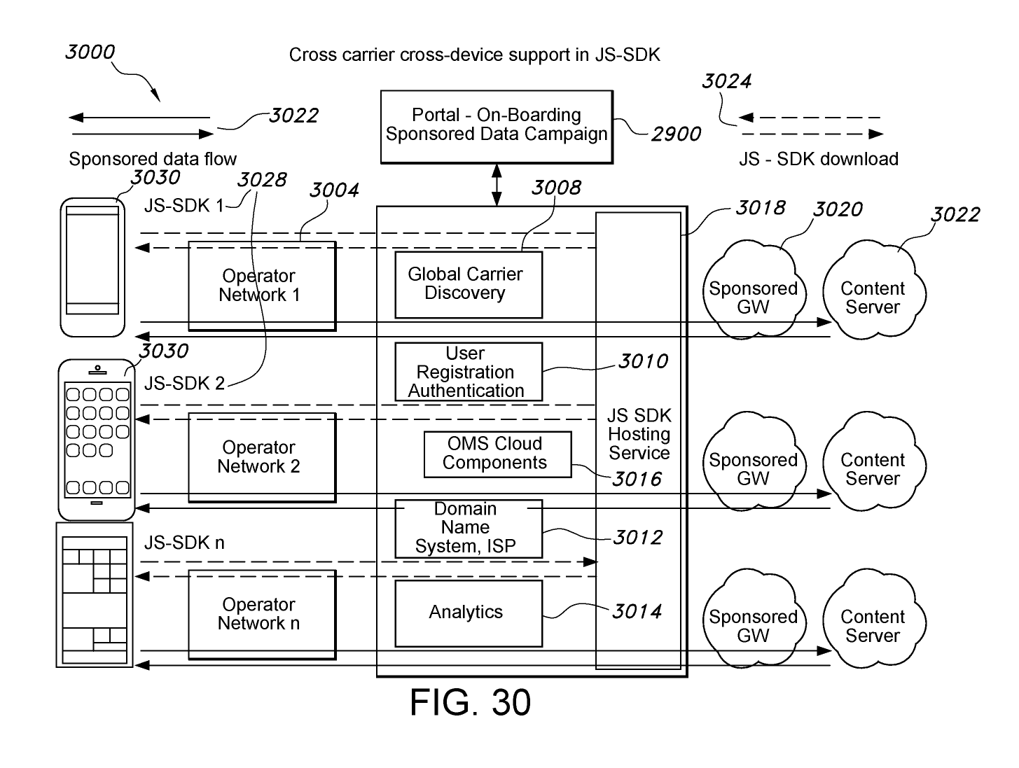

Referring to FIG. 30, cross-carrier device support can be provided by the methods and systems disclosed herein. In an aspect, once the on-boarding of a content provider is completed, such as using the portal 2900, the JS-SDK may be downloaded 3024 to the appropriate devices and servers, including content servers 3022 and gateways 3020, and the sponsored data flow 3032 may be enabled for various devices 3030 within various operator networks 3004. Various JS-SDK hosting services 3018 (which may be cloud services), may be provided in an embodiment of a JS-SDK platform 3000, such as global carrier discovery services 3008, sponsored user registration and authentication services 3010, domain name system (DNS) and ISP services 3012, and data analytics services 3014. Sponsored content gateways 3020, which may have characteristics described throughout this disclosure, may be provided for the campaigns, interacting with the hosting services 3018 and the various content servers 3022 of the content providers. Various instances of the JS-SDK 3028 can be deployed in various mobile devices 3030 operating on various operator networks 3004, each interacting with the hosting services 3018 and, where sponsorship is authenticated by the registration and authentication services 3010, through the applicable gateways 3020.

In embodiments a JS-SDK downloader code 3107 may be generated, such as for a content provider website of a content provider 3102. Upon successful content provider 3102 registration based on the web domains configured and sponsored by the content provider 3102, the content provider 3102 may receive an API key, such as received in the JS-SDK hosting service 3018 from a global carrier discovery service 3008. A JS-SDK hosting service 3018 may perform the following tasks and send a result as a header response upon receiving a request from the JS-SDK downloader code 3107: validation checking of the request using content provider identification and/or API key; generation and/or refreshing of unique device information, such as UUID for example; and determining the cellular presence of the device. The JS-SDK hosting service 3108 may be equipped to include JS-SDK as a part of its body or an embedded link to enable its download on successful validation.

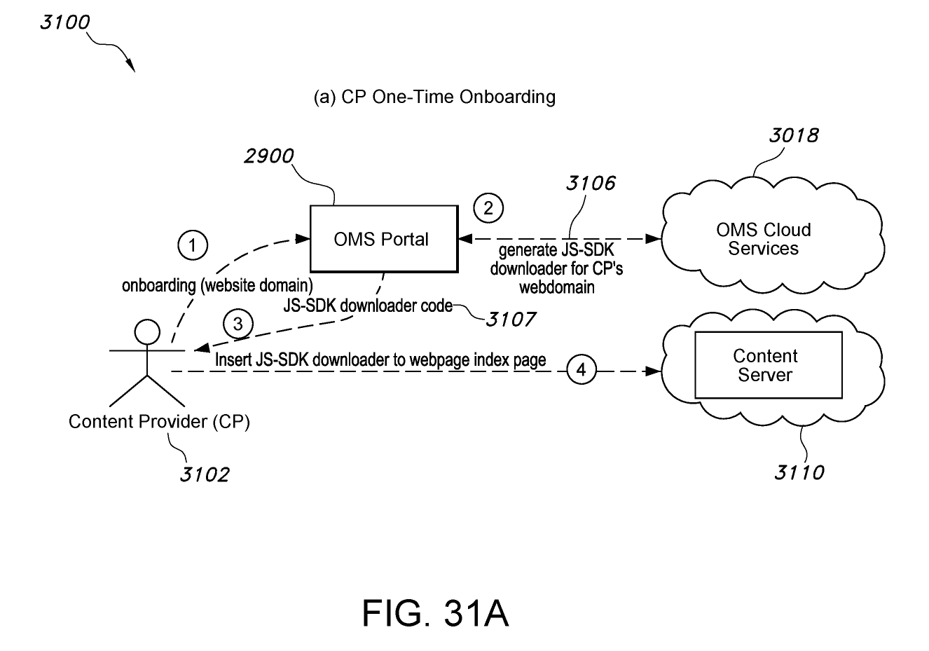

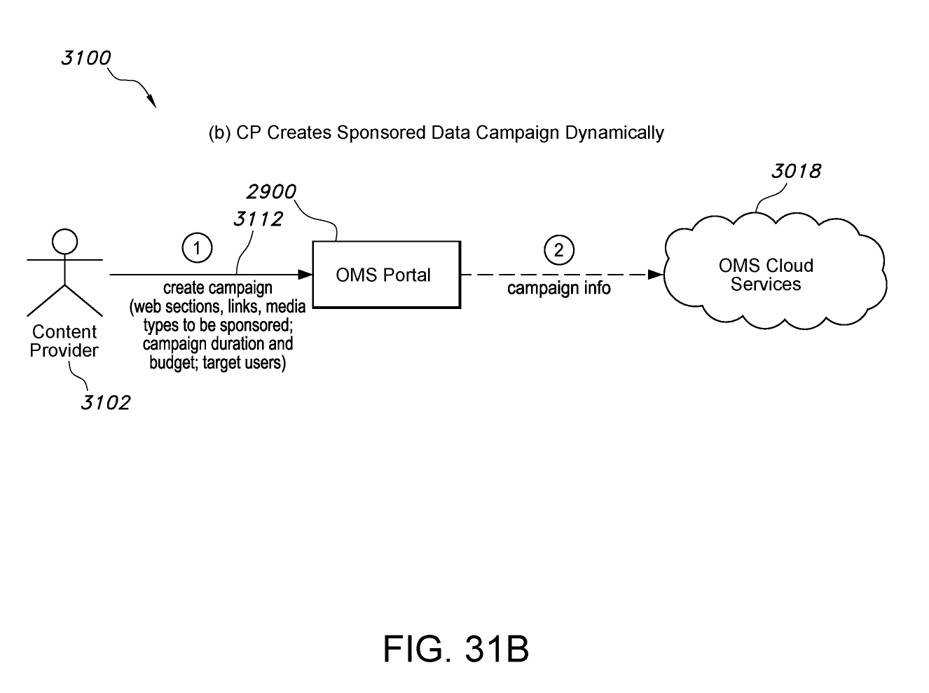

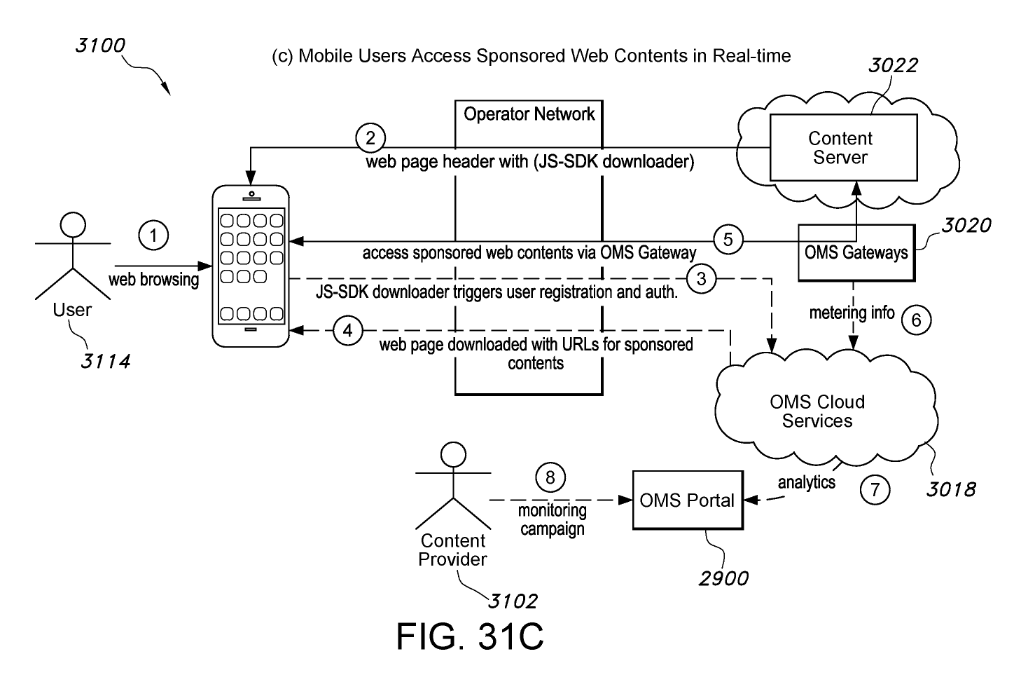

FIG. 31A illustrates a flow 3100 for one-time content provider on-boarding. The OMS portal 2900 may be configured to allow one-time boarding of a content provider 3102 by identifying each content provider 3102 with a unique content provider ID. The OMS portal 2900 may present a user-interface to allow a content provider 3102 to mention the web page name where the JS-SDK will get embedded on successful content provider 3102 registration and remains accessible to content partners 3102 on login. The user interface may further give options to generate, download and insert the JS-SDK downloader 3106 on content provider websites 2902. In embodiments, the on-boarding portal system may generate an API key for websites specified in the campaign and maintain and store the mapping between the content provider 3102 identification and the API key. The OMS portal 2900 may be equipped to push the content provider 3102 sponsored data configuration details, API key and related metadata to OMS cloud services, such as including modules for user registration, authentication, DNS, ISP, and the like, and which may include or interact with the JS-SDK services 3018.

Referring to FIG. 31B, embodiments may allow a content provider 3102 to create a dynamic sponsored campaign 3112. The OMS portal 2900 may present a user-interface for campaign creation which allows the content provider 3102 to configure webpages, links, tags, and the like which the content provider 3102 would like to sponsor. This configuration may take into consideration several factors such as: entire websites; specific sections of a website such as news, entertainment, etc.; specific content types; audio, video and images; specific web URLs for target users; number of devices limited to campaign location (mobile country codes and mobile network codes); total/per day campaign budget; and the like. The OMS portal 2900 may provide flexibility for a content provider 3102 to turn on and off sponsorship of selected content based on available network capacity, target audience, and business and marketing needs at different times of the day. In embodiments, OMS cloud services may be responsible for service discovery, as well as for registration, authentication and authorization of any request for sponsored data by the JS-SDK for a specific operator deployment. The OMS cloud service may be deployed with the global carrier discovery service 3008, which helps to locate the operator network 3004 in its respective country. Upon being contacted by the JS-SDK during its initialization phase, the user registration service 3010 may be responsible for registering the user (JS-SDK) and generating an UUID in a cellular network. The device may store this UUID. The authentication service 3010 may authenticate each request made by the JS-SDK by matching an application type, API key, UUID, website, links, and the like sponsored with campaign configuration details. The authentication token received by JS-SDK on successful authorization and authentication may contain option types for the SDK to filter traffic that will be passed through the sponsored gateway 3020. An instance of the JS-SDK cloud service 3018 may be deployed with the ISP 3012 (e.g., involving an IP to cellular network translator) service which, when queried, notifies the presence of the mobile device in a cellular network or on Wi-Fi. This can help to sponsor data in the cellular network and stop sponsoring data when the device switches to Wi-Fi.

As FIG. 31C further illustrates, one or more gateways 3020 may allow passage of sponsored traffic through them. In embodiments, the system allows a content provider 3102 to run test campaigns to better understand user 3114 behavior when content is sponsored. Traffic directed to a sponsored gateway 3020 is measured and accounted to the content provider 3102, enabling an understanding and analysis of behavior of a user 3114 with respect to different types of sponsored data accessed and consumed. At step one, a user may be browsing a mobile web site on a mobile device, resulting, at step two, in a web page header being downloaded from the content server 3110. The web page header may include the JS-SDK downloader code 3107, having been configured as noted above during creation of a campaign, such as using the portal 2900. Upon being loaded to the user device, at step three the JS-SDK downloader code 3107 may trigger user registration and authentication with the JS-SDK hosting services 3018, such via the registration and authentication services 3010 of the JS-SDK hosting services 3018 described in connection with FIG. 30, which may be cloud services, referred to in some cases as OMS cloud services herein. At step four, where the user is authenticated to receive the content in a sponsored or subsidized manner, the web page may be downloaded with the URLs for sponsored content. At step five, sponsored content may be provided via the sponsored gateways 3020 from the content server 3110. The gateways 3020 may deliver metering information at step six to the OMS cloud services, such as the JS-SDK services 3018. At step seven information, such as for supporting various analytics about the campaign, may be provided from the JS-SDK services 3018 to the portal 2900. A content provider 3102 may monitor the campaign at step 8 by accessing the portal and reviewing the analytic information, including by accessing various services, such as cloud services, such as the analytics services 3014 of the JS-SDK services 3018.

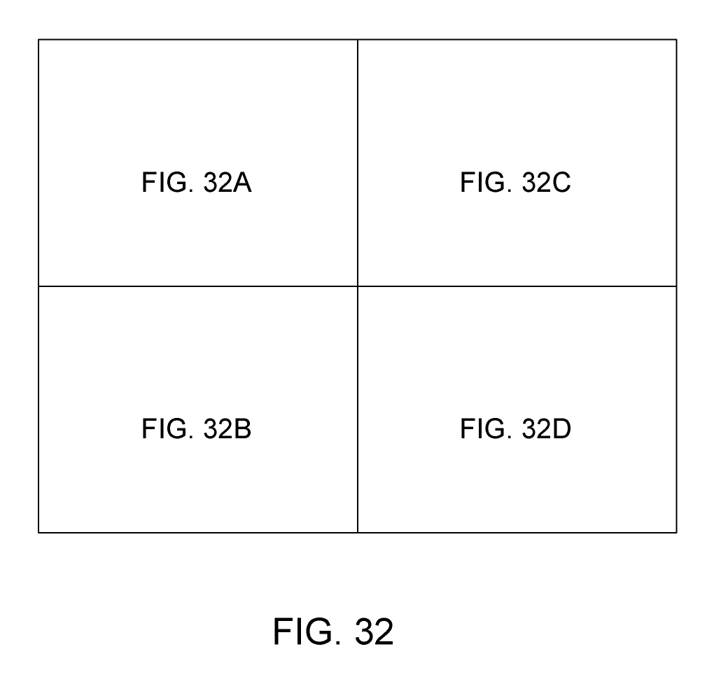

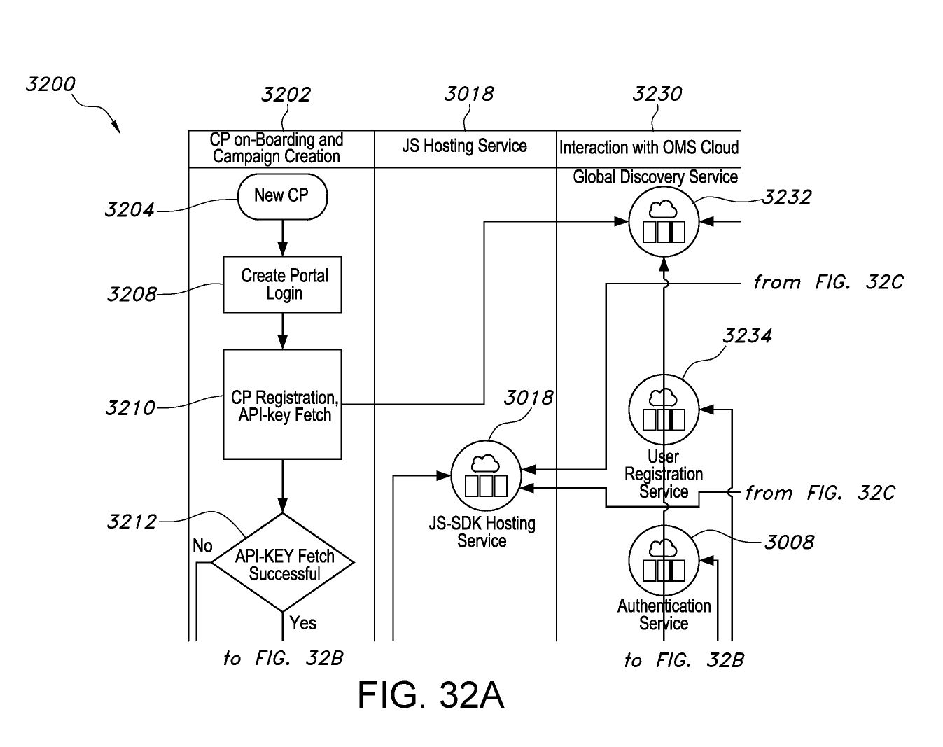

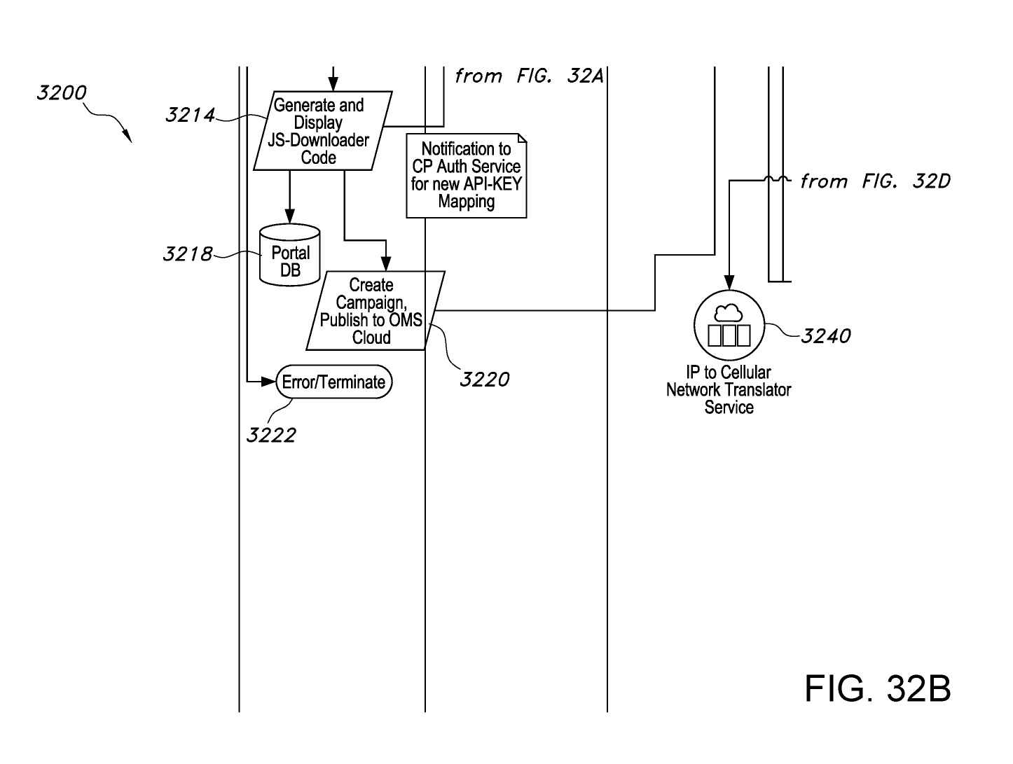

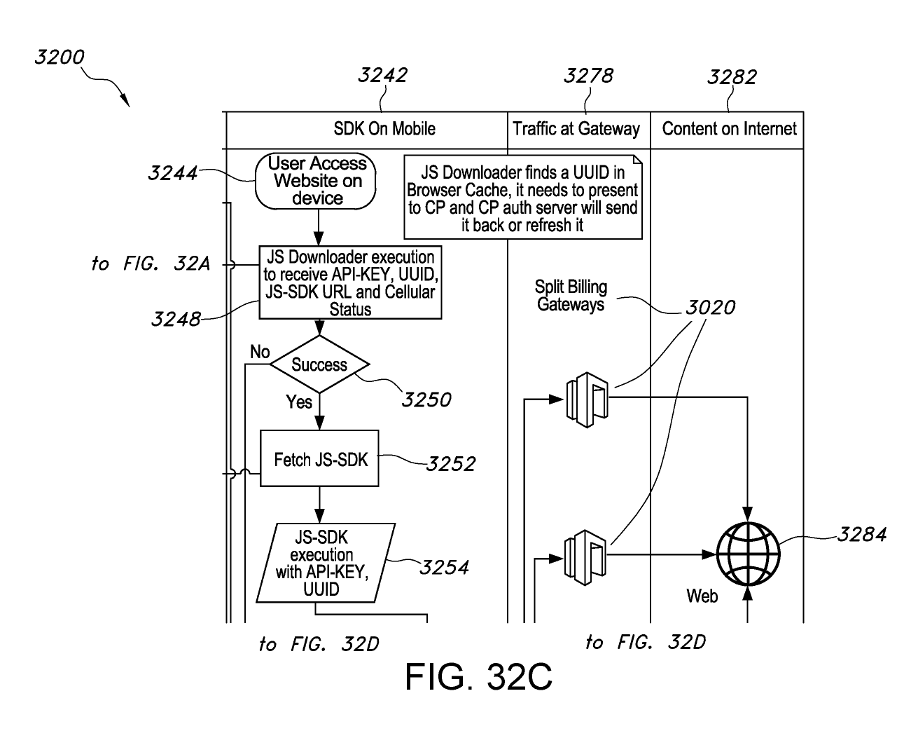

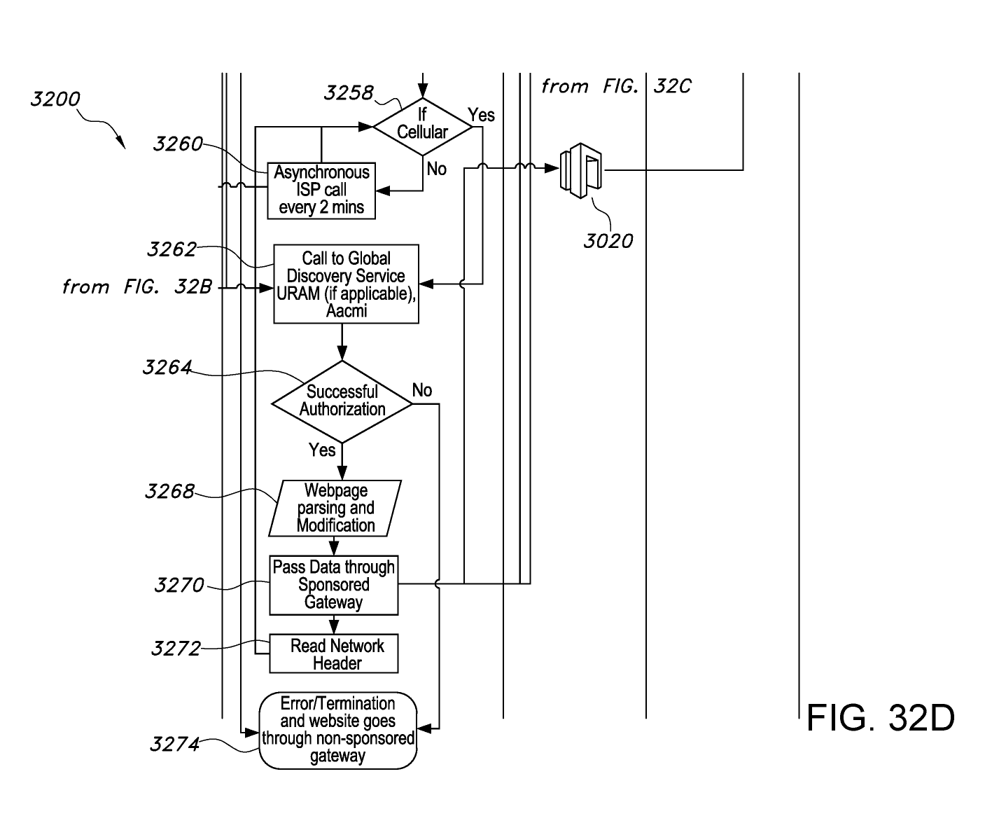

FIGS. 32A through 32D illustrate interaction of various components for creation, hosting and operation of a sponsored campaign for one or more mobile platforms on one or more operator networks. Referring to FIG. 32A, content provider onboarding and campaign creation 3202 may involve various steps, such as creating a new content provider account 3204 and logging in 3208, such as with the portal 2900. At step 3210 the content provider may be registered, and the various downloadable components, such as content provider-specific API-keys, may be fetched. This may involve interaction with a global discovery services 3232, such managed through the JS-SDK hosting services 3018.

Continuing the flow from FIG. 32A to FIG. 32B, at a step 3212 it may be determined that the fetching process was successful (e.g., that the API key was fetched). If so, then at a step 3212 the system may generate and display the JS-downloader code 3107, which may be stored in a database 3218 for the portal 2900, and published to the OMS cloud 3220, such as being relayed to the JS-SDK hosting service 3018. Notification may be provided to the content provider registration and authorization services 3008 of the JS-SDK services 3018 for new API-key mapping. A content provider may obtain the JS downloader code from the portal 2900 and include the JS downloader code in the header section of the content provider's website page. A content provider may complete the campaign at a step 3220. Publication of the campaign to the OMS cloud may include publication to the OMS Cloud Services like authentication service 3008 (shown on FIG. 32A) and the like.

Referring to FIG. 32C, the JS-SDK may include components downloaded on a mobile device 3242 that enable the execution of the campaign that was created as described in connection with the connected flows of FIGS. 32A and 32B. A user may access a website on a mobile device at a step 3244. At a step 3248 the JS downloader, which is embedded in the header of the website being downloaded by the mobile device, may be executed, such as from the JS-SDK hosting service 3018 (shown on FIG. 32A), as a result of which the device receives the API-KEY, UUID, JS-SDK URL and cellular status information. At a step 3250 it may be determined whether this information was properly received. If so, at a step 3252 the mobile device may fetch the JS-SDK from the JS-SDK hosting service 3018 (shown on FIG. 32A). At a step 3254 the mobile device may execute the JS-SDK with the API-Key and UUID. Execution can lead to a determination at a step 3258 whether there is a cellular network being used for the web connection. If not, then an asynchronous ISP call may be made at a time interval, such as every two minutes, at a step 3260, which may interact with an IP to cellular network translator service 3240 of the OMS cloud (shown on FIG. 32B). Thus, in a non-cellular network the JS-SDK may periodically asynchronously call an ISP (such as based on an IP-to-operator network translator) to check whether the device has switched to a cellular network.

In a cellular network, all requests from the SDK may contain UUIDs, and are authenticated and authorized to be directed to sponsored domains and hence a sponsored gateway. The JS-SDK may be notified of its presence in a cellular network for each response it receives from a sponsored gateway. In a cellular network, the JS-SDK may be responsible for generating sponsored domain requests based on websites and links sponsored by the content partner 3102. Thus, if the connection to the website is cellular at the step 3258 of FIG. 32C, then, referring to FIG. 32D, a call may be made at a step 3262 to the global discovery service 3232 (shown on FIG. 32A), such as a user registration (if applicable) or authentication call, as well as to the user registration service 3234 (shown on FIG. 32A) and the authentication service 3008 (shown on FIG. 32B). At a step 3264 of FIG. 32D it may be determined whether authorization was successful based on the calls to the various OMS cloud services. If not, then the process may terminate, in which case at a step 3274 the website may provide the content through a mechanism other than a sponsored content gateway. If at the step 3264 authorization is determined to be successful, then at a step 3268 the webpage may be parsed and modified. In embodiments, the JS-SDK may override default browser prototypes and attributes, such as inner-html, create-element, set-attribute, src attributes, hrefs, accessor properties, and the like, for dynamically created elements before the content starts downloading from the back-end content server. In embodiments, the document object module (DOM) parser of the JS-SDK may be responsible for generating sponsored authorized URLs for all dynamically added sponsored content.

At a step 3270 the data from the website may be passed through the sponsored gateway, which comprise various sponsored gateways 3020 (referred to variously herein as OMS gateways and split-billing gateways) (shown on FIG. 32C), which may in turn pull content from the website of the content provider 3284 for display on the mobile device. At a step 3272 the network header may be read and delivered to the OMS cloud services and/or JS-SDK hosting services 3018, such as for metering, reporting and analytics.

Thus, the JS-SDK, including the JS-SDK hosting services 3018 and the downloadable component on the mobile device, may communicate with different OMS cloud services 3230 and with content provider websites to verify authorization of a user to obtain sponsored content and to allow users to access the sponsored content. In embodiments, the JS-SDK is responsible for initiating calls to the global discovery service 3232 with a received cellular mobile country code (MCC) and mobile network code (MNC) API key from a JS-SDK hosting service 3228 to locate a sponsored gateway 3020, such as one associated with the specific carrier deployment.

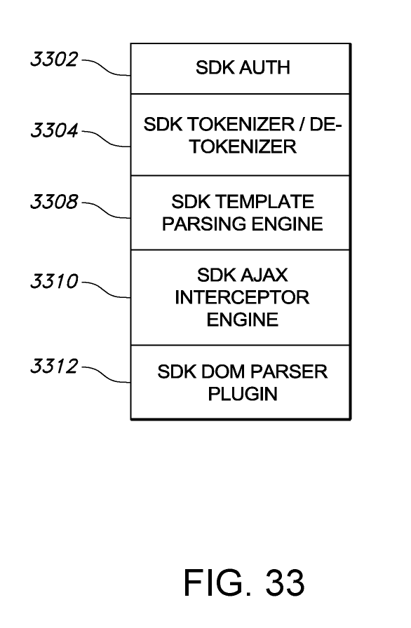

Referring to FIG. 33, the components of the JS-SDK system may include an SDK authentication module 3302, which may communicate with a cloud authentication module. The system may also include a tokenizer/de-tokenizer module 3304, which tokenizes and detokenizes embedded links within DOM elements in order to allow passage of all authorized links through a sponsored gateway 3020. The system may also include a template-parsing engine 3308, which unlocks and parses the template section of the HTML page before it is rendered by browser. The components of the JS-SDK system may also include an interceptor module 3310, such as an Ajax interceptor module, which receives browser events to handle event processing. The components of the JS-SDK system may also include a DOM element parser plugin 3312, which parses various DOM elements, such as, without limitation, img, video, form, audio, iframe, script, link, src, href, action, content, data-src, and data-href elements, among others.

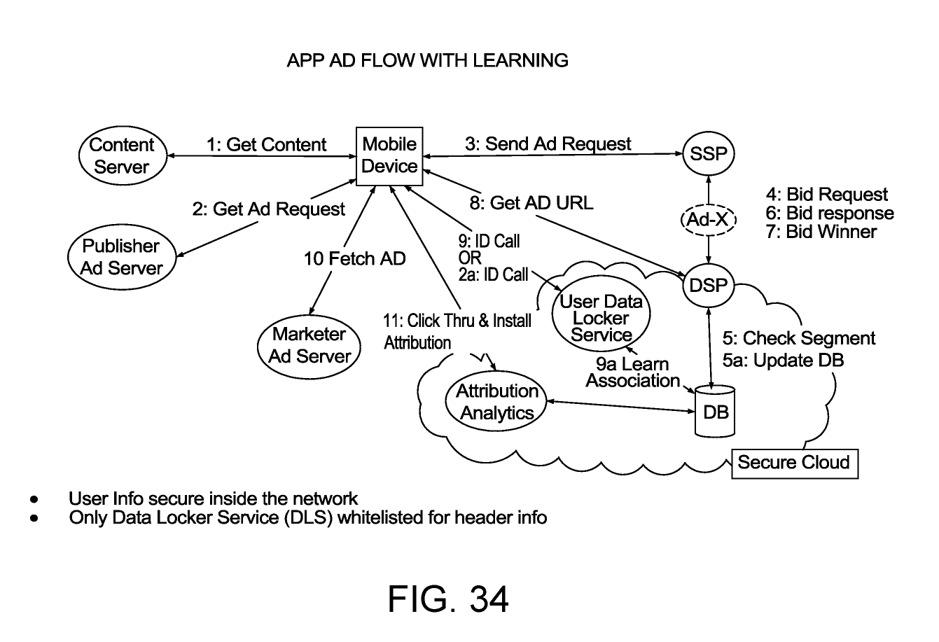

In accordance with additional embodiments, FIG. 34 shows an exemplary process flow for learning the association between the mobile network header information and the ad-network attributes. The exemplary process flow shows a sample flow for the request and delivery of an advertisement including the following steps who numbers are also shown in FIG. 34. In step 1, the device sends a request to the content server for the content served in an application or website when the user opens up that application or web-site. In step 2 when the content is displayed to the user, it may contain sub-spaces that can be used for showing advertisement to the user. These advertisement spaces can contain scripts that fetch relevant advertising to be displayed to the user. In step 3, the request for the advertisement is sent to the ad network including SSP, Ad exchanges and DSP. Steps 4, 6, and 7 can include processes for serving the advertising. In step 5 and step 5a and in case of a learning campaign, the DSP checks to see if the user segment information mapping is already learned in the database. If the information exists, the user can be skipped and not served any advertisement. If the information does not exist in the database, the DSP serves an advertisement from the learning campaign that enables the mapping of the user information from the mobile network operator to the user information received through the ad ecosystem.

In step 8, the response is can be from another piece of code called an advertisement Tag, which contains user information used for matching and serving advertising that is relevant to the user. The ID script is delivered along with this advertisement Tag. In step 9 and on delivery, the advertisement Tag can be executed in the mobile device as a follow on step to fetch the relevant advertising. The ID call is made as part of this step. The ID call is a call made to the learning platform and is enhanced by the mobile network operator to include user information in the header of the call. This information is then mapped to the information for the user from the ad ecosystem, which has already been registered into the database in Step 5. This can be shown to allow the system to monetize the mobile network information for future advertising without divulging user identifying information (for e.g. MSISDN) to any third party. Steps 10 and 11 include ad network steps for delivery of the advertising and for tracking the attribution when the user clicks through the advertising.

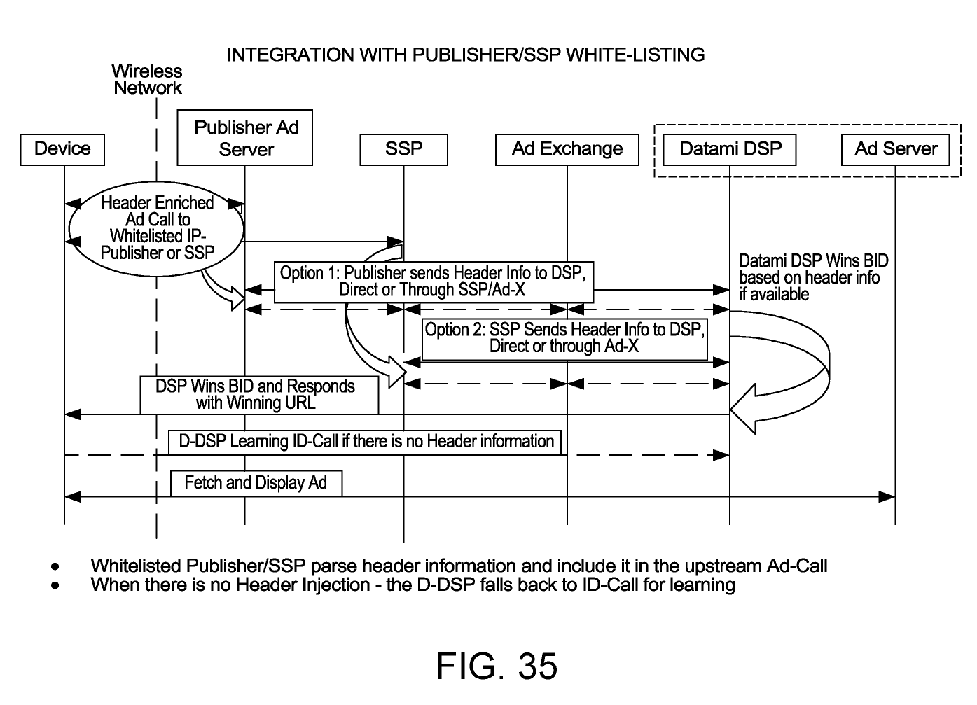

In further embodiments, FIG. 35 depicts an option where the mobile network operator can provide user information to the Publisher or the SSP. In such cases the user segment information and the user identifying information can be included in the ad request directly. In this instance, there can be no need for an additional ID call from the device in the subsequent step of delivery of the advertisement. The DSP may decide to include the ID call in the advertisement Tag if the header information is not present in the Ad request received from the Publisher or the SSP.

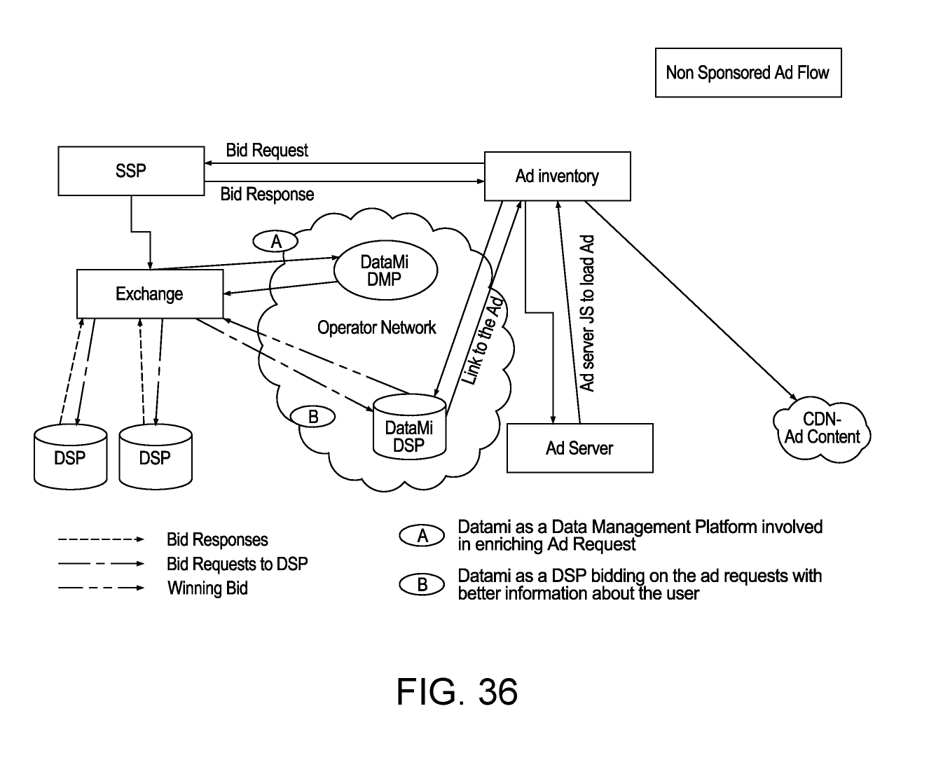

In further embodiments, FIG. 36 shows a data management platform that can enrich advertisement requests with user targeting information. This information can be retrieved from a database of information that is either learned via the learning platform that can associate the ad network information with information received from the mobile network operator about the same user. The enrichment of the ad request can be shown to enhance the value of the targeting. The advertisement may be served by the DSP configured in accordance with the present disclosure or by any DSP from the ad-network.

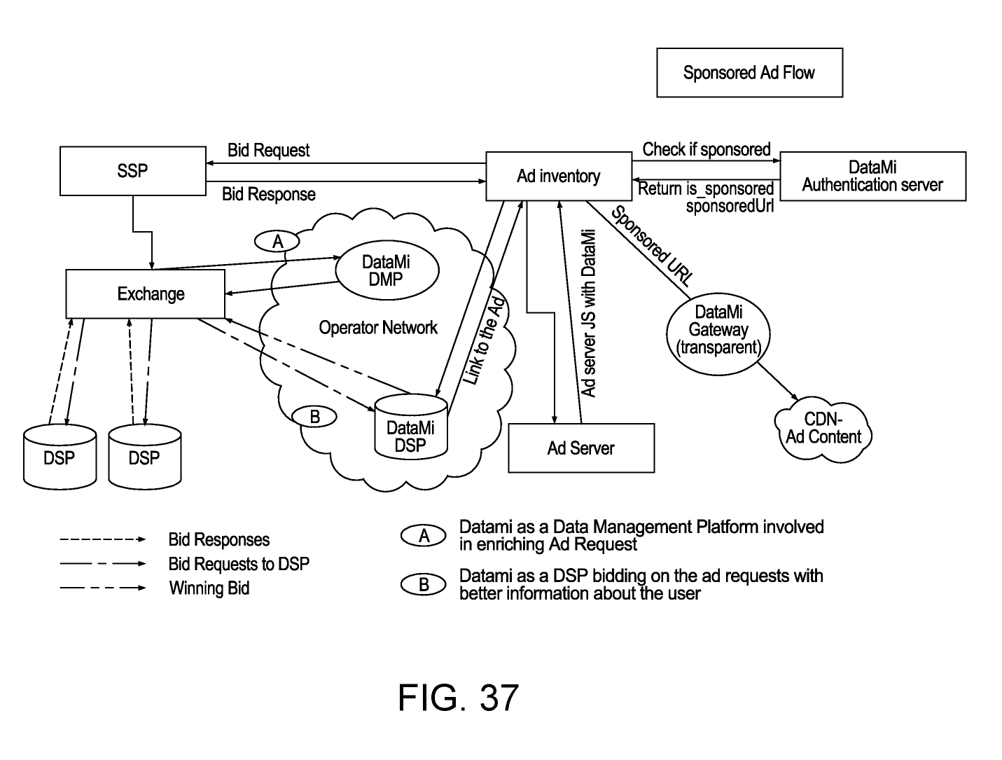

In yet additional embodiments, FIG. 37 shows how the advertisement that is served to the mobile user may avail of free data on the mobile network and in turn this can be plugged into the Sponsored data solution. The Advertisement Tag that is served to the mobile user in the application or the website can contain the SD java script (SDJS) code for sponsored data. The SDJS can verify with the cloud based authorization system when the user is eligible to get free data for the advertisement. It can also verify when a sponsor is currently running a campaign to pay for the user data consumed by the mobile advertisement. If the campaign rules and the user eligibility result in authorization for free data, then the advertisement can be routed through the sponsored data gateway. The gateway can be integrated with the mobile network operator such that all traffic to and from the gateway is not charged to the user, and the gateway maintains the data accounting records to charge the data traffic to the account of the sponsor. This can enable the eligible user to view without any data charges all mobile advertisements that are authorized by a sponsor for free data.

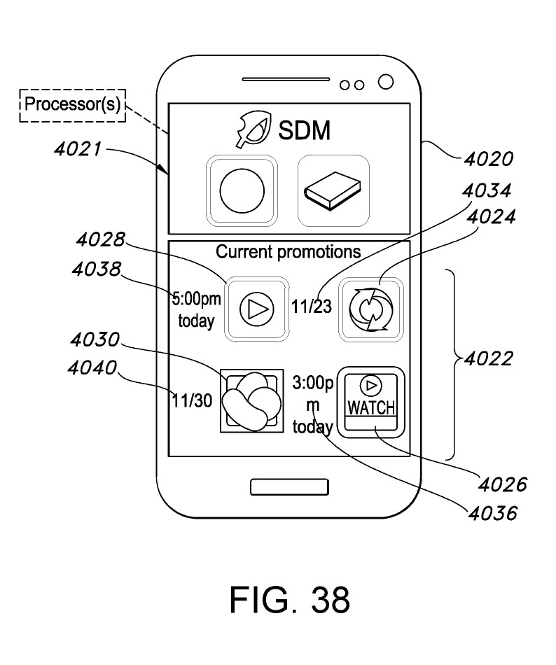

FIG. 38 is a block diagram showing a sponsored data container 4021 on a user device 4020. The sponsored data container 4021 may include a display area 4022 for sponsored promotions displaying data associated with one or more sponsored app (app have sponsored data). Data traffic for all apps displayed in the container may be sponsored. The apps 4024, 4026, 4028, 4030 may display change dynamically, e.g., showing an expiration date/time 4034, 4036, 4038, 4040, as promotions expire and the user moves in and out of locations where data is sponsored.

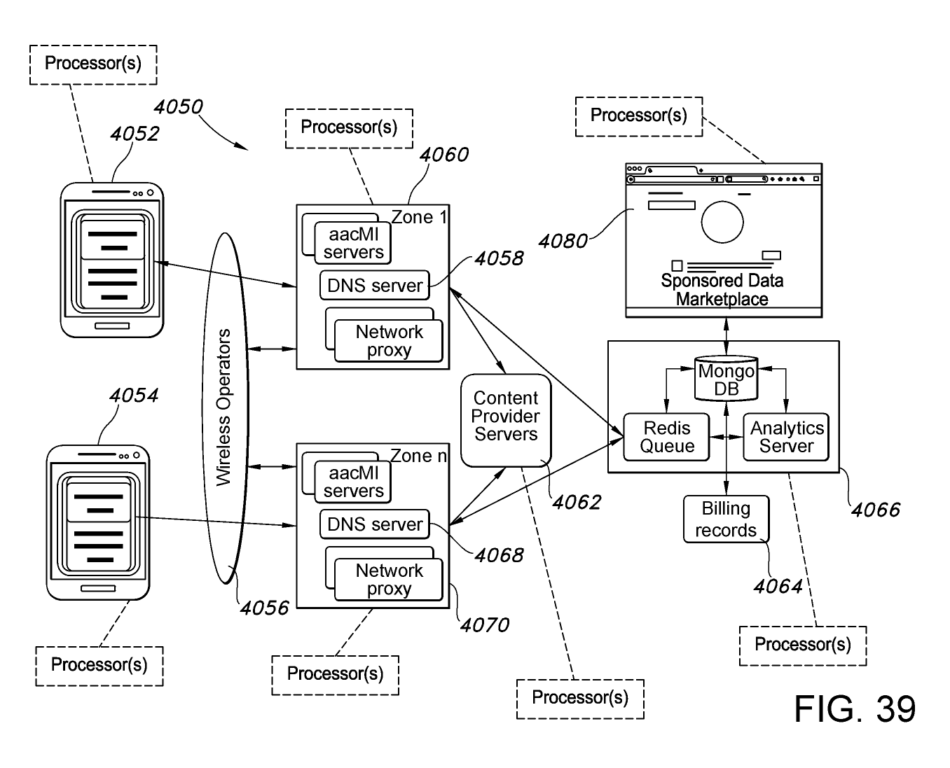

FIG. 39 shows the overall system architecture of the sponsored data system 4050. Different user devices 4052, 4054 can access sponsored data via wireless operator 4056 by first communicating with the DNS cloud component 4058, 4068 of the sponsored data system. User data then travels through the proxy box 4060, 4070 to the content provider server 4062 and obtain the sponsored content. User devices 4052, 4024 may connect to the physically nearest proxy box 4060, 4070 to reduce network latency. Accounting information may be stored in a separate billing database 4064 and analytics server 4066, which directly connects to the portal 4080.

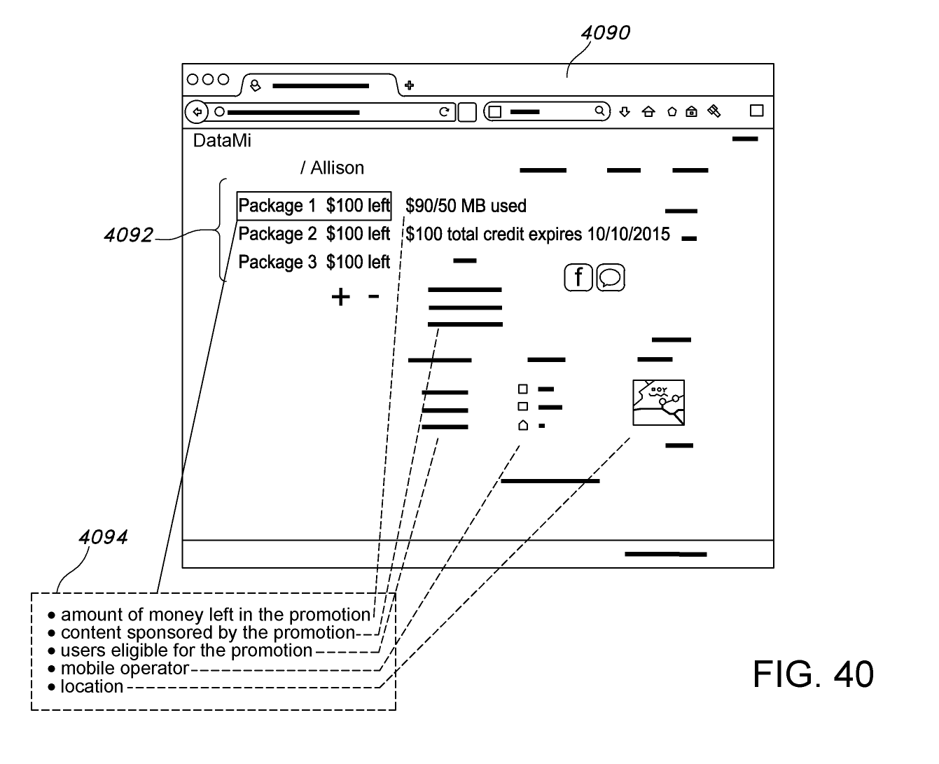

FIG. 40 shows a content provider's portal home screen. The provider may see a list of its promotion packages 4092 to the left and can select each to view its associated parameters 4094 stored by the portal. These promotion parameters 4094 include the amount of money left in the promotion, the content sponsored by the promotions, users eligible for the promotion, mobile data operator and the location of user device.

FIG. 4 shows a portal screen 4100 configured to allow a content provider to select content associated to be sponsored in a promotion package. The provider may search through available apps 4102 or add URL links 4104.

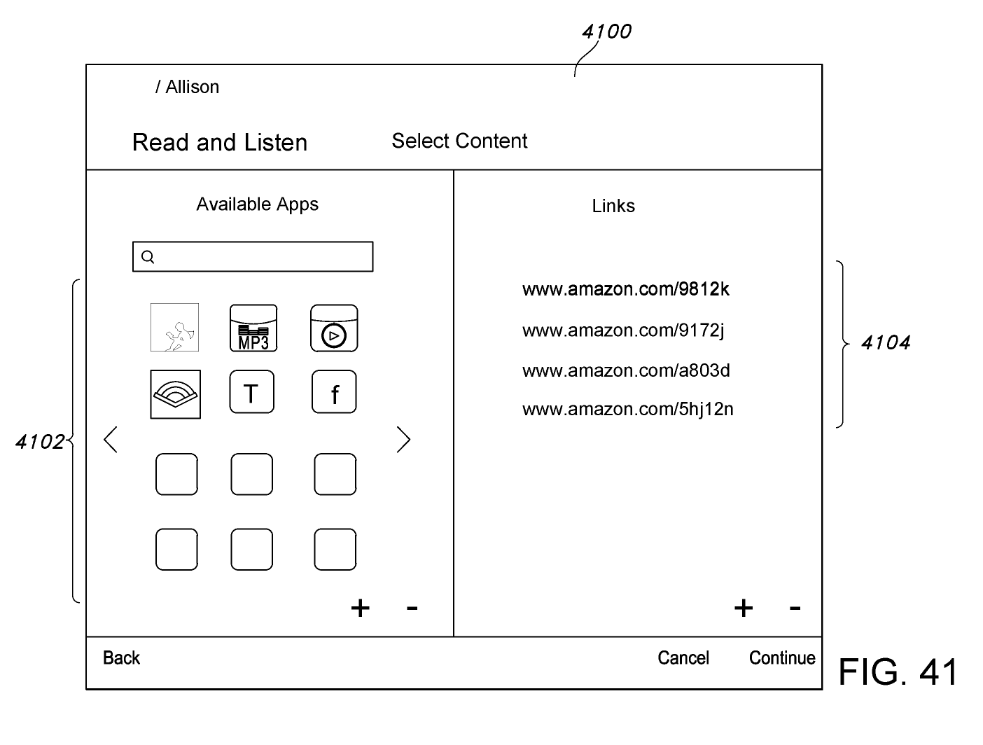

FIG. 41 shows a portal screen 4110 may be configured to allow a content provider to select users eligible for a promotion package. The provider may first specify the ISP networks 4112 on which it wishes to sponsor data (e.g., sponsoring Twitter for all AT&T subscribers at a baseball game). It can also upload a list of specific device phone numbers as shown generally by reference number 4116 or select an area of eligible user locations on a map 4118. The portal may also generate a set of promotion codes for distribution to users as shown generally by reference number 4120.

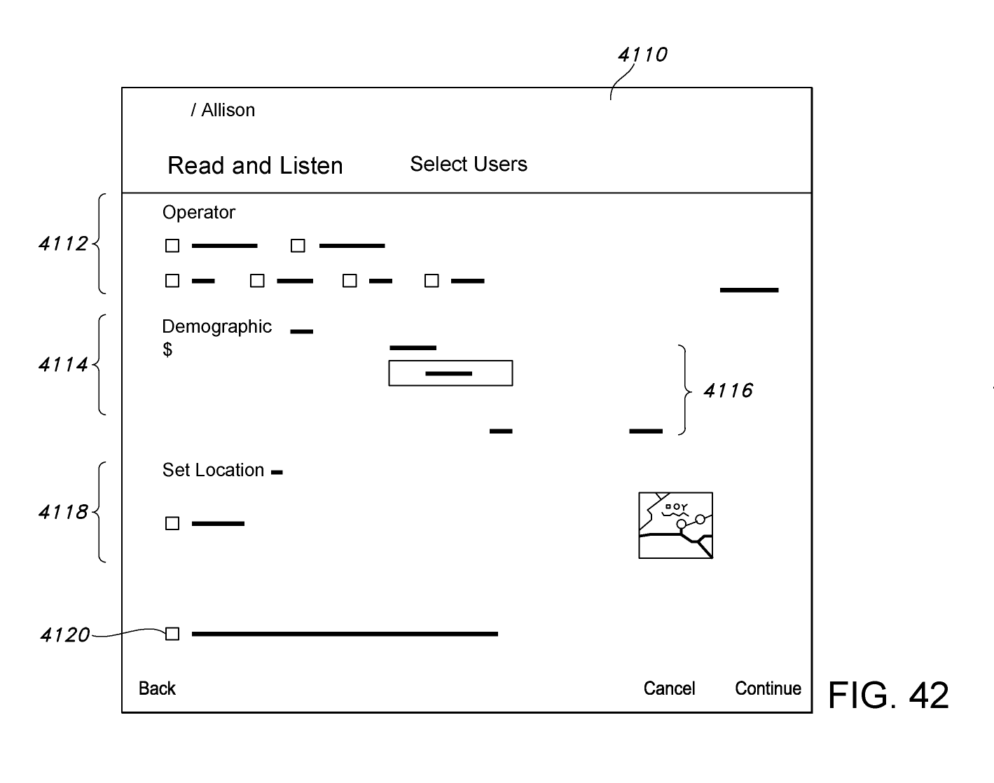

FIG. 42 shows a portal screen 4130 configured to allow a content provider to specify the amount of money it is willing to spend on the package as shown generally by reference number 4132. The provider can also specify maximum spending per user and per app included in the package. The provider can also specify expiration dates and times, e.g., the start and end of a baseball game as shown generally by reference number 4134. The portal can also generate alerts to notify the content provider as credit is running out game as shown generally by reference number 4136.

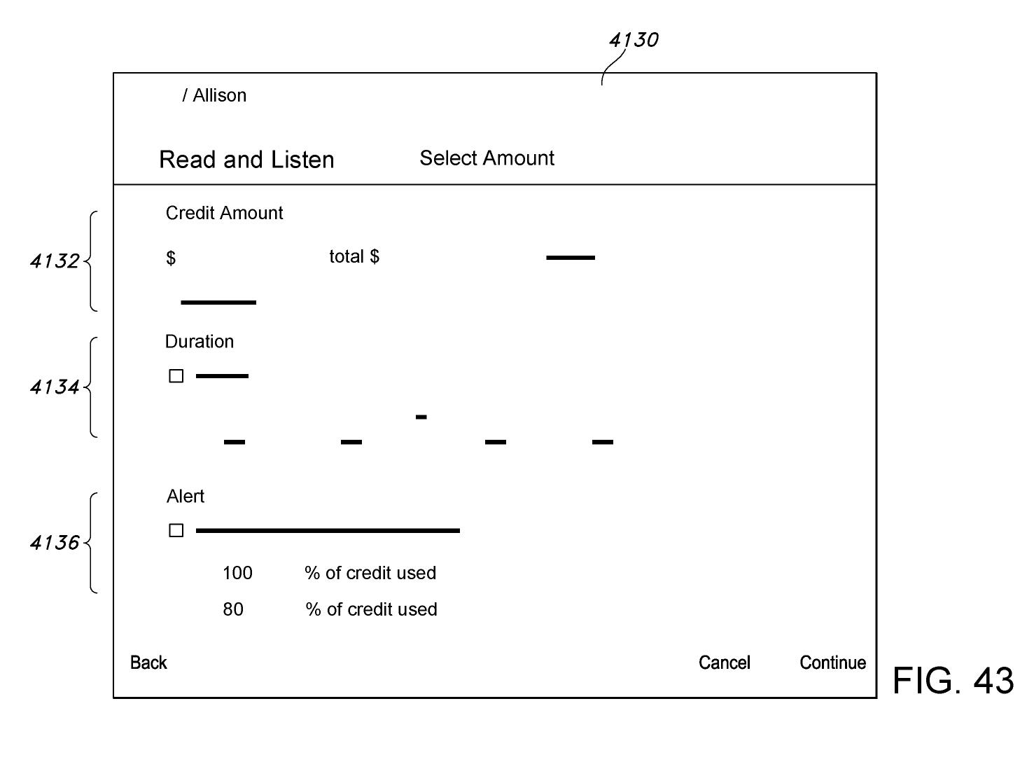

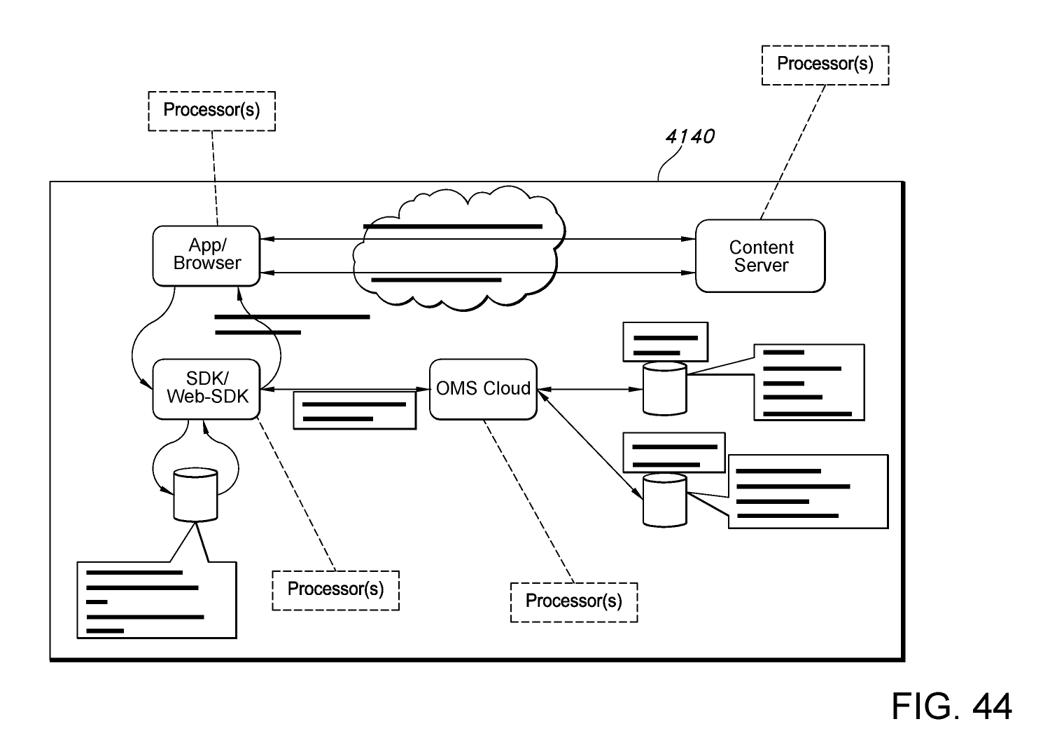

FIG. 43 is a block diagram 4140 showing operation of the interface application or SDK in determining and marking a sponsored data content. FIG. 44 generally illustrates how the SDK acts as the gatekeeper for sponsored data identifies which content to be sponsored, interacts with the App and the user and enables the sponsored data marketplace. In general, the SDK is implemented on the user device. The SDK integrates with a provisioning and accounting platform in the cloud that; a) integrates with the ISP network for detailed sponsored data accounting; b) provides an analytics portal for content providers and ISPs to view statistics of the types and users of sponsored data; and c) allows Sponsors to create promotion packages by specifying the users, content to sponsor, and monetary amount to sponsor in a way that is possibly location-, time-, content-, and user specific.

When a user opens an app integrated with the SDK on his or her device, the SDK registers the device with the provisioning and accounting in the cloud (cloud platform). The cloud platform returns a list of all sponsored content within the app, which is displayed accordingly to the user. If a user selects a piece of sponsored content, the SDK authorizes the content sponsorship by contacting the cloud platform. The cloud platform generates a token and transmits the token to the SDK. The token, which is also cached on the cloud, is then used by the SDK to validate requests for this piece of content. The operation of the sponsored data may not necessarily need the app to be active or open to start with. Along with the token the cloud platform transmits caching rules to the SDK, such as amount of data that is sponsored, duration, types of content etc., for the token which allows the SDK to make local decisions based on all the app content.

After receiving the token, the SDK appends the token to the sponsored content's URL and sends it to the app. The app uses this URL to request the piece of sponsored data. This request is validated using the token and rerouted to a proxy box in the cloud through DNS lookup of the URL with appended token. The content request is then forwarded through the proxy box to the content provider's server. The server returns the content through the proxy box, which records its size and forwards the content to the app.

The sizes of different pieces of sponsored content are forwarded by the proxy boxes to a separate analytics server in the cloud. This server aggregates information for each sponsored data session to calculate total sponsored data usage for each app, each user, each package, and each content provider. The external portal screen displays this information, which is also parsed to bill content providers according to the amount of data they sponsor.

The portal screens shown in FIGS. 41-44 allow content providers to purchase promotion packages as discussed above. The portal may be connected to a backend database configured to store information about all packages. When a user device registers with the cloud, its information may be checked against eligible user groups for all promotion packages. Apps in packages for which the user is eligible may then displayed in the sponsored data container on the device. The device initiates device registration, not the cloud, conserving device resources when the user does not wish to access sponsored data.

Some content providers may attempt to sponsor the same apps for the same users at the same time. In case of such conflicts, the cost of sponsorship is split among the content providers, possibly evenly or possibly in proportions determined by other mechanisms such as bidding or auctions. The method for splitting the cost also dictates the promotion of the sponsors' brand associated with that content.

While only a few embodiments of the present disclosure have been shown and described, it will be obvious to those skilled in the art that many changes and modifications may be made thereunto without departing from the spirit and scope of the present disclosure as described in the following claims. All patent applications and patents, both foreign and domestic, and all other publications referenced herein are incorporated herein in their entireties to the full extent permitted by law.

The methods and systems described herein may transform physical and/or or intangible items from one state to another. The methods and systems described herein may also transform data representing physical and/or intangible items from one state to another.

The elements described and depicted herein, including in flow charts and block diagrams throughout the figures, imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipment, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps associated therewith, may be realized in hardware, software or any combination of hardware and software suitable for a particular application. The hardware may include a general-purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine-readable medium.

The use of the terms “a” and “an” and “the” and similar referents in the context of describing the disclosure (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. All methods described herein can be performed in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed. No language in the specification should be construed as indicating any non-claimed element as essential to the practice of the disclosure.

While the foregoing written description enables one of ordinary skill to make and use what is considered presently to be the best mode thereof, those of ordinary skill will understand and appreciate the existence of variations, combinations, and equivalents of the specific embodiment, method, and examples herein. The disclosure should therefore not be limited by the above described embodiment, method, and examples, but by all embodiments and methods within the scope and spirit of the disclosure.

The above systems, devices, methods, processes, and the like may be realized in hardware, software, or any combination of these suitable for a particular application. The hardware may include a general-purpose computer and/or dedicated computing device. This includes realization in one or more microprocessors, microcontrollers, embedded microcontrollers, programmable digital signal processors or other programmable devices or processing circuitry, along with internal and/or external memory. This may also, or instead, include one or more application specific integrated circuits, programmable gate arrays, programmable array logic components, or any other device or devices that may be configured to process electronic signals. It will further be appreciated that a realization of the processes or devices described above may include computer-executable code created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software. In another aspect, the methods may be embodied in systems that perform the steps thereof, and may be distributed across devices in a number of ways. At the same time, processing may be distributed across devices such as the various systems described above, or all of the functionality may be integrated into a dedicated, standalone device or other hardware. In another aspect, means for performing the steps associated with the processes described above may include any of the hardware and/or software described above. All such permutations and combinations are intended to fall within the scope of the present disclosure.

Embodiments disclosed herein may include computer program products comprising computer-executable code or computer-usable code that, when executing on one or more computing devices, performs any and/or all of the steps thereof. The code may be stored in a non-transitory fashion in a computer memory, which may be a memory from which the program executes (such as random access memory associated with a processor), or a storage device such as a disk drive, flash memory or any other optical, electromagnetic, magnetic, infrared or other device or combination of devices. In another aspect, any of the systems and methods described above may be embodied in any suitable transmission or propagation medium carrying computer-executable code and/or any inputs or outputs from same.

It will be appreciated that the devices, systems, and methods described above are set forth by way of example and not of limitation. Absent an explicit indication to the contrary, the disclosed steps may be modified, supplemented, omitted, and/or re-ordered without departing from the scope of this disclosure. Numerous variations, additions, omissions, and other modifications will be apparent to one of ordinary skill in the art. In addition, the order or presentation of method steps in the description and drawings above is not intended to require this order of performing the recited steps unless a particular order is expressly required or otherwise clear from the context.

The method steps of the implementations described herein are intended to include any suitable method of causing such method steps to be performed, consistent with the patentability of the following claims, unless a different meaning is expressly provided or otherwise clear from the context. So for example performing the step of X includes any suitable method for causing another party such as a remote user, a remote processing resource (e.g., a server or cloud computer) or a machine to perform the step of X. Similarly, performing steps X, Y and Z may include any method of directing or controlling any combination of such other individuals or resources to perform steps X, Y and Z to obtain the benefit of such steps. Thus method steps of the implementations described herein are intended to include any suitable method of causing one or more other parties or entities to perform the steps, consistent with the patentability of the following claims, unless a different meaning is expressly provided or otherwise clear from the context. Such parties or entities need not be under the direction or control of any other party or entity, and need not be located within a particular jurisdiction.

It should further be appreciated that the methods above are provided by way of example. Absent an explicit indication to the contrary, the disclosed steps may be modified, supplemented, omitted, and/or re-ordered without departing from the scope of this disclosure.

It will be appreciated that the methods and systems described above are set forth by way of example and not of limitation. Numerous variations, additions, omissions, and other modifications will be apparent to one of ordinary skill in the art. In addition, the order or presentation of method steps in the description and drawings above is not intended to require this order of performing the recited steps unless a particular order is expressly required or otherwise clear from the context. Thus, while particular embodiments have been shown and described, it will be apparent to those skilled in the art that various changes and modifications in form and details may be made therein without departing from the spirit and scope of this disclosure and are intended to form a part of the invention as defined by the following claims, which are to be interpreted in the broadest sense allowable by law.

What is claimed is:

1. A sponsored data system configured to operate with a wireless mobile device running an app that receives sponsored data from a content provider server, the system comprising:
an interface application configured to run on the wireless mobile device, the interface application being configured to determine availability of sponsored data;
a cloud platform configured to interface with the content provider server, the cloud platform being configured to generate a token with data usable to determine availability of sponsored data and transmit the token to the interface application; and
a portal configured to create and store a package that identifies at least a portion of the data associated with the app as sponsored data.

2. The system of claim 1, wherein the portal allows configuration of settings for a campaign for distributing a toll-free app.

3. The system of claim 2, wherein the configuration of settings in the portal allow the campaign for distributing the toll-free app to be distributed by short message service (SMS).

4. The system of claim 1, wherein the portal allows configuration of settings for a campaign for distributing different elements of sponsored data at different pricing rates.

5. The system of claim 4, wherein the different pricing rates include at least two of fully sponsored, partially sponsored, and unsponsored pricing rates.

6. The system of claim 1, wherein the portal allows configuration of a campaign for at least one of a plurality of jurisdictions, a plurality of content categories, and a plurality of carrier networks.

7. The system of claim 6, wherein the portal allows configuration of a campaign that includes mobile credit rewards for a plurality of carrier networks.

8. The system of claim 6, wherein the portal allows configuration of a campaign for a plurality of content categories selected from the group consisting of toll-free advertising, partially sponsored advertising, toll-free video, partially sponsored video, toll-free use of a specified application, partially sponsored use of a specified application, toll-free data, partially sponsored data, toll-free email, and partially sponsored email.

9. The system of claim 1, wherein the portal allows configuration of settings for a campaign that includes delivery of toll free video advertising to the mobile device.

10. The system of claim 1, wherein the interface application comprises a software development kit on the mobile device that separates traffic that is sponsored from traffic that is not sponsored based at least in part on the token generated by the cloud platform.

11. The system of claim 10, wherein the software development kit is a JavaScript software development kit.

12. The system of claim 1, wherein the portal allows the sponsor of a campaign to configure parameters for the campaign selected from the group consisting of at least one carrier network on which the campaign will be provided, a timing for the campaign, an aggregate sponsorship amount for the campaign, a per user sponsorship amount for the campaign, at least one type of content to be sponsored, and at least one jurisdiction for the campaign.

13. The system of claim 1, wherein the cloud platform further comprises a gateway for tracking sponsored data usage by the mobile device.

14. The system of claim 13 further comprising a facility for arranging for billing of appropriate sponsored elements of a campaign to a sponsor based on the tracking of sponsored data usage by the gateway.

15. The system of claim 1, wherein the cloud platform is configured to transmit caching rules to the interface application, the caching rules including at least one of an amount of data that is sponsored, a duration, a type of content associated with the token, the interface application being configured to determine availability of sponsored data based on the token and the caching rules.

16. A system including a software development kit for enabling at least partial sponsorship of at least a portion of content of at least one of a mobile website and a mobile application by a content sponsor, the system comprising:
a device-side component of the software development kit to be loaded on a user device; and
at least one server-side component of the software development kit for storing content relating to parameters for a sponsored content campaign and for serving content to the device, wherein upon receiving a content-specific key and an identifier from the device-side component, the server-side component validates authorization of the device to receive the content associated with the content-specific key under the parameters of the campaign and authorizes delivery of the content to the device via a gateway for the sponsored content campaign.

17. The system of claim 16, wherein the software development kit is provided within an encapsulated template structure.

18. The system of claim 16, wherein the gateway is configured at least in part via a sponsor portal that allows configuration of settings for a campaign.

19. The system of claim 18, wherein the portal allows configuration of settings for a campaign for distributing different elements of sponsored data at two or more pricing rates among fully sponsored, partially sponsored, and unsponsored pricing rates.

20. The system of claim 18, wherein the portal allows the sponsor of a campaign to configure parameters for the campaign selected from the group consisting of at least one carrier network on which the campaign will be provided, a timing for the campaign, an aggregate sponsorship amount for the campaign, a per user sponsorship amount for the campaign, at least one type of content to be sponsored, and at least one jurisdiction for the campaign.

21. The system of claim 18, wherein the portal allows configuration of parameters for the gateway that include tracking components for an aggregate campaign that includes distribution of sponsored data for at least one of a plurality of jurisdictions, a plurality of content categories, and a plurality of carrier networks.

22. The system of claim 18, wherein the configuration is for different content types, wherein the content types are selected from the group consisting of toll-free advertising, partially sponsored advertising, toll-free video, partially sponsored video, toll-free application usage, partially sponsored application usage, toll-free data, partially sponsored data, toll-free email, and partially sponsored email.

23. The system of claim 16, wherein the software development kit separates traffic that is sponsored from traffic that is not sponsored based at least in part on a token for a campaign handled at least in part by the server-side component.

24. The system of claim 16 further comprising a facility for arranging for billing of appropriate sponsored elements of a campaign to a sponsor based on tracking of sponsored data by the gateway.

25. The system of claim 16, wherein the software development kit is configured to handle caching rules that are set based on the configuration of the campaign, the caching rules including at least one of an amount of data that is sponsored, a duration, a type of content associated with a token, the software development kit configured to determine availability of sponsored data based on the token and the caching rules.
